(19) United States
(12) Patent Application Publication
(10) Pub. No.: US 2026/0212416 A1
(43) Pub. Date: Jul. 23, 2026

(54) TOKENIZING AND TRADING OF TOKENIZED CARBON CREDITS

(71) Applicant: SWITCH CLIMATE TECH LLP, Puna (IN)

(72) Inventors: Vinayak Ramesh Satpute, Pune (IN); Ajinkya Suryakant Kadam, Pune (IN); Riya Ajit Latkar, Daman (IN); Shivam Kumar Singh, Pipardaha (IN)

(21) Appl. No.: 19/381,010

(22) Filed: Nov. 6, 2025

Related U.S. Application Data
(60) Provisional application No. 63/747,524, filed on Jan. 21, 2025.

(51) Int. Cl. G06Q 40/04; G06Q 30/018

(52) U.S. Cl. CPC G06Q 40/049; G06Q 30/018

(57) ABSTRACT

Systems and methods employing a Carbon Credit Tokenizing and Trading System (CCTTS) for tokenizing and trading tokenized carbon credits are provided. The CCTTS retrieves carbon credits from one or more carbon credit sources. The CCTTS generates first tokens representative of the carbon credits and second tokens mapped in a one-to-one relationship to the first tokens. The first tokens correspond to one of non-fungible tokens or semi-fungible tokens. The second tokens correspond to non-volatile and non-convertible fungible tokens independent of market fluctuations. The CCTTS executes a transactional exchange between one or more of the second tokens and corresponding one or more of the first tokens based on an order associated with a trade of at least one carbon credit of the retrieved carbon credits. The CCTTS creates, in a distributed ledger, an immutable record of data associated with one of token generation and removal, or the execution of the transactional exchange.

### CROSS-REFERENCE TO RELATED APPLICATIONS

This application claims priority to and the benefit of the provisional patent application titled “Tokenizing and Trading of Tokenized Carbon Credits,” application No. 63/747,524, filed in the United States Patent and Trademark Office on Jan. 21, 2025, which is incorporated herein by reference in its entirety.

### FIELD

The present disclosure relates generally to carbon credit trading, and, more particularly, to tokenizing and trading tokenized carbon credits.

### BACKGROUND

As the impact of climate change continues to grow, adaptation and mitigation strategies including, for example, carbon credit trading, may contribute to long-term development and advancement, while supporting a reduction of greenhouse gas emissions. Organizations are increasingly utilizing carbon credits as tangible means to meet sustainability goals. Conventional trading methods often involve complex processes, high transaction costs, and limited access for individuals or small-scale participants. The carbon credit trading system, established following the 1997 Kyoto Protocol, was designed as a market-based solution to combat climate change. Carbon credits, representing the right to emit one metric ton of a Carbon Dioxide equivalent (CO₂e), were intended to create incentives for reducing greenhouse gas emissions. However, the implementation of carbon credit trading through conventional fiat currency systems and more recent cryptocurrency approaches has revealed substantial structural limitations. Conventional cryptocurrency or stablecoin solutions may be subject to market volatility and external value fluctuations, impacting trading stability. Moreover, conventional cryptocurrency-based systems may allow token conversion and external trading, reducing platform control and transparency. Furthermore, conventional solutions may face substantial price variations for similar credits due to market inefficiencies. The market structure may present substantial issues, for example, an unstructured carbon market, inadequate carbon accounting systems, and insufficient digital infrastructure.

In light of the foregoing, there is a need for a technical solution that overcomes the above-mentioned problems.

### SUMMARY

Various embodiments of the disclosure may provide systems and computer-implemented methods for tokenizing and trading tokenized carbon credits, substantially as shown in, and/or described in connection with, at least one of the figures, as set forth more completely in the claims. The systems and computer-implemented methods disclosed herein may provide an enhanced, non-volatile token mechanism including an advanced technical framework to stabilize market valuation and foster a more efficient, transparent, auditable, traceable, and accessible trading environment. As used herein, the phrase “one or more processors individually or collectively configured to cause the system to” may encompass various embodiments, including but not limited to: processors that are programmed and capable of performing a function, regardless of whether execution is occurring at a given time; processors actively executing instructions to perform the function; and processors that, when triggered by an event or a condition, initiate execution of the function. The scope of the phrase is not to limit the scope of the disclosure to an actively functioning device.

In various embodiments, a system for tokenizing and trading tokenized carbon credits is disclosed. The system may include one or more memories and one or more processors communicatively coupled to the one or more memories. The one or more processors may be individually or collectively configured to cause the system to retrieve a plurality of carbon credits from one or more carbon credit sources. The carbon credit source(s) may correspond to at least one of a carbon registry, an electronic wallet, or a green project entity. The one or more processors may be individually or collectively configured to cause the system to generate a plurality of first tokens representative of the retrieved plurality of carbon credits. The one or more processors may be individually or collectively configured to cause the system to generate a plurality of second tokens mapped in a one-to-one relationship to the plurality of first tokens. The one or more processors may be individually or collectively configured to cause the system to execute a transactional exchange between one or more second tokens of the plurality of second tokens and corresponding one or more first tokens of the plurality of first tokens based on an order associated with a trade of at least one carbon credit of the retrieved plurality of carbon credits.

In various embodiments, the one or more processors may be individually or collectively configured to cause the system to generate the plurality of first tokens based on a first token standard, and generate the plurality of second tokens based on a second token standard. The second token standard may be different from the first token standard.

In various embodiments, the one or more processors may be individually or collectively further configured to cause the system to remove the one or more second tokens from the system after the transactional exchange.

In various embodiments, the one or more processors may be individually or collectively further configured to cause the system to create, in a distributed ledger operably coupled to the system, an immutable record of data associated with a transaction. The transaction may be associated with at least one of the generation of the plurality of first tokens, the generation of the plurality of second tokens, the execution of the transactional exchange, or the removal of the one or more second tokens.

In various embodiments, the distributed ledger may correspond to a blockchain ledger.

In various embodiments, the one or more processors may be individually or collectively further configured to cause the system to list the generated plurality of first tokens representative of the retrieved plurality of carbon credits on a user interface in a carbon credit marketplace computing entity. The carbon credit marketplace computing entity may be one of integral or external to the system.

In various embodiments, the one or more processors may be individually or collectively further configured to cause the system to receive, from a user entity, the order associated with a purchase of the at least one carbon credit of the retrieved plurality of carbon credits, receive, from the user entity, an amount of a currency instrument for the order, transmit, to an electronic wallet of the user entity, the one or more second tokens corresponding to the received amount of the currency instrument, and execute the transactional exchange between the one or more second tokens and the corresponding one or more first tokens via the electronic wallet of the user entity.

In various embodiments, the transactional exchange between the one or more second tokens and the corresponding one or more first tokens may include a reception of the one or more second tokens from the electronic wallet of the user entity into a digital storage medium of the system, and a transmission of the corresponding one or more first tokens from the digital storage medium of the system to the electronic wallet of the user entity.

In various embodiments, the one or more processors may be individually or collectively further configured to cause the system to receive, from the user entity, the order associated with a sale of the corresponding one or more first tokens, and execute a transactional exchange between the corresponding one or more first tokens and equivalent one or more second tokens from a purchasing entity based on a price issued for the sale by the carbon credit marketplace computing entity.

In various embodiments, the one or more processors may be individually or collectively further configured to cause the system to verify, in communication with the distributed ledger operably coupled to the system, ownership and authenticity of the corresponding one or more first tokens, prior to the execution of the transactional exchange between the corresponding one or more first tokens and the equivalent one or more second tokens.

In various embodiments, the one or more processors may be individually or collectively further configured to cause the system to convert the equivalent one or more second tokens into an amount of a currency instrument, and transmit the amount of the currency instrument to an electronic wallet of the purchasing entity.

In various embodiments, the one or more processors may be individually or collectively further configured to cause the system to remove the equivalent one or more second tokens from the system after the transactional exchange between the corresponding one or more first tokens and the equivalent one or more second tokens from the purchasing entity.

In various embodiments, the one or more processors may be individually or collectively further configured to cause the system to configure a ratio for a fractionalization of a carbon credit of the retrieved plurality of carbon credits, set a price for purchase of the carbon credit in proportion to the configured ratio, and generate the plurality of first tokens based on the configured ratio and the set price.

In various embodiments, the one or more processors are individually or collectively configured to cause the system to generate the plurality of first tokens and the plurality of second tokens through one or more smart contracts. The one or more smart contracts may be executable in the distributed ledger that may be operably coupled to the system.

In various embodiments, the one or more processors are individually or collectively further configured to cause the system to expose at least one application programming interface to enable one or more interactions between two or more modules. The two or more modules may be associated with at least one of: the retrieval of the plurality of carbon credits, the generation of the plurality of first tokens, the generation of the plurality of second tokens, the execution of the transactional exchange, or a removal of the one or more second tokens. The two or more modules may be one of integral or external to the system.

In various embodiments, the generated plurality of first tokens may correspond to one of: a plurality of non-fungible tokens or a plurality of semi-fungible tokens, and the generated plurality of second tokens may correspond to a plurality of non-volatile and non-convertible fungible tokens.

In various embodiments, a computer-implemented method for tokenizing and trading tokenized carbon credits is disclosed. The computer-implemented method may include retrieving a plurality of carbon credits from one or more carbon credit sources. The computer-implemented method may include generating a plurality of first tokens representative of the retrieved plurality of carbon credits. The computer-implemented method may include generating a plurality of second tokens mapped in a one-to-one relationship to the plurality of first tokens. The computer-implemented method may include executing a transactional exchange between one or more second tokens of the plurality of second tokens and corresponding one or more first tokens of the plurality of first tokens based on an order associated with trading at least one carbon credit of the retrieved plurality of carbon credits.

In various embodiments, a non-transitory computer-readable medium storing code for tokenizing and trading tokenized carbon credits is disclosed. The code may include computer program instructions executable by one or more processors to retrieve a plurality of carbon credits from one or more carbon credit sources. The code may include computer program instructions executable by one or more processors to generate a plurality of first tokens representative of the retrieved plurality of carbon credits. The code may include computer program instructions executable by one or more processors to generate a plurality of second tokens mapped in a one-to-one relationship to the plurality of first tokens. The code may include computer program instructions executable by one or more processors to execute a transactional exchange between one or more second tokens of the plurality of second tokens and corresponding one or more first tokens of the plurality of first tokens based on an order associated with trading at least one carbon credit of the retrieved plurality of carbon credits.

In various embodiments, a system for tokenizing and trading tokenized carbon credits is disclosed. The system may include one or more memories configured to store a plurality of first tokens representative of a plurality of carbon credits retrieved from one or more carbon credit sources, and a plurality of second tokens mapped in a one-to-one relationship to the plurality of first tokens. The system may include one or more processors communicatively coupled to the one or more memories. The one or more processors may be individually or collectively configured to cause the system to receive, from a user entity, an order for at least one carbon credit of the plurality of carbon credits and load an electronic wallet of the user entity for the order. The electronic wallet may store one or more second tokens of the plurality of second tokens. The one or more processors may be individually or collectively configured to cause the system to execute, via the loaded electronic wallet, a transactional exchange between the one or more second tokens of the plurality of second tokens and corresponding one or more first tokens of the plurality of first tokens based on the order.

In various embodiments, the one or more processors may be individually or collectively further configured to cause the system to receive, from the user entity, an amount of a currency instrument for the order, transmit, to the electronic wallet, the one or more second tokens corresponding to the received amount of the currency instrument, and load the electronic wallet with the corresponding one or more first tokens based on the executed transactional exchange between the one or more second tokens and the corresponding one or more first tokens.

In various embodiments, the one or more processors may be individually or collectively further configured to cause the system to receive, from the user entity, a request to retire the corresponding one or more first tokens for an offset of greenhouse gas emissions, execute a retirement of the corresponding one or more first tokens from the loaded electronic wallet, and create an immutable record of data associated with the retirement of the corresponding one or more first tokens in a distributed ledger that may be operably coupled to the system.

In various embodiments, a computer-implemented method for tokenizing and trading tokenized carbon credits is disclosed. The computer-implemented method may include storing a plurality of first tokens representative of a plurality of carbon credits retrieved from one or more carbon credit sources, and a plurality of second tokens mapped in a one-to-one relationship to the plurality of first tokens. The computer-implemented method may include receiving, from a user entity, an order for at least one carbon credit of the plurality of carbon credits. The computer-implemented method may include loading an electronic wallet of the user entity for the order, where the electronic wallet may store one or more second tokens of the plurality of second tokens. The computer-implemented method may include executing, via the loaded electronic wallet, a transactional exchange between the one or more second tokens of the plurality of second tokens and corresponding one or more first tokens of the plurality of first tokens based on the order.

In various embodiments, a non-transitory computer-readable medium storing code for tokenizing and trading tokenized carbon credits is disclosed. The code may include computer program instructions executable by one or more processors to store a plurality of first tokens representative of a plurality of carbon credits retrieved from one or more carbon credit sources, and a plurality of second tokens mapped in a one-to-one relationship to the plurality of first tokens, in one or more memories. The code may include computer program instructions executable by one or more processors to receive, from a user entity, an order for at least one carbon credit of the plurality of carbon credits. The code may include computer program instructions executable by one or more processors to load an electronic wallet of the user entity for the order. The electronic wallet may store one or more second tokens of the plurality of second tokens. The code may include computer program instructions executable by one or more processors to execute, via the loaded electronic wallet, a transactional exchange between the one or more second tokens of the plurality of second tokens and corresponding one or more first tokens of the plurality of first tokens based on the order.

The above-disclosed features and advantages of the present disclosure may be appreciated from a review of the following detailed description of the present disclosure, along with the accompanying drawings in which like reference numerals refer to like parts throughout.

### BRIEF DESCRIPTION OF THE DRAWINGS

The accompanying drawings illustrate various embodiments of systems, methods, and aspects of the disclosure by way of example. As such, the embodiments herein are not limited to the specific components, structures, and methods disclosed herein. Further, the description of a component, or a structure, or a method step referenced by a numeral in a drawing is applicable to the description of that component, or structure, or method step shown by that same numeral in any subsequent drawing herein.

Various embodiments of the present disclosure are illustrated by way of example and not limitation in the figures of the accompanying drawings, in which:

FIG. 1 is a block diagram illustrating a system for tokenizing and trading tokenized carbon credits, in accordance with various embodiments of the present disclosure;

FIG. 2 is a block diagram illustrating a process flow for tokenizing and trading tokenized carbon credits, in accordance with various embodiments of the present disclosure;

FIG. 3 is a flowchart illustrating an example of a computer-implemented method for tokenizing and trading tokenized carbon credits, in accordance with various embodiments of the present disclosure;

FIG. 4 is a flowchart illustrating an example of a computer-implemented method for tokenizing carbon credits and executing a purchase of the tokenized carbon credits, in accordance with various embodiments of the present disclosure;

FIG. 5 is a flowchart illustrating an example of a computer-implemented method for tokenizing carbon credits and executing a sale of the tokenized carbon credits, in accordance with various embodiments of the present disclosure;

FIG. 6 is a flowchart illustrating an example of a computer-implemented method for tokenizing and trading tokenized carbon credits, in accordance with various embodiments of the present disclosure;

FIG. 7 is a flowchart illustrating an example of a computer-implemented method for tokenizing carbon credits and trading tokenized carbon credits via an electronic wallet, in accordance with various embodiments of the present disclosure;

FIGS. 8A, 8B, 8C, 8D, and 8E collectively represent a flowchart illustrating an example of a computer-implemented method for tokenizing and trading tokenized carbon credits by utilizing a dual-token mechanism, in accordance with various embodiments of the present disclosure;

FIG. 9 is a block diagram illustrating an example of a method for minting non-fungible tokens, in accordance with various embodiments of the present disclosure;

FIG. 10 is a block diagram illustrating an example of a method for issuing non-fungible tokens to a user for performing different user actions, in accordance with various embodiments of the present disclosure;

FIGS. 11A and 11B are block diagrams illustrating an example of a method for redeeming and burning non-fungible tokens, in accordance with various embodiments of the present disclosure; and

FIG. 12 is a block diagram illustrating an integration of application programming interfaces, a security framework, and multiple external entities into a system for tokenizing and trading tokenized carbon credits, in accordance with various embodiments of the present disclosure.

### DETAILED DESCRIPTION

The present disclosure is best understood with reference to the detailed figures and descriptions set forth herein. Various embodiments are discussed below with reference to the figures. However, entities skilled in the art will readily appreciate that the detailed description provided herein with respect to the figures are merely for explanatory purposes as the systems and methods may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

Climate change presents a persistent and escalating global challenge, driven primarily by rising concentrations of Greenhouse Gases (GHGs) in the atmosphere. In response, governments, industries, and international bodies have adopted various policy instruments aimed at reducing emissions and promoting sustainable practices. Among the various policy instruments, carbon credit trading systems have gained prominence as a market-based mechanism to incentivize the reduction of GHG emissions. By assigning a quantifiable monetary value to reductions of GHG emissions, carbon credit trading systems may allow entities to meet targets for regulatory or voluntary GHG emissions more flexibly and cost-effectively. Moreover, the carbon credit trading systems may support an allocation of capital toward low-carbon technologies and projects, thereby aligning environmental objectives with sustainable growth and development. Despite ongoing efforts, there remains a need to enhance the transparency, efficiency, and credibility of carbon credit trading systems to ensure effectiveness of the carbon credit trading systems in driving real and verifiable climate benefits.

Carbon credit trading systems may face significant challenges in transparency, traceability, auditability, and accessibility. Transparency in carbon credit trading systems may help maintain market integrity and ensure genuine environmental impact. Conventional carbon credit trading systems may be hindered by substantial opacity in both data accessibility and transaction visibility, leading to market inefficiencies and reduced confidence among participants. Lack of transparency may be particularly acute in cross-border transactions and in dealings with multiple stakeholders across different jurisdictions. Further, traceability in carbon credit trading systems may help ensure legitimacy of carbon credits and prevent issues such as double-counting which may lead to reconciliation errors. Conventional carbon credit trading systems may have limited capacity to maintain accurate tracking throughout a carbon credit lifecycle, from issuance to retirement of carbon credits. Moreover, the international structure of carbon credit markets may add complexity to tracking carbon credits across multiple jurisdictions and trading platforms. Furthermore, the lack of standardized reporting frameworks and varying requirements across jurisdictions may create substantial compliance burdens and increase the risk of errors, thereby affecting small and medium-sized entities that may lack resources to manage complex reporting requirements across multiple frameworks.

The carbon credit trading system, established following the 1997 Kyoto Protocol, was designed as a market-based solution for reducing GHG emissions to combat climate change. Carbon credits, which confer the right to emit one metric ton of Carbon Dioxide equivalent (CO₂e), were established as a market-based mechanism to incentivize the reduction of GHG emissions. However, the implementation of carbon credit trading through conventional fiat currency systems and more recent cryptocurrency or stablecoin platforms has revealed several structural and operational limitations. Cryptocurrency-based systems, for example, may be subject to market volatility and external value fluctuations, which can adversely affect trading stability. Moreover, conventional cryptocurrency-based systems may allow token conversion and external trading, reducing platform control and transparency. Furthermore, price variations or inconsistencies may also be prevalent, for example, credits of similar type and quality may exhibit price variations of up to 200%, reflecting market inefficiencies. The above-disclosed challenges may be compounded by broader structural issues, for example, an unstructured carbon credit market, inadequate carbon accounting systems, and underdeveloped digital infrastructure to support transparent and reliable carbon credit transactions.

The application of blockchain technology to tokenize and trade carbon credits exhibits substantial potential for improving the efficiency and transparency of carbon credit trading systems. However, conventional blockchain-enabled systems face several challenges due to reliance on a single-token mechanism which may depend on volatile fiat currencies and cryptocurrencies having fluctuating market valuations, which may result in instability in carbon credit trading markets and impact investor confidence. Further, the conventional blockchain-enabled systems may lack robust mechanisms for regulated token minting, double entry verification for transaction accuracy, and the ability to fractionalize the carbon credits to the smallest units, thereby limiting market accessibility and liquidity, which may result in substantial price inefficiencies and compromised integrity and transparency of carbon credit transactions.

Various embodiments of the present disclosure address the above-mentioned challenges by providing systems and computer-implemented methods for tokenizing and trading tokenized carbon credits. In various embodiments, the present disclosure relates to tokenizing carbon credits by utilizing a non-volatile token mechanism where native fungible tokens generated by a system may be used for trading the tokenized carbon credits. Native fungible tokens may refer to interchangeable units of value that are identical in utility and value. Each native fungible token may be indistinguishable from an alternative native fungible token. In many embodiments, the non-volatile token mechanism may be a dual-token mechanism where at least two types of tokens, for example, first tokens and second tokens, may be generated for tokenizing and trading the tokenized carbon credits. In some embodiments, the first tokens may correspond to one of non-fungible tokens or semi-fungible tokens, and the second tokens may correspond to non-volatile and non-convertible fungible tokens independent of market fluctuations. Non-fungible tokens may refer to unique, indivisible, non-interchangeable digital assets with distinct properties and metadata. Each non-fungible token may be uniquely identified by a token ID and cannot be copied, replaced, substituted, subdivided, or exchanged on a one-to-one (1:1) basis. The non-fungible tokens may represent ownership of specific items, for example, carbon credits, on a blockchain. Semi-fungible tokens may be fungible within a specific context or token ID but non-fungible across different contexts or token IDs. In various embodiments, the second tokens may be free from volatility associated with fiat-backed tokens.

In several embodiments, the system disclosed herein may provide a traceable, transparent, and secure method for trading the tokenized carbon credits. In various embodiments, the system and the computer-implemented method disclosed herein may leverage blockchain technology to establish trust, create transparency, auditability, reporting, and promote end-to-end traceability for carbon credit-related activities in a carbon credit marketplace. In many embodiments, the system disclosed herein may provide a secure and transparent method for retiring, offsetting, or burning carbon credits. In some embodiments, the system and the computer-implemented method disclosed herein may enable fractional ownership of the carbon credits to democratize market access, for example, for small-sized or medium-sized enterprises. In several embodiments, the system and the computer-implemented method disclosed herein may provide automated verification and instant settlement by an instant transactional exchange between the first tokens and the second tokens, to reduce operational costs and complexity. In various embodiments, the system and the computer-implemented method disclosed herein may support price stability through the non-volatile token mechanism independent of market speculation. In many embodiments, the system and the computer-implemented method disclosed herein may enable programmatic tracking of environmental impact through smart contracts. In some embodiments, the system and the computer-implemented method disclosed herein may establish a double-entry verification system for enhanced trading accuracy and audit trails. In several embodiments, the system and the computer-implemented method disclosed herein may ensure a one-to-one mapping between the tokens and actual carbon credits through regulated minting. In various embodiments, the system and the computer-implemented method disclosed herein may create immutable retirement records with automatic carbon credit source updates. In many embodiments, the system and the computer-implemented method disclosed herein may maintain the legitimacy of the carbon credits and enhance the verifiability of the carbon credits. The system and the computer-implemented method disclosed herein may allow users to purchase pre-verified, high quality carbon credits through reputed carbon credit sources, for example, carbon registries, and in the exact requested quantity. In some embodiments, the system disclosed herein may operate as an optimized carbon credit marketplace for trade requests to fulfill the carbon credit demand.

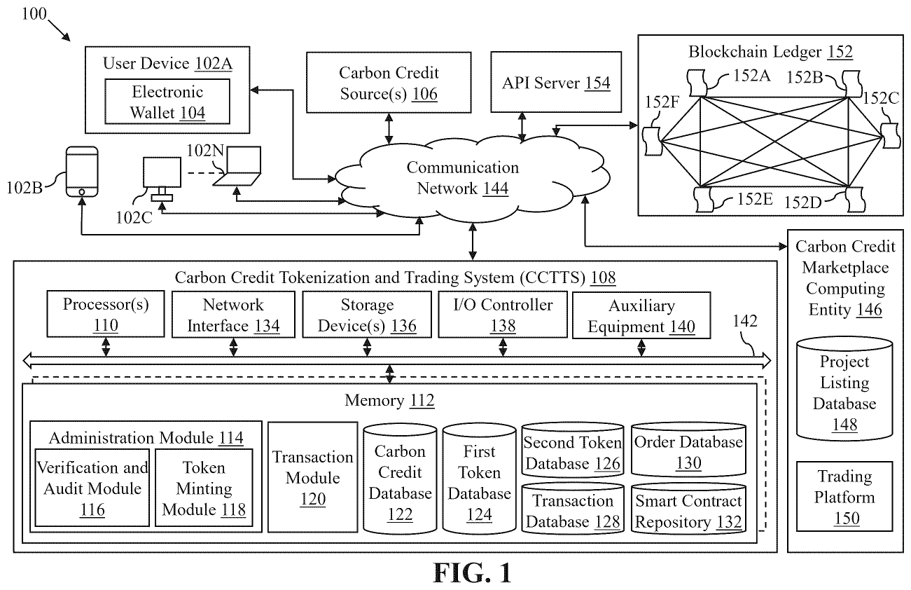

FIG. 1 is a block diagram illustrating a system 100 for tokenizing and trading tokenized carbon credits, in accordance with various embodiments of the present disclosure. A carbon credit may refer to a tradeable unit of measurement that represents one ton of carbon dioxide or a different Greenhouse Gas (GHG) that has been avoided or removed from the atmosphere. For example, one (1) carbon credit may be equivalent to a reduction or an avoidance of an emission of 1 metric ton of carbon dioxide or a different GHG into the earth's atmosphere. A verifying and issuing authoritative entity may issue a digital certificate with a unique identifier (ID) to each verified carbon credit stored in a carbon credit source 106 such as a carbon registry. In an example implementation, the system 100 may include multiple user devices 102A, 102B, 102C . . . , 102N (herein referred to as the “user devices 102A-102N”), one or more carbon credit sources 106, a Carbon Credit Tokenization and Trading System (CCTTS) 108, and a communication network 144. The user devices 102A-102N may access the CCTTS 108 via the communication network 144. The CCTTS 108 may access the carbon credit source(s) 106 via the communication network 144. In many embodiments, the system 100 may further include a carbon credit marketplace computing entity 146. The CCTTS 108 may further communicate with the carbon credit marketplace computing entity 146 via the communication network 144. The carbon credit marketplace computing entity 146 may include a trading platform 150 configured to support trading of tokenized carbon credits. In some embodiments, the carbon credit marketplace computing entity 146 may be integrated in the CCTTS 108. In several embodiments, the system 100 may further include a blockchain ledger 152 and an Application Programming Interface (API) server 154.

The communication network 144 may refer to a medium through which data and messages are transmitted between the user devices 102A-102N, the carbon credit source(s) 106, the CCTTS 108, the blockchain ledger 152, the API server 154, and the carbon credit marketplace computing entity 146. The communication network 144 may, for example, be a short-range network or a long-range network. Examples of the communication network 144 may include at least one of the Internet, an intranet, a wired network, a wireless network, a communication network that implements Bluetooth® of Bluetooth Sig, Inc., a network implementing Wi-Fi® of Wi-Fi Alliance Corporation, an Ultra-Wide Band (UWB) communication network, a wireless Universal Serial Bus (USB) communication network, or the like. Additional examples of the communication network 144 may include a communication network that implements ZigBee® of ZigBee Alliance Corporation, a General Packet Radio Service (GPRS) network, a mobile telecommunication network such as a Global System for Mobile (GSM) communications network, a Code Division Multiple Access (CDMA) network, an Nth generation mobile communication network, where “N” may be 2, 3, 4, 5, 6, etc., a Long-Term Evolution (LTE) mobile communication network, a public telephone network, etc., a local area network, a wide area network, an internet connection network, an infrared communication network, or the like. Further examples of the communication network 144 a Light Fidelity (Li-Fi) network, a Local Area Network (LAN), a Wide Area Network (WAN), a Metropolitan Area Network (MAN), a satellite network, a fiber optic network, a coaxial cable network, an infrared (IR) network, a Radio Frequency (RF) network, or any combination thereof. The communication network 144 may also be a network formed from any combination of the above-mentioned networks and different networks. Various entities in the system 100 may connect to the communication network 144 in accordance with various wired and wireless communication protocols, for example, a Transmission Control Protocol (TCP)/Internet Protocol (IP), a User Datagram Protocol (UDP), Long Term Evolution (LTE) communication protocols, or any combination thereof.

The user devices 102A-102N may include, for example, a first user device 102A, a second user device 102B, a third user device 102C, . . . , and an nth user device 102N. Each user device (any of the user devices 102A-102N) may be associated with a user of a plurality of users. The user may refer to an individual user, for example, a person, that may interact with the CCTTS 108 and the trading platform 150 in the carbon credit marketplace computing entity 146 for trading tokenized carbon credits. The user may also refer to a non-individual entity, for example, an organizational user representing an organization that can interact with the CCTTS 108 and the trading platform 150 for trading tokenized carbon credits. The organization may, for example, be a micro-organization, a small organization, a medium organization, or a large organization based on market participation and/or capitalization. The organization may also be a community such as a housing society, a cooperative institution, or a Non-Governmental Organization (NGO). The user may access the CCTTS 108, for example, as a registered user or through a third-party application via an API. The CCTTS 108 may uniquely identify a registered user by a unique registration identifier (ID) assigned to the user during the user's registration with the CCTTS 108. Examples of the user devices 102A-102N may include cellular phones, mobile phones, smartphones, tablet computing devices, laptops, desktops, phablets, wearable devices such as smartwatches or smart glasses, personal digital assistants, or the like.

In several embodiments, each user device may include an electronic wallet 104 configured to securely store payment information and digital assets, for example, cryptocurrency, fiat currency, native fungible tokens, tokenized carbon credits, or the like, associated with a corresponding user. In various embodiments, the electronic wallet 104 may be a digital wallet linked to the trading platform 150 in the carbon credit marketplace computing entity 146. In many embodiments, each transaction performed by the corresponding user on the trading platform 150 may be reflected in the electronic wallet 104 as transaction history. In some embodiments, the electronic wallet 104 may support tracking of trading activities, access of an account balance associated with the user, deposit and withdrawal of funds, or the like. In several embodiments, the electronic wallet 104 may be configured to track transactions associated with tokenized carbon credits that are utilized for trading activities within the trading platform 150. In various embodiments, the electronic wallet 104 may be configured to be compatible with a decentralized blockchain with a smart contract functionality, for example, Ethereum. In an example, the electronic wallet 104 may be a Web3 wallet configured to store digital assets, access blockchain networks, and conduct transactions. The CCTTS 108 may allow the user to link the unique registration ID to the electronic wallet 104. In various embodiments, the electronic wallet 104 may be configured to record tokens associated with the CCTTS 108 that may be equivalent to user activities. The electronic wallet 104 may record the tokens received or spent by the user during purchase and retirement processes through the CCTTS 108. The electronic wallet 104 may allow the user to view, validate, and download wallet transactions in any format, for example, a .xlsx format or a .pdf file format. In a further example, if the user does not possess an electronic wallet 104, the CCTTS 108 may create the electronic wallet 104 for the user and link the created electronic wallet 104 to the user's unique registration ID.

The carbon credit source(s) 106 may refer to an entity responsible for generating, verifying, and issuing carbon credits. The carbon credit source(s) 106 may also refer to a source where the carbon credits are stored. In various embodiments, the carbon credit source(s) 106 may refer to a source of carbon credits including excess carbon credits stored in the electronic wallet 104 of a registered user. In an example, the carbon credit source(s) 106 may include a carbon registry. The carbon registry may refer to a centralized database configured to record, track, and verify carbon credits. The carbon registry may verify authenticity and quality of the carbon credits. Further, the carbon registry may support the transfer of carbon credits between two parties, for example, between purchasers and sellers. In many embodiments, the carbon registry may serve as a transparent and reliable system that ensures that each carbon credit is unique and accurately accounted for. The carbon registry may issue carbon credits based on defined certification protocols, track available carbon credits in the carbon credit marketplace computing entity 146, and when the carbon credits are purchased, the carbon registry may be responsible for tracking a retirement of the carbon credits to ensure that two or more purchasers cannot claim the same verified carbon reduction. The carbon registry may also ensure that a carbon credit is legitimate and that once the environmental benefit of the carbon credit is claimed, the carbon credit is retired from the carbon credit marketplace computing entity 146 or removed from circulation. In some embodiments, the carbon registry may act as a third party between green project developers and purchasers of carbon credits to ensure that the carbon credits listed for sale on the carbon registry deliver the promised environmental impact in a transparent and traceable way. The carbon registry may include established standards, documentation, third-party validation and verification requirements, and monitoring protocols for green projects to ensure that any carbon credit in the carbon credit marketplace computing entity 146 has been thoroughly verified, validated, and meets strict requirements. In several embodiments, the carbon registry may include public ledgers where the user can validate issuances of carbon credits, project data, and retirement information. Examples of the carbon registry utilized as the carbon credit source(s) 106 in the system 100 may include, the Verra registry, the American Carbon Registry (ACR), the Universal Carbon Registry (UCR), the Carbon Registry-India (CR-I), the Global Carbon Council (GCC) carbon registry, the Verified Carbon Standard (VCS) registry, the Gold Standard registry, Climate Action Reserve (CAR) registry, registries of the International Carbon Reduction and Offset Alliance (ICROA) or the United Nations Framework Convention on Climate Change (UNFCCC) Clean Development Mechanism (CDM), or the like.

In a further example, the carbon credit source(s) 106 may be a storage entity of a green project developer, also referred to as a “green project entity.” The green project developer may refer to an organization, a company, or an individual responsible for designing, implementing, and operating green projects aimed at promoting environmental sustainability and resulting in a reduction of GHG emissions. The green projects may focus on reducing GHG emissions, conserving natural resources, enhancing energy efficiency, and fostering renewable energy use. Examples of the green projects may include renewable energy projects associated with solar energy such as a solar power plant, wind energy such as a wind farm, hydropower, or the like, reforestation and afforestation projects, energy efficiency initiatives, sustainable agriculture and land-use management, waste management and recycling programs, water conservation and management efforts, etc. Further, in an example, the green project developer may build a wind farm that utilizes a renewable energy source to generate electricity resulting in a quantifiable reduction in GHG emissions. The reduction of the GHG emissions may be quantified in metric tons of CO₂e and verified by an independent third party. A carbon registry, for example, the Verra Registry, the Gold Standard Registry, ACR, UCR, or the like, may certify the verified reduction of the GHG emissions and issue 1 carbon credit for 1 metric ton of CO₂e reduced or removed. Additionally, green project developers may sell the resulting carbon credits to a user, for example, an organization seeking to offset the GHG emissions. The green project developers may be involved in the entire project lifecycle—from feasibility assessments and securing funding to regulatory compliance, project execution, and monitoring the environmental benefits over time. Many green project developers may also work to secure certification and verification for carbon credits or different sustainability metrics, allowing businesses and governments to meet environmental goals or regulations. The green project developers may ensure that the carbon credits are certified by a credit verifying and issuing authority, for example, the carbon credit source(s) 106. In various embodiments, the green project developers may grant exclusive rights and access to a specific batch of carbon credits to the CCTTS 108. The exclusive rights and access permit the CCTTS 108 to tokenize the specific batch of carbon credits and sell the specific batch of carbon credits through one or more offerings associated with the CCTTS 108. The price of carbon credits may depend upon many factors including, for example, the type of green project, the year of the carbon credit generation (commonly known as vintage year), the year of the sale of the carbon credit, the region, continent, or country of the green project, government or local authority regulations, environmental impact, Sustainable Development Goals (SDG) achieved through or by that project, or the like.

In an additional example, the carbon credit source(s) 106 may be a storage entity of an organization having carbon credits in an excess amount. For example, such an organization may have reduced the associated net GHG emissions beyond regulatory requirements, resulting in excess carbon credits. In a further example, the organization may have invested in one or more carbon offset projects. A carbon offset may refer to a purchase or an investment in carbon credits to “offset” or compensate for a user's GHG emissions. The carbon offset may provide a tool for users who have committed to reaching carbon neutrality or net-zero or are working to reduce the GHG emissions as a part of mitigation planning under a sustainability strategy. One carbon offset may represent a metric ton of avoided or captured GHG emissions that the user can purchase to meet environmental goals. The organization may sell the excess amount of carbon credits to such an organization or an individual seeking to offset the corresponding carbon credits. Examples of organizations having carbon credits in the excess amount may include companies implementing energy-efficient practices, government bodies that have implemented policies to reduce GHG emissions, individuals investing in carbon-reducing projects, or the like. The carbon credits sourced from the carbon credit source(s) 106 are expected to be of high-quality and may be verified via a website associated with the corresponding carbon credit source(s) 106.

The CCTTS 108 disclosed herein may support and monitor tokenizing and trading activities such as sale and purchase activities, associated with carbon credits. The CCTTS 108 may include suitable logic, circuitry, interfaces, and/or code executable by circuitry that may be configured to perform one or more operations for tokenizing and trading tokenized carbon credits. In various embodiments, the CCTTS 108 may be maintained by a trading service-providing organization, a third-party financial service provider, or the like. In many embodiments, the CCTTS 108 may be implemented in a cloud computing environment. The cloud computing environment may refer to a processing environment including configurable, computing, physical, and logical resources, for example, networks, servers, storage media, virtual machines, applications, services, or the like, and data distributed through the communication network 144. In some embodiments, the CCTTS 108 may be a cloud-based platform implemented as a service for implementing tokenization and trading of tokenized carbon credits as a service. For example, the CCTTS 108 may be configured as a Software-as-a Service (SaaS) platform or a cloud-based Software-as-a Service (CSaaS) platform that implements tokenization and trading of tokenized carbon credits as a service. In several embodiments, the CCTTS 108 may be configured as a server or a network of servers in a cloud computing platform. In various embodiments, the CCTTS 108 may be configured as a cluster of computing and networking servers that is maintained at a fixed location or at different locations. In many embodiments, the CCTTS 108 may be implemented locally as an on-premises platform comprising an on-premises software installed and run on client systems on the premises of an organization to meet privacy and security requirements.

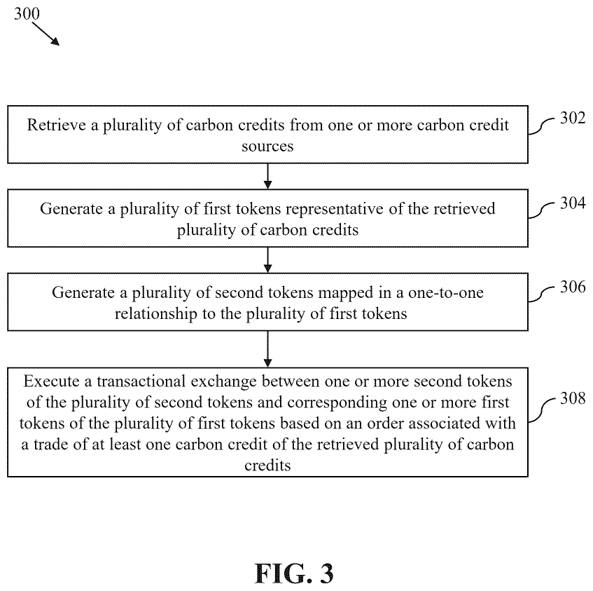

In an example implementation, the CCTTS 108 may include one or more processors 110 and one or more memories 112. The processor(s) 110 may be communicatively coupled to the one or more memories 112. The processor(s) 110 may be individually or collectively configured to cause the CCTTS 108 to tokenize and trade tokenized carbon credits as disclosed in the description of FIGS. 3, 4, 5, 6, 7, 8A, 8B, 8C, 8D, and 8E. The memory 112 may refer to a storage unit utilized for recording, storing, and reproducing data, program instructions, and applications. In various embodiments, the memory 112 may include a Random-Access Memory (RAM) or a different type of dynamic storage device that serves as a read and write internal memory and provides short-term or temporary storage for information and instructions executable by the processor(s) 110. In many embodiments, the memory 112 may include a Read-Only Memory (ROM) or a different type of static storage device that stores firmware, static information, and instructions for execution by the processor(s) 110. The memory 112 may be configured to store computer program instructions defined by one or more modules of the CCTTS 108. In an example implementation of the system 100 illustrated in FIG. 1, the modules of the CCTTS 108 may include an administration module 114, a transaction module 120, a carbon credit database 122, a first token database 124, a second token database 126, a transaction database 128, an order database 130, and a smart contract repository 132, and are herein collectively referred to as the “modules 114-132.” In some embodiments, the modules 114-132 may be stored in the memory 112 of the CCTTS 108.

In various embodiments, the administration module 114 including a verification and audit module 116 and a token minting module 118, and the transaction module 120 may include computer program instructions, which when executed by the processor(s) 110 of the CCTTS 108, cause the processor(s) 110 to perform respective functions disclosed herein. In various embodiments, the CCTTS 108 may store the computer program instructions defined by the modules 114-132 in a non-transitory, computer-readable storage medium. The non-transitory, computer-readable storage medium may refer to any computer-readable media that contains and stores computer programs and data, except for a transitory, propagating signal. Examples of the computer-readable media may include hard drives, solid state drives, optical discs or magnetic disks, memory chips, a ROM, a register memory, a processor cache, a RAM, etc. In many embodiments, the computer program instructions may implement the processes of various aspects described herein and perform additional processes for tokening and trading tokenized carbon credits.

For purposes of illustration, the modules 114-132 of the CCTTS 108, for example, the administration module 114, the transaction module 120, the carbon credit database 122, the first token database 124, the second token database 126, the transaction database 128, the order database 130, and the smart contract repository 132 are shown to be a part of an in-memory system of the CCTTS 108. However, the scope of the system 100 disclosed herein is not limited to the modules 114-132 being part of the in-memory system, but may extend to the modules 114-132 being distributed across a cluster of multiple computer systems, for example, computers, servers, virtual machines, containers, nodes, etc., coupled to the communication network 144, where the computer systems may operate as a team and coherently communicate and coordinate with each computer system to share resources, distribute workload, and execute different portions of the logic to implement tokenization and trading of tokenized carbon credits. Each computer system in the cluster may execute a part of the logic, and coordinate with different computer systems in the cluster to provide the complete functionality of the system 100 disclosed herein.

In several embodiments, the modules 114-132 of the CCTTS 108 may be computer-embeddable systems that implement tokenization and trading of tokenized carbon credits. The modules 114-132 of the CCTTS 108 may define computer program instructions executable by the processor(s) 110. The processor(s) 110 may be configured to execute the modules 114-132 of the CCTTS 108 for tokenizing and trading the tokenized carbon credits. The modules 114-132, when loaded into the memory 112 and executed by the processor(s) 110, transform the CCTTS 108 into a specially-programmed, special purpose computing system configured to implement the functionality disclosed herein. Examples of the processor(s) 110 may include any one or more Application Specific Integrated Circuit (ASIC) processors, Reduced Instruction Set Computer (RISC) processors, Complex Instruction Set Computer (CISC) processors, Field Programmable Gate Arrays (FPGAs), Central Processing Unit (CPU) devices, finite state machines, computers, controllers, microcontrollers, microprocessors, digital signal processors, logic, logic devices, chips, etc., or any combination thereof, capable of executing computer programs or a series of commands, instructions, or state transitions.

In some embodiments, the administration module 114 may correspond to a software module configured to allow an authorized operator, for example, an administrator, to manage, configure, and monitor the CCTTS 108. Consider an example where a user such as an individual user or an organization (e.g., a manufacturing company aiming to achieve net-zero GHG emissions or the like) intends to trade at least one carbon credit via the CCTTS 108. The user may register on the CCTTS 108 by creating a user account. In various embodiments, the administration module 114 may define computer program instructions for requesting the user to provide user information to complete registration. For example, if the user is an individual user, the administration module 114 may request the user to provide one or more identity verification documents, occupation details, compliance information for meeting a regulatory standard, or the like, to complete the registration. In a further example, if the user is an organization, the administration module 114 may request the user to provide one or more documents indicating a proof of incorporation, environment compliance certification, authorization of a designated representative to act on the organization's behalf, or the like. In many embodiments, the administration module 114 may define computer program instructions for authenticating the user and allowing the user to specify one or more parameters to initiate trading of the carbon credit(s). The parameters may include, for example, a quantity of carbon credits such as 1000 metric tons of CO₂e, a type of project associated with the carbon credits such as a renewable energy project, a reforestation initiative, or the like, a geographical preference, a price limitation, or the like. In some embodiments, the administration module 114 may render an interface, for example, a graphical user interface, for receiving a request associated with trading at least one carbon credit, herein referred to as a “trade request,” from the user.

The administration module 114 may be configured to source carbon credits from the carbon credit source(s) 106 via the communication network 144. In various embodiments, the administration module 114 may source the carbon credits for selling the carbon credits after tokenization and fractionalization. In an example implementation, the administration module 114 may include the verification and audit module 116 and the token minting module 118. The verification and audit module 116 may be configured to verify and validate project details and the associated carbon credits. The verification and audit module 116 may define computer program instructions for performing verification of documents corresponding to projects associated with the carbon credit source(s) 106 to complement checks and support purchasers of such carbon credits from the CCTTS 108 with enhanced verification. Examples of the documents may include Project Design Documents (PDDs), Monitoring, Reporting and Verification (MRV) documents, or the like.

At the completion of the sourcing phase, the CCTTS 108 may be provided legal possession and ownership of a digital version of the carbon credits from the carbon credit source(s) 106. Further, the verification and audit module 116 may be configured to retrieve, verify, and validate one or more additional details associated with the carbon credits from the corresponding carbon credit source(s) 106. Examples of the additional details may include details of the projects that generated the carbon credits such as name of a project, owner, location including place, city, state, country, region, continent, or the like, proponent, project Uniform Resource Locator (URL), project media files such as images, videos, etc., or the like. Further examples of the additional details may include the type of project such as reduction of GHGs or avoidance of GHGs, subtype of a renewable type such as solar, wind, hydro, or the like, chronological details such as start date of the project, end date of the project, date of carbon credit generation, date of project commissioning, date of project operationalization, and carbon credit details such as a total number of carbon credits, a procured number of carbon credits, vintage year of carbon credits, serial number(s) corresponding to each of the carbon credits, or the like. The verification and audit module 116 may be configured to securely store the additional details in the carbon credit database 122.

In several embodiments, the token minting module 118 may implement a regulated minting mechanism tied to actual carbon credit availability. In many embodiments, the token minting module 118 may be configured to tokenize the carbon credits by utilizing a non-volatile token system. In some embodiments, the non-volatile token system may be a dual-token mechanism where at least two types of tokens, for example, first tokens and second tokens, are generated for tokenizing and trading the tokenized carbon credits. In various embodiments, the first tokens may correspond to one of: non-fungible tokens or semi-fungible tokens, and the second tokens may correspond to non-volatile and non-convertible fungible tokens independent of market fluctuations. The dual-token mechanism may enable a trade of the tokenized carbon credits by utilizing the second tokens. Upon sourcing the carbon credits from the carbon credit source(s) 106, the token minting module 118 may be configured to generate first tokens for the sourced carbon credits based on a first token standard. The first token standard may refer to a first set of rules and guidelines that define a behavior and characteristic(s) of a digital token in a network, for example, a blockchain network. The first token standard may outline a functionality, a structure, and an interaction of the corresponding first token with the network. In an example, the first token standard may correspond to the Ethereum Request for Comment-1155 (ERC-1155) multi-token standard. The ERC-1155 multi-token standard may refer to a versatile token standard that enables creation and management of fungible tokens and non-fungible tokens in parallel. The ERC-1155 multi-token standard may allow multiple instances of token types minted within a single contract. This flexibility may enable the CCTTS 108 to represent fractional ownership for a variety of tokens while maintaining a unique identifier for each token associated with specific carbon credits, thereby keeping the operational cost of minting the tokens at a minimum. The CCTTS 108 may pass on an operational saving to users in the form of better quotes and rates for the carbon credits and substantially low processing fees. The token minting module 118 may be configured to store the first tokens in the first token database 124.

In many embodiments, the first tokens, for example, ERC-1155 tokens, may be semi-fungible tokens corresponding to the carbon credits. In various embodiments, the ERC-1155 tokens may refer to non-fungible tokens representing specific carbon credits. The non-fungible tokens may represent unique carbon credits that vary based on the specific attributes, for example, the source and amount of carbon offset. The non-fungible tokens may also represent ownership of specific assets or content. In some embodiments, each individual project may be identified by a different token ID, and each token ID may provide unique information about the underlying project. Users can view project details on the blockchain via the ERC-1155 token. The ERC-1155 tokens may support fractionalization, enable partial retirement, and maintain a direct link to original carbon credits. Users may acquire the ERC-1155 tokens by exchanging the second tokens, for example, ERC-20 tokens, and can later burn the ERC-1155 tokens to offset GHG emissions. The ERC-20 tokens may function as payment or exchange tokens, represent a fiat currency value, support seamless transactions, and be automatically burned after purchase of the tokenized carbon credits. In several embodiments, the ERC-20 tokens may refer to ERC-20 standard blockchain tokens on the Polygon blockchain. The combination of fungible tokens with non-fungible tokens may add versatility in handling both routine transactions and unique carbon credit assets. Through payment via fiat currency to the CCTTS 108, the user may receive the ERC-20 tokens in the user's electronic wallet 104 from the CCTTS 108. The user can receive any number of ERC-20 tokens desired to purchase the carbon credits in the ERC-1155 token format. Upon receiving the ERC-20 tokens, the administrator may transfer an equivalent number of ERC-1155 tokens associated with a project to the user. In various embodiments, the CCTTS 108 may allow only an administrator to trigger tokenization of the carbon credits. The token minting module 118 may be configured to tokenize a minimum of 1 carbon credit without a maximum limit on the number of carbon credits from the same project that can be tokenized simultaneously. The first token database 124 may be utilized for storing and managing the tokenized carbon credits. In many embodiments, the carbon credits that are previously tokenized cannot be tokenized again. The token minting module 118 may perform a comparison by utilizing a unique serial number of the carbon credit and different attributes. In some embodiments, the carbon credits that are previously retired/burned cannot be tokenized again. The token minting module 118 may perform a comparison by utilizing a unique serial number of the carbon credit and entries in the carbon credit database 122.

In several embodiments, the token minting module 118 may ensure that a quantity equal to or less than the sourced carbon credits is minted, to avoid creating first tokens without the backing of real assets, that is, the carbon credits. In an example, for each carbon credit tokenized, the token minting module 118 may mint an equal number of ERC-1155 tokens and ERC-20 tokens in a ratio as specified by the administrator. The details of the minting process may be securely recorded in the carbon credit database 122, the first token database 124, and the second token database 126. In an example, when a user places an order or a trade request to purchase carbon credit(s) from a project, the purchase may take place in the following sequence: (a) the user may pay for the carbon credits in the form of fiat currency; (b) the CCTTS 108 may transfer ERC-20 tokens to the user's electronic wallet 104 in exchange for the fiat currency; (c) the CCTTS 108 may exchange the ERC-1155 tokens from an administrator account of the CCTTS 108 with the ERC-20 tokens from the user's electronic wallet 104; (d) the user may receive the ordered ERC-1155 tokens in the electronic wallet 104; (e) the administrator may receive the ERC-20 tokens from the user's electronic wallet 104 as a part of the exchange in the preceding step; (f) the administrator may burn or retire the ERC-20 tokens received in the previous step; (g) the user has the ERC-1155 tokens that represent the carbon credits based on the user's purchase in the electronic wallet 104; and (h) the corresponding ERC-20 tokens, which were minted when the ERC-1155 tokens were minted, are permanently removed from the CCTTS 108 as well as circulation. The user is a rightful, unique, and only owner of the ERC-1155 tokens in the user's electronic wallet 104. The details of the order placed by the user may be stored in the order database 130.

To offset GHG emissions, the user can retire or burn the ERC-1155 tokens. The user can retire or burn the ERC-1155 tokens, for example, through his/her own electronic wallet 104 or account; or by logging into the CCTTS 108 and selecting a menu item named “retire/burn.” The result of retiring or burning may be such that the ERC-1155 tokens are permanently removed from the CCTTS 108 as well as circulation, which may ensure that the ERC-1155 tokens cannot be reused or resold, and that the ERC-1155 tokens cannot be double-counted. The transactional data of each transaction from the above steps under regulation are securely recorded immediately in the transaction database 128. The transactional data may include, for example, sender, recipient, amount, digital signature, and optional data such as smart contract input. By utilizing native ERC-20 tokens as a medium for purchasing ERC-1155 tokens, the CCTTS 108 may streamline transactions and enhance liquidity. This dual-token mechanism may simplify the process for users who intend to offset the GHG emissions without navigating external exchanges and blockchain bridges. In various embodiments, once the ERC-1155 tokens are utilized to offset the GHG emissions through a process called as burn or retire, the users may receive a digital certificate with a unique serial number and transaction hash, signifying the users' contribution confirming the users' offset action and supporting a greener environment. A transaction hash may refer to a confirmation that the transaction is recorded on the blockchain. In various embodiments, the digital certificate may include a barcode, for example, a Quick Response (QR) code, that may provide access to a record of the transaction on the blockchain. In an example, the records of the transactions may be accessible on a website of the blockchain.

In many embodiments, the token minting module 118 may be further configured to fractionalize a carbon credit. Fractionalizing a carbon credit may refer to dividing a carbon credit into smaller, tradable fractions enabling enhanced flexibility in the carbon credit marketplace computing entity 146. Fractionalization may enable the CCTTS 108 to provide carbon credits in smaller units, for example, kilograms (kg), rather than expecting users to purchase full carbon credits (e.g., 1,000 kg). The tokenization process of the CCTTS 108 may support the fractionalization. By enabling fractional purchases through the ERC-1155 tokens, the CCTTS 108 can attract a broader audience, including individuals and small businesses who may not have previously engaged in carbon credit markets, due to a larger ticket size or purchase cost compared to a financial threshold. In an example, 1 carbon credit may represent 1000 kg of GHG emissions avoided or reduced. The token minting module 118 may be configured to tokenize and fractionalize a carbon credit, for example, into a maximum of 1000 parts, where each part may be indicative of 1 kg of GHG emissions avoided or reduced or 0.001th fraction of a carbon credit. In a further example, the token minting module 118 may be configured to fractionalize a carbon credit into 100 parts, where each part may be indicative of ten (10) kg of GHG emissions and 0.01th fraction of a carbon credit. In a still further example, the token minting module 118 may be configured to fractionalize a carbon credit into 10 parts, where each part may be indicative of a hundred (100) kg of GHG emissions and 0.1th fraction of a carbon credit. In an additional example, if the carbon credits are not fractionalized into subparts, each carbon credit may continue to represent a thousand (1000) kg of GHG emissions, that is, 1 ton of carbon corresponds to 1 carbon credit. The token minting module 118 may record the ratio of fractionalization and allow adjustment of the price of the carbon credits in proportion to the ratio. In some embodiments, if each carbon credit is fractionalized into smaller fractions, the token minting module 118 may be configured to display a pricing per ratio or fraction to the user via an interface. The token minting module 118 may be further configured to generate first tokens corresponding to each fraction of the carbon credit based on the first token standard.

In several embodiments, the token minting module 118 may be further configured to generate second tokens in parallel to the first tokens for exchange with the corresponding first tokens based on a second token standard. In an example, the second tokens may be native fungible tokens. The second token standard may refer to a second set of rules and guidelines that define a behavior and characteristics of a digital token in a network, for example, a blockchain network. The second token standard may outline a functionality, a structure, and an interaction of the corresponding second tokens with the network. In an example, the second token standard may correspond to the ERC-20 token standard that enables creation and management of fungible tokens including interchangeable and identical units. The token minting module 118 may be configured to store the generated second tokens in the second token database 126. The token minting module 118 may ensure token value stability through the non-volatile and non-convertible fungible tokens independent of market fluctuations. The independence from market fluctuations and market trading platforms may ensure that the non-volatile and non-convertible fungible tokens maintain a predictable value within the CCTTS 108. In various embodiments, the generated ERC-20 tokens may be indicative of payment tokens capable of automatic burn after utilization in a trade. The ERC-20 tokens may refer to fungible tokens utilized as a medium of exchange within the CCTTS 108 to purchase carbon credits. The user may purchase the generated ERC-20 tokens by utilizing, for example, fiat currency, and store the purchased ERC-20 tokens in the electronic wallet 104.

In many embodiments, the token minting module 118 may execute the generation of the first tokens and the second tokens through one or more smart contracts. A smart contract may refer to a self-executing piece of code deployed on the blockchain that defines, manages, and enforces rules and logic governing behavior, ownership, and transactions associated with the generation and exchange of the first tokens and the second tokens, without the need for intermediaries. In some embodiments, the smart contract(s) may be stored in the smart contract repository 132. Each smart contract in the smart contract repository 132 may include a document with contract attributes and settings. The smart contract(s) may be executable in a distributed ledger that is operably coupled to the CCTTS 108 via the communication network 144. The distributed ledger may refer to a decentralized and distributed database that may record multiple transactions across multiple nodes, ensuring transparency, immutability, and enhanced security. The distributed ledger may correspond to a blockchain ledger 152 and is hereinafter referred to as the “blockchain ledger 152.” In various embodiments, the system 100 disclosed herein may deploy smart contracts on the blockchain ledger 152 that is implemented, for example, on the Polygon network for optimal transaction speed and cost. The smart contracts, for example, on platforms such as Ethereum, may be Turing-complete, allowing for programmable logic. This programmability enables the first tokens, for example, non-fungible tokens, to have unique properties, royalty structures, and interactive elements that exceed mere ownership verification. The smart contracts may automate the minting and trading processes, ensuring that transactions are executed efficiently and securely. Transactions related to token minting and purchases may be recorded in the blockchain ledger 152, providing verifiable proof of ownership and transaction history for users continuously and without interruption, ensuring blockchain transparency. The CCTTS 108 may enable atomic transactions through the smart contracts, eliminating double-counting risks. An atomic transaction through a smart contract may refer to a set of one or more operations bundled together such that if any part fails, the entire transaction is rolled back, leaving the state of the blockchain unchanged.

In various embodiments, through the smart contract(s), information about the first tokens and the second tokens may be available on the blockchain, providing transparency and trust to stakeholders. In an example, the first tokens and the second tokens may be deployed on Amoy Testnet or Polygon Mainnet blockchain at configured addresses, for example, Uniform Resource Locators (URLs). Amoy Testnet may refer to a test network (testnet) for the Polygon Proof-of-Stake (PoS) blockchain. The Polygon Mainnet may refer to a live, production version of the Polygon PoS blockchain, that is, a scalable, fast, and cost-efficient Layer 2 solution built on top of Ethereum. The dual token mechanism implemented by the CCTTS 108 may provide tangible environmental value and utility in carbon offsetting efforts. The contract deployment details can be independently verified by accessing the respective URLs.

In several embodiments, the system 100 may also implement automated compliance processes through programmable smart contract logic and perform real-time synchronization with the carbon credit source(s) 106 for verification. In an embodiment, the CCTTS 108 may implement a proxy pattern through smart contracts that enables an upgrade of one or more protocols while maintaining data consistency and state preservation of a transaction. The proxy pattern in smart contracts may refer to a design pattern that allows upgradability by decoupling smart contract logic from contract data. The proxy pattern may enable upgradeability of one or more protocols without disrupting the integrity of on-chain data or the continuity of transactions. For example, the proxy pattern may allow the smart contract logic to be updated without changing the address or stored contract data on the blockchain. By separating the smart contract logic from the contract data, the CCTTS 108 may route function calls through a proxy contract that holds a persistent state and storage. This proxy contract may delegate execution to an external implementation contract including the smart contract logic, ensuring that contract operations affect the storage context of the proxy contract. When a protocol upgrade is needed, for example, for fixing a bug, improving performance, or extending functionality, the proxy contract may be pointed to a new implementation contract without altering the proxy contract's address or storage, thereby maintaining transactional state, user balances, and historical data seamlessly across upgrades, ensuring data consistency and uninterrupted service. The smart contract repository 132 may be utilized to maintain version control associated with upgrades to the protocol(s), thereby tracking implementation versions.

In various embodiments, the proxy pattern may include a fail-safe mechanism configured to prevent irreversible damage or unauthorized changes during or after an upgrade of the protocol(s). The fail-safe mechanism may incorporate circuit breakers configured to trigger an automatic emergency pause function on on-going contract operations, when there is a breach in predefined risk thresholds, for example, on detection of irregular transaction patterns, unexpected token value fluctuations, or the like. Moreover, the system 100 may implement multi-signature requirements for critical platform operations and execute the emergency pause function for risk management, thereby enabling immediate system suspension during critical situations. Furthermore, upon the emergency pause function being triggered, the system 100 may escrow the pending transactions and preserve token state data in an immutable format.

The transaction module 120 may be configured to execute a transactional exchange between one or more of the second tokens and corresponding one or more of the first tokens based on the order or the trade request received from the user. In an example, the transaction module 120 may execute a purchase or a sale of carbon credits by executing a transactional exchange between the second token(s) and the first token(s). The user may utilize the second token(s) stored in the electronic wallet 104 to purchase the first token(s) corresponding to the carbon credits. The transaction module 120 may be configured to retrieve the second tokens from the electronic wallet 104 for the exchange with the first tokens to complete a transaction. In various embodiments, the first tokens may be mapped to the corresponding second tokens. The first tokens indicative of the carbon credits requested by the user may be transferred to the user's electronic wallet 104. In many embodiments, the valuation of the second tokens may be based on the fractionalized valuation of the carbon credits. In some embodiments, the transaction module 120 may be further configured to retire the second tokens to maintain a one-to-one relationship between the corresponding first tokens and the carbon credits associated with the first tokens. The retirement of the second tokens may avoid double counting of the carbon credits in the CCTTS 108. In several embodiments, each second token may be indicative of a transaction associated with one carbon credit or one fraction of a carbon credit. The transaction module 120 may store details of each transaction in the transaction database 128.

In various embodiments, the transaction module 120 may be configured to record each transaction in the blockchain ledger 152 implemented, for example, on a Polygon blockchain. The transaction may refer to a single operation including, for example, transmitting first tokens, executing a smart contract, or the like initiated at the CCTTS 108. The transaction may represent a change of state in the blockchain, for example, account balances, executing smart contract functions, or the like. In many embodiments, the blockchain ledger 152 may be implemented in a fully decentralized, public blockchain for enhancing transparency, traceability, and accessibility associated with carbon credit trading. The blockchain ledger 152 may record multiple transactions across multiple nodes, for example, nodes 152A, 152B, 152C, 152D, 152E, and 152F, collectively referred to as “nodes 152A-152F.” When the transaction module 120 broadcasts a transaction to the blockchain ledger 152 via the communication network 144, each of the nodes 152A-152F may validate the transaction independently to ensure that only valid, non-fraudulent data is added to the blockchain ledger 152. The nodes 152A-152F may validate the transaction independently, for example, by checking: digital signatures to ensure authenticity, sufficient balance or token ownership, proper formatting and adherence to protocol rules, nonce correctness to prevent double spending or replay attacks, or the like. If the transaction passes checks, the node (any of the nodes 152A-152F) may mark the transaction as valid and propagate the transaction to a different one of the nodes 152A-152F.

The blockchain ledger 152 may ensure transparency, security, auditability, and end-to-end traceability of each transaction. In various embodiments, each transaction may be recorded as a block in the blockchain ledger 152. A block may refer to a data structure that groups multiple transactions together, along with metadata such as timestamp and cryptographic hashes. Each block of the blockchain ledger 152 may include a hash indicative of a previous block in the blockchain ledger 152. Additionally, the blockchain ledger 152 may prevent unauthorized alteration and deletion of the recorded blocks in the blockchain ledger 152. When a trade of the carbon credits is executed, the blockchain ledger 152 may record the details of the transactions associated with the trade. Examples of the details of the transactions associated with the trade may include parties involved, quantity of carbon credits involved in the trade, a timestamp, or the like. The blockchain ledger 152 may reduce the risk of fraud, administrative costs, or the like. In an example, when a proposed block containing transactions is received from a node 152A by a node 152B, the node 152B may verify the block, for example, by validating each transaction inside the block as disclosed herein, checking block metadata, such as timestamp, block size, and hash, confirming consensus requirements, such as Proof of Work (PoW) and Proof of Stake (PoS). If any transaction or the block is invalid, the node 152B may reject the block and may not add the block to a local copy of the blockchain ledger 152. The blockchain ledger 152 may also ensure a layer-two scaling configured to improve the speed, cost, and scalability of associated transactions. Further, the blockchain ledger 152 may act as a base system for managing and storing transaction records associated with the carbon credit marketplace computing entity 146.

In various embodiments, the CCTTS 108 may utilize the blockchain for recording carbon credit certificates as issued by the carbon credit source(s) 106 for each project on the blockchain, thereby enhancing trust, transparency, and traceability. The recorded carbon credit certificates may be publicly available and independently verifiable. The recording of carbon credit certificates may be for both awarding of the carbon credits via the first tokens upon purchase and retirement of the first tokens. The CCTTS 108 may further utilize the blockchain for recording purchase transactions of the first tokens by individual or organizational users for offset requirements, thereby enhancing trust, transparency, and traceability. The recorded purchase transactions may be made publicly available and can be accessed by registered users of the CCTTS 108. The recorded purchase transactions may be utilized for internal reconciliation and reporting purposes, and auditing. The recorded purchase transactions may be utilized by purchasers for submission as a part of the purchasers' statutory, compliance, or transactional reporting. In various embodiments, each block of the blockchain can represent one or more of the recorded purchase transactions. The CCTTS 108 may utilize the blockchain for providing end-to-end traceability for carbon credit-related activities including, for example, creation of a project, entry of carbon credits in the carbon credit source(s) 106 for that particular project, tokenization of the carbon credits, purchase of the carbon credits by a transactional exchange between the first tokens and the second tokens, removal of the second tokens, retirement of the first tokens, etc., in the carbon credit marketplace.

In various embodiments, the CCTTS 108 may further include a network interface 134 configured to connect the CCTTS 108 to the communication network 144. The network interface 134 may be configured to transmit and receive data over the communication network 144 by utilizing one or more network protocols. In some embodiments, the network interface 134 may be provided as an interface card also referred to as a line card. Examples of the network interface 134 may include one or more of the following: Ethernet interfaces, Ethernet communication interfaces, interfaces based on TCP/IP, LAN interfaces, high speed serial interfaces, or the like. In several embodiments, the CCTTS 108 may include additional components, for example, an antenna, a radio frequency transceiver, a wireless transceiver, a Bluetooth® transceiver, an Ethernet port, a USB port, or a different device configured to transmit and receive data via the communication network 144.

The CCTTS 108 may further include one or more storage devices 136, an Input/Output (I/O) controller 138, auxiliary equipment 140, and a data bus 142. In various embodiments, one or more aspects of data associated with an order or a trade request, the carbon credits, the first tokens, the second tokens, transactional data, project data, or the like may be stored in the storage device(s) 136. In many embodiments, the I/O controller 138 may manage input and output signals for the CCTTS 108. The I/O controller 138 may also manage peripherals not integrated into the CCTTS 108. In some embodiments, the I/O controller 138 may represent a physical connection or a port to an external peripheral. In several embodiments, the I/O controller 138 may be implemented as part of the processor(s) 110. In various embodiments, a user such as an administrator of the CCTTS 108 may interact with the CCTTS 108 via the I/O controller 138 or via hardware components controlled by the I/O controller 138. In various embodiments, the auxiliary equipment 140 may include, for example, input devices, output devices, fixed media drives such as hard drives, removable media drives for receiving removable media, power circuitry, or the like. Computer applications and programs that may be utilized for operating the CCTTS 108 may be loaded onto fixed media drives and into the memory 112 via the removable media drives. In some embodiments, the computer applications and programs may be loaded into the memory 112 directly via the communication network 144. In many embodiments, the auxiliary equipment 140 may include one or more sensors for monitoring and measuring operational health, performance, or different purposes, interfaces for additional types of communication such as wired communications, or the like. The inclusion and type of components of the auxiliary equipment 140 may vary depending on the aspect or network scenario associated with the communication network 144. In various embodiments, the data bus 142 may permit communications and exchange of data between components of the CCTTS 108, for example, the processor(s) 110, the memory 112, and the network interface 134. The data bus 142 may transfer data to and from the memory 112 and into or out of the processor(s) 110.

In various embodiments, the carbon credit marketplace computing entity 146 may include a project listing database 148 and the trading platform 150. In an example implementation, the carbon credit marketplace computing entity 146 may be disposed external to the CCTTS 108 as illustrated in FIG. 1. In various embodiments, the carbon credit marketplace computing entity 146 may be integral to the CCTTS 108. In several embodiments, the project listing database 148 may be disposed external to the carbon credit marketplace computing entity 146 and remotely accessed by the carbon credit marketplace computing entity 146. The project listing database 148 may be a centralized repository configured to display and catalogue the carbon credits and carbon footprint offset activities available for trade. The project listing database 148 may support a display of the carbon credits available for sale to purchasers, thereby providing access of the available carbon credits for purchase. The purchasers may filter the carbon credits based on the purchasers' requirements. For example, a purchaser may provide a requirement and select the most suitable carbon credits to offset the GHG emissions. Further, the project listing database 148 may allow real-time tracking and monitoring of carbon credit transactions, ensuring compliance with regulatory requirements and supporting accurate reporting. Further, the project listing database 148 may support a market analysis by providing aggregated data on carbon credit availability, pricing trends, and a project type associated with each available carbon credit, thereby enhancing the overall efficiency and liquidity of the trading platform 150 in the carbon credit marketplace computing entity 146.

In various embodiments, each of the databases, for example, the carbon credit database 122, the first token database 124, the second token database 126, the transaction database 128, the order database 130, the smart contract repository 132, and the project listing database 148, collectively referred to as “databases 122-132 and 148,” may refer to storage areas or storage mediums configured for storing data and files. One or more of the databases 122-132 and 148 may be, for example, any of a structured query language (SQL) data store or a not only SQL (NoSQL) data store such as the Microsoft® SQL Server®, the Oracle® servers, the MySQL® database of MySQL AB Limited Company, the mongoDB® of MongoDB, Inc., the Neo4j graph database of Neo Technology Corporation, the Cassandra database of the Apache Software Foundation, the HBase® database of the Apache Software Foundation, or the like. In an embodiment, one or more of the databases 122-132 and 148 may be a location on a file system. In various embodiments, one or more of the databases 122-132 and 148 may be configured as cloud-based databases implemented in a cloud computing environment.

The trading platform 150 may be an electronic system that supports an interface for the users to purchase, sell, and exchange carbon credits. The trading platform 150 may serve as a centralized hub for connecting entities such as sellers with excess carbon credits to purchasers who seek to offset GHG emissions. The trading platform 150 may provide a client application configured to be installed on the user device 102A for allowing the user to access the trading platform 150. Further, the trading platform 150 enables execution of the transaction associated with the trade of the tokenized carbon credits. Furthermore, the trading platform 150 may enable the abovementioned features in compliance with carbon trading market regulations and standards. The trading platform 150 may further provide a facility for generating a report associated with the transactions performed and maintain a record for auditing in the corresponding blockchain ledger 152. The trading platform 150 may further provide market data and analytics enabling users to make informed decisions.

In various embodiments, the CCTTS 108 may expose at least one API to enable one or more interactions between two or more modules associated with several operations or transactions executed by the CCTTS 108. The operations or transactions may include, for example, the retrieval of the carbon credits, the generation of the first tokens, the generation of the second tokens, the execution of the transactional exchange, the removal of the second tokens, the retirement of the first tokens, or the like. An API may refer to computer code or a set of defined rules, routines, protocols, tools, or the like that allows communication and interaction between different modules, including hardware components, software components, or a combination thereof. For example, an API may include function calls, functions, subroutines, communication protocols, fields, or the like, that may be usable or accessible by different modules. The module(s) may be one of integral or external to the CCTTS 108. Examples of the modules that may be integral to the CCTTS 108 may include the verification and audit module 116, the token minting module 118, and the transaction module 120 as illustrated in FIG. 1. Examples of the modules that may be external to the CCTTS 108 may include modules of one or more external entities such as external enterprise systems, carbon registries, third-party applications, marketplace platforms, enterprise platforms, sustainability reporting platforms, business intelligence tools, analytics tools, or the like, that support tokenizing, trading, and different operations associated with tokenized carbon credits.

In various embodiments, the CCTTS 108 may expose the API(s) via internal service endpoints. An endpoint may refer to a specific addressable location of a resource in an API. In an example, the endpoint may be a Uniform Resource Locator (URL) or a Uniform Resource Identifier (URI) that represents a resource or an action that a module may access or perform. The internal service endpoints may include, for example, API routes as part of the main application process, and may handle HyperText Transfer Protocol (HTTP) requests internally. In various embodiments, the CCTTS 108 may expose the API(s) by utilizing an API entity. In an example implementation illustrated in FIG. 1, the CCTTS 108 may be operably coupled to the API entity, for example, the API server 154. The CCTTS 108 may communicate with the API server 154 via the communication network 144. The API server 154 may host and expose the API(s), process requests made to the API(s), and return responses to the requests based on underlying logic and data. In various embodiments, the API server 154 may fetch data from third-party APIs to respond to a request. In various embodiments, the API server 154 may integrate with external entities such as third-party applications to provide data from the CCTTS 108 to the external entities or trigger actions. Further, the API server 154 may serve as an intermediary between a frontend, internal services, and third-party systems, based on which the API server 154 may accept requests from frontends, authenticate and validate the requests, call multiple backends or third-party APIs, aggregate results, return responses, or the like.

In various embodiments, one or more modules, databases, processing elements, memory elements, storage elements, etc., of the CCTTS 108 may be distributed across a cluster of multiple computer systems, for example, computers, servers, virtual machines, containers, nodes, etc., coupled within the cloud computing environment, where the computer systems coherently communicate and coordinate with each computer system to share resources, distribute workload, and execute different portions of the CCTTS 108 to perform tokenization and trading of tokenized carbon credits. Each computer system in the cluster may execute a part of the CCTTS 108, and coordinate with different computer systems in the cluster to provide the complete functionality of the CCTTS 108 and the methods discussed herein.

The system 100 disclosed herein may address the challenges faced by a conventional carbon credit trading ecosystem through the distributed ledger-based system and the dual-token mechanism for trading tokenized carbon credits among users. The CCTTS 108 may utilize the dual-token mechanism for trading tokenized carbon credits, instead of relying on fiat currency or cryptocurrency. In various embodiments, the CCTTS 108 may enable fractional trading starting, for example, from 1 kg which improves accessibility, improves data availability, enhances transparency, and reduces costs while maintaining market integrity. The system 100 disclosed herein may also provide immutable blockchain records for each transaction stage from carbon credit sourcing to retirement. In various embodiments, the system 100 may reduce verification costs through automated compliance processes, improve impact measurement accuracy through programmable environmental attributes, and support fractional trading down to 1 kg units, reducing minimum investment requirements.

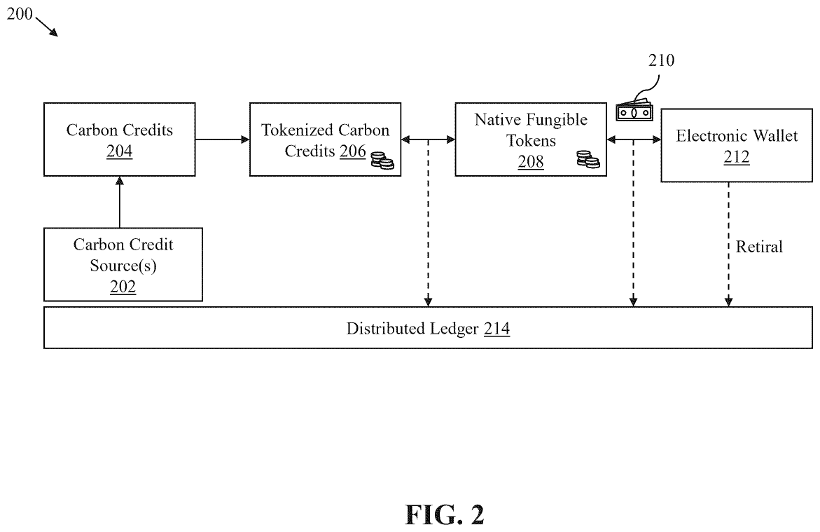

FIG. 2 is a block diagram 200 illustrating a process flow for tokenizing and trading tokenized carbon credits 206, in accordance with various embodiments of the present disclosure. The process flow is indicative of a process implemented on the CCTTS 108 illustrated in FIG. 1, for purchasing, selling, and retiring carbon credits 204 using native fungible tokens 208. In various embodiments, through this process, the CCTTS 108 may procure, trade, and retire carbon credits 204 in a transparent and trackable manner by utilizing a dual-token mechanism. The dual-token mechanism may ensure that the native fungible tokens 208 and tokenized carbon credits 206 undergo a transparent, accountable process, allowing tracking and management of carbon credit purchases. Consider an example where a user such as an individual user or an organization, may register with the CCTTS 108 and request to purchase carbon credits 204 by placing a purchase order with the CCTTS 108. Upon receiving a request to purchase the carbon credits 204 from the user, the CCTTS 108 may retrieve the carbon credits 204 based on the purchase order from a carbon credit source(s) 202, for example, a carbon registry, and tokenize the retrieved carbon credits 204. In various embodiments, the CCTTS 108 may retrieve the requested carbon credits 204 from excess tokenized carbon credits available with a different registered user. In various embodiments, the CCTTS 108 may source the carbon credits 204 from the carbon credit source(s) 202 and render a list of the available carbon credits 204 on an interface, for example, a graphical user interface, displayed on a user device, for selection by the user. The CCTTS 108 may tokenize the sourced carbon credits 204 by utilizing the dual-token mechanism and allow the user to select one or more of the tokenized carbon credits 206 based on the user's choice for purchase.

In various embodiments, the CCTTS 108 may tokenize the retrieved carbon credits 204 by utilizing first tokens, for example, non-fungible tokens or semi-fungible tokens, generated based on a first token standard such as the ERC-1155 multi-token standard. In parallel, the CCTTS 108 may also generate second tokens, for example, native fungible tokens 208, based on a second token standard such as the ERC-20 token standard. The native fungible tokens 208 may correspond, for example, to ERC-20 tokens. The native fungible tokens 208 may be non-volatile tokens, that is, the value of the native fungible tokens 208 may be independent of any market parameters. The native fungible tokens 208 may also be non-convertible into any form. The CCTTS 108 may strictly regulate the generation of the native fungible tokens 208 by the tokenized carbon credits 206 requested by the user and fiat currency 210 provided by the user. The minting of the native fungible tokens 208 may be regularized strictly in accordance with the tokenized carbon credits 206. The tokenized carbon credits 206 may be transacted or traded by utilizing the native fungible tokens 208. The CCTTS 108 may credit the native fungible tokens 208 to the user's electronic wallet 212, on receiving an equivalent amount of fiat currency 210 from the user. The electronic wallet 212 may be accessible on a user device associated with the user. The user may utilize the native fungible tokens 208 in exchange for the tokenized carbon credits 206. That is, the user may purchase the tokenized carbon credits 206 by utilizing the native fungible tokens 208. The CCTTS 108 may then transmit the tokenized carbon credits 206 to the user's electronic wallet 212. In various embodiments, once the tokenized carbon credits 206 are transmitted to the user's electronic wallet 212, the CCTTS 108 may retire or burn the native fungible tokens 208 that were minted when the tokenized carbon credits 206 were minted. The user may choose to retain or retire the tokenized carbon credits 206. The CCTTS 108 may register the above-disclosed process and each transaction or interaction on a distributed ledger 214. In an example, the distributed ledger 214 may correspond to the blockchain ledger 152 illustrated in FIG. 1.

Consider an example where the user may request to sell the tokenized carbon credits 206 by placing a sell order with the CCTTS 108. The CCTTS 108 may implement a reverse dual-token mechanism to execute a selling process. When the user wants to sell the tokenized carbon credits 206, the user may initiate the sell order with the CCTTS 108 through the first tokens, for example, ERC-1155 tokens, that are representative of the tokenized carbon credits 206. The CCTTS 108 may verify authenticity and ownership of the ERC-1155 tokens through the distributed ledger 214. Upon verification, the CCTTS 108 may exchange the user's ERC-1155 tokens with equivalent ERC-20 tokens stored in a purchasing entity or purchaser's electronic wallet based on the current trading value or offer price. Upon receiving the ERC-20 tokens, the CCTTS 108 may convert the received ERC-20 tokens into fiat currency 210 at the agreed rate and transfer a payment of the fiat currency 210 to the user. The CCTTS 108 may add the returned ERC-1155 tokens back to the carbon credit marketplace computing entity 146 illustrated in FIG. 1 for future purchases, while the ERC-20 tokens utilized in the transaction are retired or burned to maintain a strict one-to-one relationship between the minted ERC-1155 tokens and the available carbon credits 204 through a regulated minting process. The ability for users to burn ERC-1155 tokens as an offset for the GHG emissions may simplify the compensation process and encourage inclusivity and more active participation in sustainability efforts. The CCTTS 108 may complete the retirement and record the retirement in the distributed ledger 214. The CCTTS 108 may, therefore, ensure that sales are traceable and verifiable, and may maintain the integrity of the carbon credit marketplace computing entity 146 while preserving a regulated token supply. By implementing the above disclosed process, the CCTTS 108 may ensure that the ERC-1155 tokens cannot be reused, resold, or double counted.

The dual-token mechanism implemented by the CCTTS 108 for carbon credit trading using the native fungible tokens 208 may ensure double entry system verification, fractional purchase, enhanced user experience, improved liquidity management, strengthened security measures, and flexibility in transactions. Double entry system verification may refer to a process by which the distributed ledger 214 ensures that for every transaction, the total value of the native fungible tokens 208, for example, the ERC-20 tokens, deducted from the user's electronic wallet 212 is equal to the total value of the tokenized carbon credits 206, for example, the ERC-1155 tokens, deducted from the CCTTS 108 and added to the user's electronic wallet 212, thereby maintaining a balanced and auditable state across the distributed ledger 214. The dual-token mechanism may enable the double entry system and enhanced security for enabling transparency. The CCTTS 108 may maintain the double entry system where the ERC-20 tokens and the ERC-1155 tokens may always be minted and exchanged in the same quantity. The checks and balances may ensure that the CCTTS 108 records the purchase transactions using two types of tokens and not just one type of token, which may help in calculating and maintaining the quantity of the available tokenized carbon credits 206 with greater accuracy and accountability. The CCTTS 108 may enhance the user experience by not expecting the user to purchase two types of tokens.

The CCTTS 108 may handle ERC-20 and ERC-1155 token transfers, thereby expecting the user to only select and purchase the tokenized carbon credits 206 specific to the project he/she desires. For liquidity management, the CCTTS 108 may allow the user to pay in the form of fiat currency 210 and only upon a successful transaction, may allocate the ERC-20 tokens to the user's electronic wallet 212. At this stage, the user may receive an equal number of ERC-1155 tokens, and the CCTTS 108 may receive funds toward purchase of the tokenized carbon credits 206, which may reduce the likelihood of failed transactions due to insufficient funds. The use of ERC-1155 tokens as a medium for transactions may increase liquidity within the carbon credit ecosystem, allowing for smooth trading and purchasing experiences. The dual-token mechanism may operate as a verification layer, where users can confirm an ability to purchase before engaging in a more complex transaction of acquiring the tokenized carbon credits 206. The flexibility in transactions may enhance the user's purchasing power by achieving fractionalization due to specific tokenization and usage of the native fungible tokens 208 for transactions. This flexibility may allow users to purchase the tokenized carbon credits 206 in smaller increments, where the users can purchase fractional amounts of the tokenized carbon credits 206 based on the users' exact and specific emission needs, promoting greater participation from individuals and small businesses. Further, this flexibility may allow the users to make strategic purchasing decisions, where the users can evaluate market conditions and make informed decisions about purchasing additional tokenized carbon credits 206 as and when needed, in the requested quantity.

FIG. 3 is a flowchart 300 illustrating an example of a computer-implemented method for tokenizing and trading tokenized carbon credits, in accordance with various embodiments of the present disclosure. FIG. 3 is described in conjunction with FIGS. 1 and 2. In various embodiments, the computer-implemented method disclosed herein may be implemented by the CCTTS 108 illustrated in FIG. 1. The flowchart 300 illustrated in FIG. 3 shows example operations 302 through 308 for tokenizing and trading tokenized carbon credits. In various embodiments, the example operations 302 through 308 may be executed by the CCTTS 108.

At 302, the CCTTS 108 may retrieve a plurality of carbon credits from one or more carbon credit sources, for example, the carbon credit source(s) 106 illustrated in FIG. 1. Examples of the carbon credit source(s) 106 may include a carbon registry such as the Verra registry, the ACR, the UCR, the CR-I, the GCC carbon registry, the VCS registry, the Gold Standard Registry, the CAR registry, registries of the ICROA or the UNFCCC CDM, a green project entity, or the like as disclosed in the description of FIG. 1. In various embodiments, the CCTTS 108 may retrieve the carbon credits from excess carbon credits available in a registered user's electronic wallet, for example, the electronic wallet 104 or 212 illustrated in FIGS. 1 and 2.

At 304, the CCTTS 108 may generate a plurality of first tokens representative of the retrieved plurality of carbon credits. The first tokens may correspond, for example, to non-fungible tokens or semi-fungible tokens. In various embodiments, the CCTTS 108 may generate the first tokens based on a first token standard. An example of the first token standard may be the ERC-1155 multi-token standard as disclosed in the description of FIG. 1. The ERC-1155 multi-token standard may refer to a token standard on the Ethereum blockchain that enables the creation and transfer of both fungible and non-fungible tokens within a single transaction. In an example, the first tokens generated based on the ERC-1155 multi-token standard may be referred to as ERC-1155 tokens.

In an example, when a green project developer shares exclusive rights of verified carbon credits with the CCTTS 108 to be sold exclusively through the CCTTS 108, the CCTTS 108 may map the carbon credits to first tokens, for example, as 1:1000 GREEN_CC_PROJECT unique tokens, and then such first tokens are made available for purchase toward GHG emission offset. The GREEN_CC_PROJECTS tokens may refer, for example, to ERC1155 standard blockchain tokens on the Polygon blockchain. Each GREEN_CC_PROJECTS token may be backed by carbon credits issued by the carbon credit source(s) 106. For example, each GREEN_CC_PROJECTS token may correspond to 1 kg of carbon credits. For example, a purchase of 1500 GREEN_CC_PROJECTS tokens corresponds to a purchase of 1500 kg or 1.5 tons of carbon credits. The following table lists two example projects, carbon credits associated with the two example projects, and the first tokens mapped to the carbon credits:

| | | | | Number of |
|---|---|---|---|---|
| | | | Available | GREEN_{—} |
| | | | carbon | CC_PROJECTS |
| Sr. No. | Project ID | Project Name | credits | tokens |
| 1 | PR001 | Green Project | 250 | 250,000 |
| | | (Solar) | | |
| 2 | PR002 | Electric | 100 | 100,000 |
| | | Vehicle (EV) | | |
| | | Project | | |

In the above table, 1 carbon credit may represent 1000 GREEN_CC_PROJECTS tokens. Each GREEN_CC_PROJECTS token may contain the information of the carbon credit to which the GREEN_CC_PROJECTS token is mapped, that is, each GREEN_CC_PROJECTS token may have a reference of one and only one carbon credit digital certificate ID ensuring the uniqueness of the GREEN_CC_PROJECTS token. The price of the carbon credits may vary, for example, from $1 per carbon credit to $140 per carbon credit. Each GREEN_CC_PROJECTS token may contain the rate at which the underlying carbon credit is priced. A single GREEN_CC_PROJECTS token may be utilized to offset a maximum of 1 kilogram of GHG emission. In an example, the smallest quantity of the GHG emission offset that can be achieved by purchasing 1 GREEN_CC_PROJECTS token may be 1 kilogram. Any fractional emission of carbon may be rounded up to the nearest kilogram. For example, 0.5 kg may be rounded up to 1 kg which can be offset by purchasing 1 GREEN_CC_PROJECTS token; 3.65 kg may be rounded up to 4 kg which can be offset by purchasing four (4) GREEN_CC_PROJECTS tokens, or the like. There is no upper limit on the maximum number of carbon credits offered by the CCTTS 108. The carbon credits can be purchased to the tune of thousands or millions of kilograms or tons of carbon credits in the form of GREEN_CC_PROJECTS tokens. Each GREEN_CC_PROJECTS token, when purchased for GHG emission offset, may belong to only 1 purchaser at any point in time ensuring a unique, unquestionable, and traceable ownership of each GREEN_CC_PROJECTS token. In an embodiment where selected green projects may need to offer more quantities of carbon credits, multiple green projects may be selected to offset the required amount of GHG emissions. For example, if the requirement is to offset 105 carbon credits, either of the following options can be exercised:

Option 1: 105 carbon credits (that is, 105,000 GREEN_CC_PROJECTS tokens) may be purchased from PR001. Since the 105,000 GREEN_CC_PROJECTS tokens belong to the same carbon credits, the 105,000 GREEN_CC_PROJECTS tokens may be purchased at the same rate.

Option 2: The 100 carbon credits (that is, 100,000 GREEN_CC_PROJECTS tokens) may be purchased from PR002 and 5 credits (that is, 5,000 GREEN_CC_PROJECTS tokens) may be purchased from PR001. Since the overall GREEN_CC_PROJECTS tokens purchased belong to two different carbon credits, the 5000 GREEN_CC_PROJECTS tokens from PR001 may be purchased at the rate applicable for carbon credits from PR001 whereas the 100,000 GREEN_CC_PROJECTS tokens from PR002 may be purchased at the rate applicable for carbon credits from PR002. A purchaser may pay the combined price and be duly informed of the combination of the carbon credits and applicable rates before the purchase is completed.

Option 3: Any proportion of the carbon credits may be purchased from PRI001 and PRI002 totaling up to 105 carbon credits. The purchaser may pay the combined price and be duly informed of the combination of the carbon credits and applicable rates before the purchase is completed.

In various embodiments, the verified carbon credits supplied by the green project developers to the CCTTS 108 are for exclusive possession and sale through the trading platform 150 of the carbon credit marketplace computing entity 146 illustrated in FIG. 1. Therefore, the CCTTS 108 may maintain a record of carbon credits supplied to the CCTTS 108 including details such as project details, rate, date of supply, etc., maintain the mapping of the carbon credits to the GREEN_CC_PROJECTS tokens, maintain purchase transactions (that is, purchase of carbon credits/GREEN_CC_PROJECTS tokens), etc. Each purchase transaction record may contain the quantity, rate of the carbon credits/GREEN_CC_PROJECTS tokens, the total sale value, and an owner of the GREEN_CC_PROJECTS tokens. In various embodiments, the information of the owner of the GREEN_CC_PROJECTS may be recorded as a wallet ID of an electronic wallet of the owner. Further, in various embodiments, the CCTTS 108 may maintain offset (retire/burn) transactions, that is, removing the carbon credits/GREEN_CC_PROJECTS tokens from circulation to offset the GHG emissions. Each offset transaction record may contain the quantity, rate of the carbon credits/GREEN_CC_PROJECTS tokens, the total sale value, and the owner of the GREEN_CC_PROJECTS tokens who initiated and retired the carbon credits. The owner information may be recorded as the wallet ID.

In various embodiments, the CCTTS 108 may generate the first tokens through a smart contract. The smart contract may be executable in a distributed ledger, for example, the blockchain ledger 152, that is operably coupled to the CCTTS 108 as illustrated in FIG. 1. In an example, the CCTTS 108 may generate the ERC-1155 tokens by preparing a smart contract that implements the ERC-1155 standard, deploying the smart contract to the blockchain ledger 152, minting the ERC-1155 tokens via internal functions such as “_mint” or “_mintBatch,” setting up metadata via a {id}Uniform Resource Identifier (URI), and interacting with and managing the ERC-1155 tokens via standard functions. The internal functions may be called from within the smart contract to assign the ERC-1155 tokens to an address in a digital storage medium such as an electronic wallet or an account of the CCTTS 108.

At 306, the CCTTS 108 may generate a plurality of second tokens mapped in a one-to-one relationship to the plurality of first tokens. The second tokens may correspond, for example, to non-volatile and non-convertible fungible tokens independent of market fluctuations. In various embodiments, the CCTTS 108 may generate the second tokens based on a second token standard. The second token standard may be different from the first token standard. An example of the second token standard may be the ERC-20 token standard as disclosed in the description of FIG. 1. The ERC-20 token standard may refer to a token standard for fungible tokens on the Ethereum blockchain. In an example, the second tokens generated based on the ERC-20 token standard may be referred to as ERC-20 tokens, where any ERC-20 token is exactly equal to a different token without any special rights or behavior associated with the token. The ERC-20 tokens may, therefore, be utilized as a medium of exchange currency. The ERC-20 tokens may, for example, be ERC-20 standard blockchain tokens on the Polygon blockchain. In an example, the ERC-20 tokens may serve as a primary medium of exchange for purchasing GREEN_CC_PROJECTS tokens, which may be utilized for offsetting GHG emissions.

In various embodiments, the CCTTS 108 may generate the second tokens through one or more smart contracts. The smart contract(s) may be executable in a distributed ledger corresponding, for example, to the blockchain ledger 152, that is operably coupled to the CCTTS 108 as illustrated in FIG. 1. In an example, the CCTTS 108 may generate the ERC-20 tokens by preparing a smart contract using the ERC-20 token standard, deploying the smart contract to the blockchain ledger 152, minting the ERC-20 tokens, interacting with standard supported functions such as transfer, approve, or the like, verifying the ERC-20 tokens, and optionally adding features such as burn, mint, pause, or the like. The standard functions may be called from within the smart contract to assign the ERC-20 tokens to an address in a digital storage medium such as an electronic wallet or an account of the CCTTS 108 for purchase by a user, for example, through fiat currency.

In the above example, the ERC-20 tokens may be utilized as a medium of exchange for GREEN_CC_PROJECT token purchases. The minting of the ERC-20 tokens may correspond to the GREEN_CC_PROJECT tokens. For example, when the CCTTS 108 tokenizes 250 carbon credits, the CCTTS 108 may mint 250,000 ERC-20 tokens and 250,000 GREEN_CC_PROJECT tokens. When the CCTTS 108 retires or burns 250 carbon credits, the CCTTS 108 may retire or burn 250,000 ERC-20 tokens and 250,000 GREEN_CC_PROJECT tokens.

At 308, the CCTTS 108 may execute a transactional exchange between one or more second tokens of the plurality of second tokens and corresponding one or more first tokens of the plurality of first tokens based on an order associated with a trade of at least one carbon credit of the retrieved plurality of carbon credits. The order may be a purchase order for purchasing carbon credits to reduce GHG emissions. In various embodiments, the transactional exchange between the second token(s) and the corresponding first token(s) may include a reception of the second token(s) from the electronic wallet 104 of a user entity such as a user device, into a digital storage medium, such as an electronic wallet, an account, or a second token database such as the second token database 126 of the CCTTS 108 illustrated in FIG. 1, and a transmission of the corresponding first token(s) from a digital storage medium, such as an electronic wallet, an account, or a first token database such as the first token database 124 of the CCTTS 108 illustrated in FIG. 1 to the electronic wallet 104 of the user entity. In various embodiments, the CCTTS 108 may execute the transactional exchange between the second token(s) and the corresponding first token(s) through a smart contract executable in the blockchain ledger 152. The CCTTS 108 may remove the second token(s) from the digital storage medium after the transactional exchange.

Consider an example where the CCTTS 108 executes a transactional exchange between an ERC-20 token and a corresponding ERC-1155 token. The CCTTS 108 may store the ERC-1155 token with a token identifier, for example, token ID 42, in the first token database 124, and list the ERC-1155 token on the trading platform 150 of the carbon credit marketplace computing entity 146 illustrated in FIG. 1. A user may place a purchase order to purchase the ERC-1155 token for one ERC-20 token. The ERC-20 token may be stored in the user's electronic wallet 104. A smart contract may be utilized to transfer the ERC-20 token from the user's electronic wallet 104 to a digital storage medium, for example, the second token database 126 of the CCTTS 108, and transfer the ERC-1155 token with token ID 42 to the user's electronic wallet 104. In an example, the CCTTS 108 may perform a function call on an ERC-1155 contract by utilizing the code: erc1155.setApprovalForAll(exchangeContractAddress, true), and the user may approve the ERC-1155 contract to transfer the ERC-20 token by utilizing the code: usdc.approve(exchangeContractAddress, 100*10**6). The smart contract for the transactional exchange may run in the blockchain ledger 152 and emit events for both transfers and updates balances, thereby storing the ERC-20 token in the second token database 126 and storing the ERC-1155 token with token ID 42 in the user's electronic wallet 104.

For purposes of illustration, the detailed description refers to the first tokens being ERC-1155 tokens and the second tokens being ERC-20 tokens. However, the scope of the present disclosure is not limited to the first tokens being ERC-1155 tokens and the second tokens being ERC-20 tokens, but may extend to include first tokens of any non-fungible or semi-fungible type and second tokens of any native fungible type that is non-volatile, non-convertible, and independent of market fluctuations.

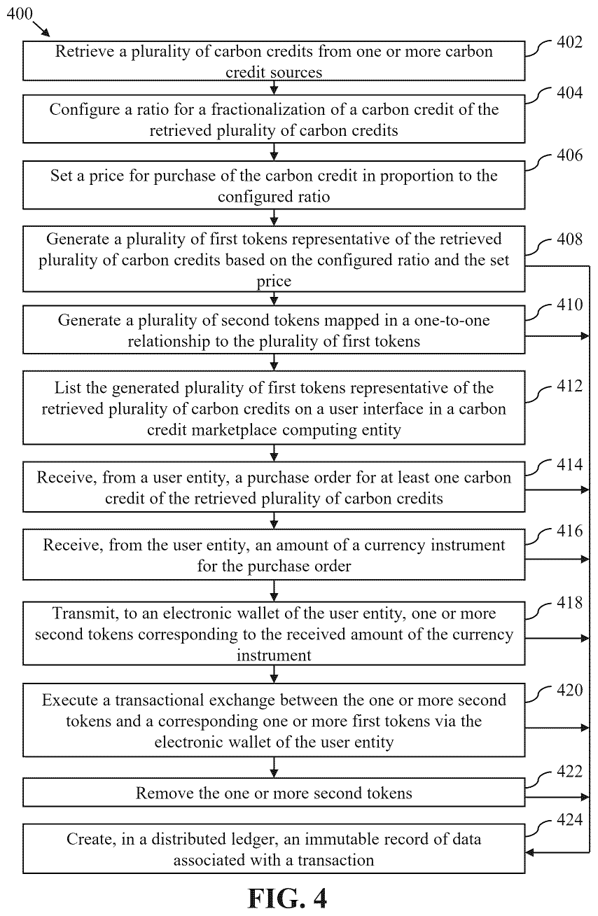

FIG. 4 is a flowchart 400 illustrating an example of a computer-implemented method for tokenizing carbon credits and executing a purchase of the tokenized carbon credits, in accordance with various embodiments of the present disclosure. FIG. 4 is described in conjunction with FIGS. 1, 2, and 3. In various embodiments, the computer-implemented method disclosed herein may be implemented by the CCTTS 108 illustrated in FIG. 1. The flowchart 400 illustrated in FIG. 4 shows example operations 402 through 424 for tokenizing carbon credits and executing a purchase of the tokenized carbon credits. In various embodiments, the example operations 402 through 424 may be executed by the CCTTS 108.

At 402, the CCTTS 108 may retrieve a plurality of carbon credits from one or more carbon credit sources 106 as illustrated in FIG. 1 and as disclosed in the descriptions of FIG. 1 and FIG. 3. Although the description herein discloses the retrieval of a plurality of carbon credits, in various embodiments, the quantity of the carbon credits may depend on a user's requirement of at least 1 carbon credit as defined in a purchase order. In various embodiments, the CCTTS 108 may verify one or more additional details associated with the carbon credit source(s) 106 during the retrieval of the carbon credit(s). Examples of the additional details may include project details associated with the carbon credit(s) (such as name of the project, owner, location, or the like), a proponent, a project Uniform Resource Locator (URL), project media files (such as images, videos, or the like), the type of project (such as reduction of GHGs or avoidance of GHGs), a renewable type (e.g., solar, wind, hydro, or the like), chronological details (such as start date of the project, end date of the project (if applicable), date of carbon credit generation, date of project commissioning, date of project operationalization, or the like), carbon credit details (such as total number of carbon credits, procured number of carbon credits, vintage year of the carbon credits, and serial number corresponding to each of the carbon credits, or the like), etc.

At 404, the CCTTS 108 may configure a ratio for a fractionalization of a carbon credit of the retrieved plurality of carbon credits. The fractionalization of the carbon credit may be executed by the token minting module 118 as illustrated in FIG. 1. By fractionalizing the carbon credit, the CCTTS 108 may provide carbon credits in smaller units, for example, kilograms (kg) rather than expecting users to purchase full carbon credits (e.g., 1,000 kg). In an example, the table below demonstrates a few combinations in which the token minting module 118 of the CCTTS 108 may tokenize and fractionalize the carbon credits.

| Number | | Number | Number | |
|---|---|---|---|---|
| of | | of | of | Equivalent |
| Carbon | Ratio | ERC1155 | ERC20 | (carbon |
| Credits | (1:*) | tokens | tokens | credit) |
| 1 | 1:1 | 1 | 1 | 1 |
| 1 | 1:10 | 10 | 10 | 0.1 |
| 1 | 1:100 | 100 | 100 | 0.01 |
| 1 | 1:1000 | 1000 | 1000 | 0.001 |
| 2 | 1:1000 | 2000 | 2000 | 0.001 |
| 5 | 1:10 | 50 | 50 | 0.1 |

The CCTTS 108 may record the ratio of fractionalization and allow adjustment of the price of the carbon credits in proportion to the ratio. In some embodiments, if a carbon credit is fractionalized into smaller fractions, the CCTTS 108 may be configured to display a pricing per ratio or fraction to the user via an interface.

At 406, the CCTTS 108 may set a price for purchase of the carbon credit in proportion to the configured ratio. In an example, the CCTTS 108 may set a price of 100 United States Dollars (USD or $) for purchasing 1 carbon credit in proportion to a configured ratio of 1:100. In this example, the user may purchase 100 ERC-1155 tokens, each representing 1/100^{th} of a carbon credit, by transferring 100 ERC-20 tokens that were purchased using fiat currency of $100.

At 408, the CCTTS 108 may generate a plurality of first tokens representative of the retrieved plurality of carbon credits based on the configured ratio and the set price. The first tokens may correspond, for example, to non-fungible tokens or semi-fungible tokens. In various embodiments, the CCTTS 108 may be further configured to generate the first tokens corresponding to each fraction of the carbon credit based on the first token standard. An example of the first token standard may be the ERC-1155 multi-token standard as disclosed in the descriptions of FIG. 1 and FIG. 3. In the above example, the CCTTS 108 may generate 1 ERC-1155 token representative of 1 carbon credit based on a configured ratio of 1:1; 10 ERC-1155 tokens representative of 1 carbon credit based on a configured ratio of 1:10; 100 ERC-1155 tokens representative of 1 carbon credit based on a configured ratio of 1:100; 1000 ERC-1155 tokens representative of 1 carbon credit based on a configured ratio of 1:1000; 2000 ERC-1155 tokens representative of 2 carbon credits based on a configured ratio of 1:1000; and 50 ERC-1155 tokens representative of 5 carbon credits based on a configured ratio of 1:10. The CCTTS 108 may store the generated first tokens in a digital storage medium such as an electronic wallet or the first token database 124 illustrated in FIG. 1. The generation of the first tokens by the CCTTS 108 may constitute a transaction for which an immutable record may be created in a distributed ledger 214 illustrated in FIG. 2. An immutable record may refer to a data entry that, once written in the distributed ledger 214, cannot be changed or removed. Any updates or corrections to the data entry may be made by appending new data entries in the distributed ledger 214, leaving the original data intact, thereby ensuring a complete and unalterable history of updates, enhancing transparency and trustworthiness. The distributed ledger 214 may correspond, for example, to the blockchain ledger 152 illustrated in FIG. 1.

At 410, the CCTTS 108 may generate a plurality of second tokens mapped in a one-to-one relationship to the plurality of first tokens. The second tokens may correspond, for example, to non-volatile and non-convertible fungible tokens independent of market fluctuations. In various embodiments, the generation of the second tokens may be based on a second token standard. An example of the second token standard may be the ERC-20 token standard as disclosed in the descriptions of FIG. 1 and FIG. 3. In the above example, the CCTTS 108 may generate 1 ERC-20 token corresponding to 1 ERC-1155 token based on the configured ratio of 1:1, 10 ERC-20 tokens corresponding to 10 ERC-1155 tokens based on the configured ratio of 1:10, and so on. In various embodiments, the generated ERC-20 tokens may be indicative of a payment token capable of an automatic burn. The CCTTS 108 may store the generated second tokens in a digital storage medium such as the electronic wallet or the second token database 126 illustrated in FIG. 1. The generation of the second tokens by the CCTTS 108 may constitute a transaction for which an immutable record may be created in the distributed ledger 214.

At 412, the CCTTS 108 may list the generated plurality of first tokens representative of the retrieved plurality of carbon credits on a user interface in a carbon credit marketplace computing entity, for example, the carbon credit marketplace computing entity 146 illustrated in FIG. 1. For example, the CCTTS 108 may list the generated first tokens representative of the retrieved carbon credits on a website of the trading platform 150 of the carbon credit marketplace computing entity 146.

At 414, the CCTTS 108 may receive, from a user entity, a purchase order for at least one carbon credit of the retrieved plurality of carbon credits. The purchase order may refer to an order associated with a purchase of the at least one carbon credit of the retrieved plurality of carbon credits. Through the user entity, for example, a user device, the user may select one of the generated first tokens representative of the retrieved carbon credits listed on the website of the trading platform 150 and initiate a purchase order for the selected first token(s). The user may also include information, for example, quantity of carbon credits desired, the type of project associated with the carbon credits, price limitations, or the like, in the purchase order. The reception of the purchase order by the CCTTS 108 may constitute a transaction for which an immutable record may be created in the distributed ledger 214.

At 416, the CCTTS 108 may receive, from the user entity, an amount of a currency instrument for the purchase order. In various embodiments, the currency instrument may be digital form of fiat currency. The user may perform a payment transaction on the CCTTS 108 or the trading platform 150 to purchase one or more second tokens by utilizing the currency instrument. In the above example, the user may purchase 100 ERC-20 tokens by utilizing fiat currency of $100, where the 100 ERC-20 tokens correspond to 100 ERC-1155 tokens. The reception of the amount of the currency instrument for the purchase order may constitute a transaction for which an immutable record may be created in the distributed ledger 214.

At 418, the CCTTS 108 may transmit, to an electronic wallet, for example, the electronic wallet 104 of the user entity illustrated in FIG. 1, one or more second tokens corresponding to the received amount of the currency instrument. In response to receiving the amount of the currency instrument from the user entity, the CCTTS 108 may retrieve the second token(s) corresponding to the received amount of the currency instrument from the digital storage medium such as the electronic wallet or the second token database 126 and transmit the retrieved second token(s) to the electronic wallet 104 of the user entity. In the above example, the CCTTS 108 may transmit 100 ERC-20 tokens corresponding to $100 to the electronic wallet 104 of the user entity. The transmission of the second token(s) corresponding to the received amount of the currency instrument may constitute a transaction for which an immutable record may be created in the distributed ledger 214.

At 420, the CCTTS 108 may execute a transactional exchange between the one or more second tokens and a corresponding one or more first tokens via the electronic wallet 104 of the user entity. In various embodiments, via the transactional exchange, the CCTTS 108 may receive the second token(s) from the electronic wallet 104 of the user entity, into the digital storage medium such as the electronic wallet or the second token database 126 of the CCTTS 108, and transmit the corresponding first token(s) from the digital storage medium such as the electronic wallet or the first token database 124 to the electronic wallet 104 of the user entity as disclosed in the description of FIG. 3. In the above example, the CCTTS 108 may execute a transactional exchange between 100 ERC-20 tokens and 100 ERC-1155 tokens via the electronic wallet 104 of the user entity, where the 100 ERC-20 tokens may be stored in the digital storage medium such as the electronic wallet or the second token database 126 of the CCTTS 108 and the 100 ERC-1155 tokens may be stored in the electronic wallet 104 of the user entity. In various embodiments, the second tokens may be utilized for purchases of additional carbon credits, utilized for donations to organizations in the climate space, exchanged for different tokens available on one or more compatible blockchains, or utilized for the purchase of sustainable merchandise associated with the CCTTS 108. The execution of the transactional exchange between the second token(s) and the corresponding first token(s) based on the order may constitute a transaction for which an immutable record may be created in the distributed ledger 214.

At 422, the CCTTS 108 may remove the one or more second tokens. In various embodiments, after the transactional exchange, the second token(s) that is stored in the digital storage medium such as the electronic wallet or the second token database 126 of the CCTTS 108 may be automatically retired or burned from the CCTTS 108 as well as circulation. The CCTTS 108 may retire the second token(s) to prevent double counting of the carbon credit(s). Thus, upon the retiring of the second token(s), the associated carbon credit may only be associated with one type of token, that is, the first token(s). The removal of the second token(s) may constitute a transaction for which an immutable record may be created in the distributed ledger 214.

At 424, the CCTTS 108 may create, in a distributed ledger 214, an immutable record of data associated with a transaction. The transaction(s) may be associated with one or more of the example operations 408 to 410 and 414 through 422 of the computer-implemented method disclosed herein. The CCTTS 108 may, therefore, provide immutable blockchain records for each transaction stage from carbon credit sourcing to retirement.

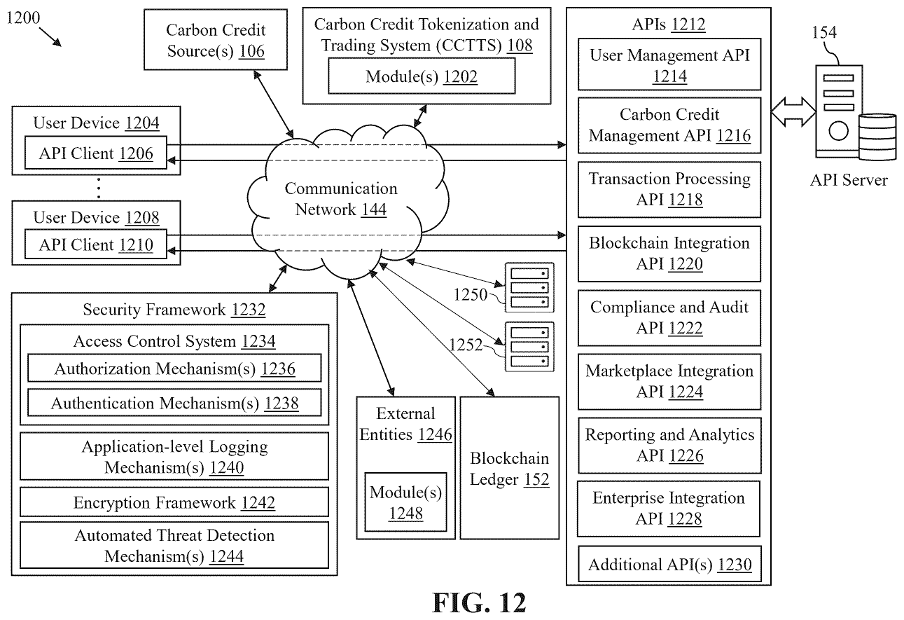

In various embodiments, for the purchase order, the CCTTS 108 may expose at least one API to enable one or more interactions between two or more modules. The two or more modules may be associated with at least one of: the retrieval of the plurality of carbon credits, the generation of the plurality of first tokens, the generation of the plurality of second tokens, the execution of the transactional exchange, the removal of the one or more second tokens, or operations 404 to 406, 412 through 418, and 424. The two or more modules may be one of integral or external to the CCTTS 108 as disclosed in the description of FIG. 1 and FIG. 12. In various embodiments, the CCTTS 108 may expose the API(s), in communication with an API entity, for example, the API server 154 illustrated in FIG. 1 and FIG. 12.

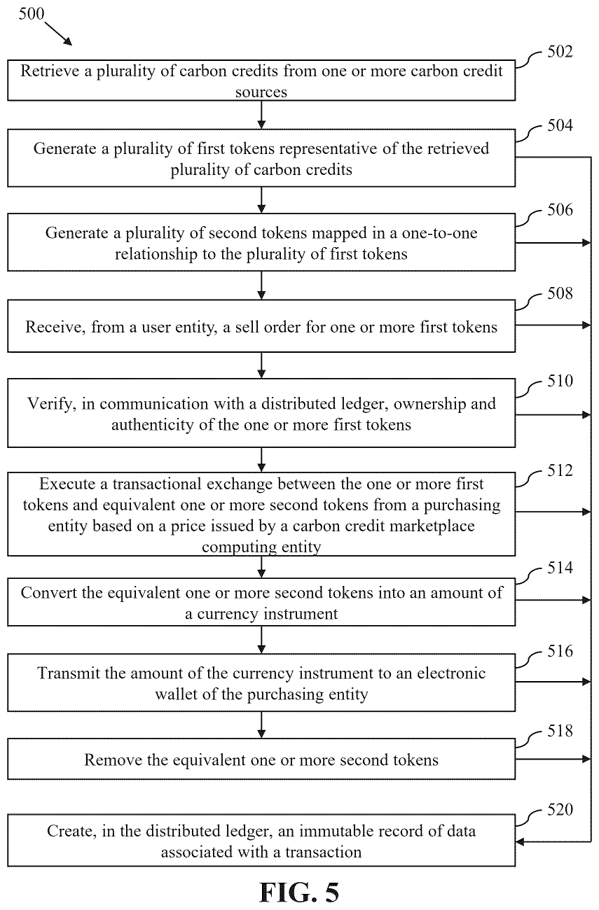

FIG. 5 is a flowchart 500 illustrating an example of a computer-implemented method for tokenizing carbon credits and executing a sale of the tokenized carbon credits, in accordance with various embodiments of the present disclosure. FIG. 5 is described in conjunction with FIGS. 1, 2, and 3. In various embodiments, the computer-implemented method disclosed herein may be implemented by the CCTTS 108 illustrated in FIG. 1. The flowchart 500 illustrated in FIG. 5 shows example operations 502 through 520 for tokenizing carbon credits and executing a sale of the tokenized carbon credits. In various embodiments, the example operations 502 through 520 may be executed by the CCTTS 108.

At 502, the CCTTS 108 may retrieve a plurality of carbon credits from one or more carbon credit sources 106 as illustrated in FIG. 1 and as disclosed in the descriptions of FIG. 1 and FIG. 3.

At 504, the CCTTS 108 may generate a plurality of first tokens representative of the retrieved plurality of carbon credits. The first tokens may correspond, for example, to non-fungible tokens or semi-fungible tokens. An example of the first token standard may be the ERC-1155 multi-token standard as disclosed in the descriptions of FIG. 1 and FIG. 3. The generation of the first tokens may constitute a transaction for which an immutable record may be created in a distributed ledger 214 illustrated in FIG. 2. The distributed ledger 214 may correspond, for example, to the blockchain ledger 152 illustrated in FIG. 1.

At 506, the CCTTS 108 may generate a plurality of second tokens mapped in a one-to-one relationship to the plurality of first tokens. The second tokens may correspond, for example, to non-volatile and non-convertible fungible tokens independent of market fluctuations. In various embodiments, the generation of the second tokens may be based on a second token standard. An example of the second token standard may be the ERC-20 token standard as disclosed in the descriptions of FIG. 1 and FIG. 3. The generation of the second tokens may constitute a transaction for which an immutable record may be created in the distributed ledger 214.

At 508, the CCTTS 108 may receive, from a user entity, a sell order for one or more first tokens. The user entity may refer to a user device of a seller of the first token(s). The sell order may refer to an order associated with a sale of the one or more first tokens. Based on a previous transactional exchange, the seller may have one or more first tokens, for example, one or more ERC-1155 tokens, stored in an electronic wallet such as the electronic wallet 104 on a user device 102A illustrated in FIG. 1. The user may want to sell the first token(s) because the user has surplus carbon offsets that different users, referred to as “purchasers,” may wish to purchase to reduce the GHG emissions or meet sustainability targets. When the seller wants to sell the carbon credits, the seller may initiate a sell order through the ERC-1155 tokens. In an example, the seller may initiate the sell order on a website of the trading platform 150 illustrated in FIG. 1. The reception of the sell order for the first token(s) may constitute a transaction for which an immutable record may be created in the distributed ledger 214.

At 510, the CCTTS 108 may verify, in communication with a distributed ledger 214, ownership and authenticity of the one or more first tokens. In various embodiments, the CCTTS 108 may verify the ownership and the authenticity of the corresponding first token(s), prior to the execution of a transactional exchange between the corresponding first token(s) and equivalent one or more second tokens. In some embodiments, the CCTTS 108 may record and maintain ownership of the first token(s) belonging to the seller by a smart contract in the distributed ledger 214. When the seller's electronic wallet 104 holds the first token(s), the smart contract deployed by the CCTTS 108 on the distributed ledger 214 may track balances by executing a function such as “mapping(uint256=>mapping(address=>uint256)) private_balances” and calling a function “balanceOf(userAddress, tokenId)” to determine ownership of the first token(s). If a value greater than 0 is returned, the seller owns the first token(s). In various embodiments, the CCTTS 108 may utilize one or more smart contracts to verify the authenticity of the first token(s) based on a smart contract address and a unique token ID. To verify the authenticity, the first token(s) is expected to be associated with a correct contract address, which may define an official source. Further, metadata via the URI for the token ID of the first token(s) may define the representation of the first token(s), for example, as 1 carbon credit. As the above-disclosed details are recorded in the distributed ledger 214, the CCTTS 108 may verify, in communication with the distributed ledger 214, the ownership and the authenticity of the first token(s). The verification of the ownership and the authenticity of the corresponding first token(s) may constitute a transaction for which an immutable record may be created in the distributed ledger 214.

At 512, the CCTTS 108 may execute a transactional exchange between the one or more first tokens and equivalent one or more second tokens from a purchasing entity based on a price issued by a carbon credit marketplace computing entity, for example, the carbon credit marketplace computing entity 146 illustrated in FIG. 1. The purchasing entity may correspond to a user device of a purchaser who places a purchase order for purchasing the corresponding first token(s). The purchaser may utilize the equivalent second token(s) to purchase the corresponding first token(s). The CCTTS 108 may execute the transactional exchange based on the price issued for the sale by the carbon credit marketplace computing entity 146. The price may refer to a trading value or an offer price issued by the carbon credit marketplace computing entity 146. In various embodiments, the carbon credit marketplace computing entity 146 may set the price for the second token(s) that may be utilized to purchase the first token(s) based on a fixed pricing model or a dynamic pricing model. The dynamic pricing model may be based on market conditions and parameters including, for example, supply and demand, trade offers, carbon credit age, type, certification, etc., or the like. For example, if the price of 1 full carbon credit is set to $100 and 1 ERC-1155 token represents 1/100 of a carbon credit, the price of the ERC-1155 token would be $1.00. In various embodiments, the CCTTS 108 may define an exchange rate between the ERC-20 token(s) and a currency instrument, for example, fiat currency such as USD. For example, if the CCTTS 108 sets the price of 1 ERC-20 token to $0.25, the purchaser may utilize four (4) ERC-20 tokens to purchase 1 ERC-1155 token.

In various embodiments, via the transactional exchange, the CCTTS 108 may receive the equivalent second token(s) from an electronic wallet of the purchasing entity, into the digital storage medium such as an electronic wallet or the second token database 126 of the CCTTS 108 illustrated in FIG. 1, and transmit the corresponding first token(s) from the electronic wallet 104 of the seller to the electronic wallet of the purchasing entity via the first token database 124 of the CCTTS 108. The CCTTS 108 may store the received equivalent second token(s), for example, in the second token database 126. In the above example, based on the issued price, the CCTTS 108 may receive 4 ERC-20 tokens from the electronic wallet of the purchasing entity in the second token database 126, and transmit the corresponding 1 ERC-1155 token from the electronic wallet 104 of the seller to the electronic wallet of the purchasing entity via the first token database 124. The execution of the transactional exchange may constitute a transaction for which an immutable record may be created in the distributed ledger 214.

At 514, the CCTTS 108 may convert the equivalent one or more second tokens into an amount of a currency instrument. In various embodiments, the current instrument may correspond to a digital form of fiat currency. The CCTTS 108 may convert the received equivalent second token(s) into the digital form of fiat currency at a set range of exchange. In the above example, the CCTTS 108 may convert the 4 ERC-20 tokens received from the electronic wallet of the purchasing entity into $1.00. The conversion of the equivalent second token(s) into an amount of the currency instrument may constitute a transaction for which an immutable record may be created in the distributed ledger 214.

At 516, the CCTTS 108 may transmit the amount of the currency instrument to an electronic wallet of the purchasing entity. In the above example, the CCTTS 108 may transmit $1.00 to the electronic wallet of the purchasing entity. The transmission of the amount of the currency instrument to the electronic wallet of the purchasing entity may constitute a transaction for which an immutable record may be created in the distributed ledger 214.

At 518, the CCTTS 108 may remove the equivalent one or more second tokens. In various embodiments, after the transactional exchange, the second token(s) that is stored in the second token database 126 of the CCTTS 108 may be automatically retired or burned from the CCTTS 108 as well as circulation. The CCTTS 108 may retire the second token(s) to prevent double counting of the carbon credit(s). The removal of the second token(s) may constitute a transaction for which an immutable record may be created in the distributed ledger 214.

At 520, the CCTTS 108 may create, in the distributed ledger 214, an immutable record of data associated with a transaction. The transaction(s) may be associated with one or more of the example operations 504 through 518 of the computer-implemented method disclosed herein. The CCTTS 108 may, therefore, provide immutable blockchain records for each transaction stage from carbon credit sourcing to retirement.

In various embodiments, for the sell order, the CCTTS 108 may expose at least one API to enable one or more interactions between two or more modules. The two or more modules may be associated with at least one of: the retrieval of the plurality of carbon credits, the generation of the plurality of first tokens, the generation of the plurality of second tokens, the execution of the transactional exchange, or the operations 508 to 510 and 514 through 520. The two or more modules may be one of integral or external to the CCTTS 108 as disclosed in the description of FIG. 1 and FIG. 12. In various embodiments, the CCTTS 108 may expose the API(s), in communication with an API entity, for example, the API server 154 illustrated in FIG. 1 and FIG. 12.

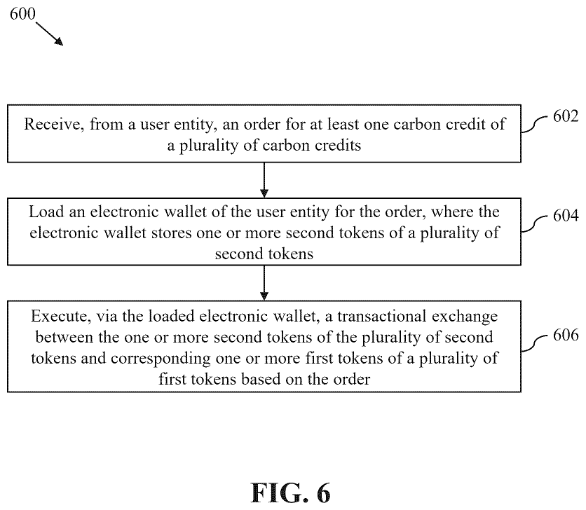

FIG. 6 is a flowchart 600 illustrating an example of a computer-implemented method for tokenizing and trading tokenized carbon credits, in accordance with various embodiments of the present disclosure. FIG. 6 is described in conjunction with FIGS. 1, 2, and 3. In various embodiments, the computer-implemented method disclosed herein may be implemented by the CCTTS 108 illustrated in FIG. 1. The flowchart 600 illustrated in FIG. 6 shows example operations 602 through 606 for tokenizing and trading tokenized carbon credits. In various embodiments, the example operations 602 through 606 may be executed by the CCTTS 108. The CCTTS 108 may store, in one or more memories 112 communicatively coupled to one or more processors 110, a plurality of first tokens representative of a plurality of carbon credits retrieved from one or more carbon credit sources 106 illustrated in FIG. 1, and a plurality of second tokens mapped in a one-to-one relationship to the plurality of first tokens. The first tokens may correspond, for example, to one of non-fungible tokens or semi-fungible tokens. The second tokens may correspond, for example, to non-volatile and non-convertible fungible tokens independent of market fluctuations. In various embodiments, the CCTTS 108 may be generate the first tokens and the second tokens based on the first token standard and the second token standard, respectively, as disclosed in the description of FIG. 1 and FIG. 3.

At 602, the CCTTS 108 may receive, from a user entity, an order for at least one carbon credit of a plurality of carbon credits. The order may correspond to a purchase order for purchasing the carbon credit(s). The CCTTS 108 may list the carbon credits represented by the first tokens on a user interface, for example, a website of a trading platform, for example, the trading platform 150 of the carbon credit marketplace computing entity 146 illustrated in FIG. 1, for purchase. A user, via the user entity such as a user device, may access the website of the trading platform 150 to select at least one of the listed carbon credits for purchase and place the order thereon.

At 604, the CCTTS 108 may load an electronic wallet, for example, the electronic wallet 104 of the user entity for the order. The electronic wallet 104 illustrated in FIG. 1 may store one or more second tokens of a plurality of second tokens. The CCTTS 108 may load the electronic wallet 104 with the second token(s) based on a purchase of the second token(s) made by the user entity using an amount of a currency instrument for the order. The currency instrument may correspond to a digital form of fiat currency. In various embodiments, to load the electronic wallet 104, the CCTTS 108 may receive, from the user entity, an amount of the currency instrument for the order. The CCTTS 108 may transmit, to the electronic wallet 104, the second token(s) corresponding to the received amount of the currency instrument.

At 606, the CCTTS 108 may execute, via the loaded electronic wallet 104, a transactional exchange between the one or more second tokens of the plurality of second tokens and corresponding one or more first tokens of a plurality of first tokens based on the order. In various embodiments, the transactional exchange between the second token(s) and the corresponding first token(s) may include a reception of the second token(s) from the electronic wallet 104 of the user entity, into a digital storage medium, such as an electronic wallet, an account, or a second token database 126 of the CCTTS 108 illustrated in FIG. 1, and a transmission of the corresponding first token(s) from a digital storage medium, such as an electronic wallet, an account, or a first token database 124 of the CCTTS 108 illustrated in FIG. 1 to the electronic wallet 104 of the user entity. The CCTTS 108 may, therefore, load the electronic wallet 104 with the corresponding first token(s) based on the executed transactional exchange between the second token(s) and the corresponding first token(s). The CCTTS 108 may remove the second token(s) from the digital storage medium after the transactional exchange.

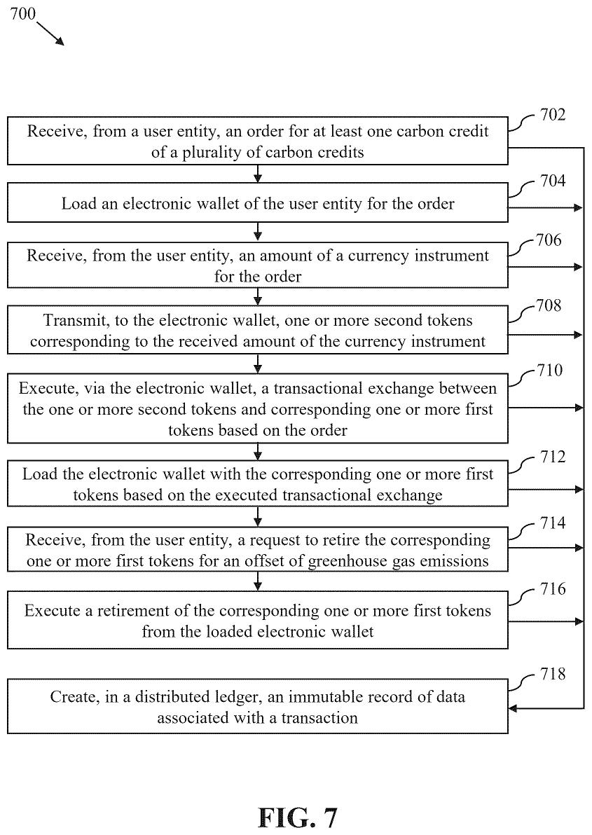

FIG. 7 is a flowchart 700 illustrating an example of a computer-implemented method for tokenizing carbon credits and trading tokenized carbon credits via an electronic wallet, for example, the electronic wallet 104 shown in FIG. 1, in accordance with various embodiments of the present disclosure. FIG. 7 is described in conjunction with FIGS. 1, 2, and 3. In various embodiments, the computer-implemented method disclosed herein may be implemented by the CCTTS 108 illustrated in FIG. 1. The flowchart 700 illustrated in FIG. 7 shows example operations 702 through 718 for tokenizing and trading tokenized carbon credits. In various embodiments, the example operations 702 through 712 may be executed by the CCTTS 108.

At 702, the CCTTS 108 may receive, from a user entity, an order for at least one carbon credit of a plurality of carbon credits. The order may correspond to a purchase order for purchasing the carbon credit(s). A user, via the user entity such as a user device, may access a user interface, for example, a website of a trading platform, for example, the trading platform 150 of the carbon credit marketplace computing entity 146 illustrated in FIG. 1, to select at least one of the listed carbon credits for purchase and place the order thereon. The reception of the order for the carbon credit(s) may constitute a transaction for which an immutable record may be created in a distributed ledger 214 illustrated in FIG. 2. The distributed ledger 214 may correspond to a blockchain ledger 152 illustrated in FIG. 1.

At 704, the CCTTS 108 may load an electronic wallet 104 of the user entity for the order.

The electronic wallet 104 may store one or more second tokens. The second tokens may correspond, for example, to non-volatile and non-convertible fungible tokens independent of market fluctuations. In various embodiments, the loading of the electronic wallet 104 of the user entity for the order may constitute a transaction for which an immutable record may be created in the distributed ledger 214.

At 706, to load the electronic wallet 104, the CCTTS 108 may receive, from the user entity, an amount of the currency instrument for the order. In various embodiments, the currency instrument may be digital form of fiat currency. The reception of the amount of the currency instrument for the order to load the electronic wallet 104 may constitute a transaction for which an immutable record may be created in the distributed ledger 214.

At 708, the CCTTS 108 may transmit, to the electronic wallet 104, one or more second tokens corresponding to the received amount of the currency instrument. In various embodiments, the transmission of the one or more second tokens corresponding to the received amount of the currency instrument to the electronic wallet 104 may constitute a transaction for which an immutable record may be created in the distributed ledger 214.

At 710, the CCTTS 108 may execute, via the electronic wallet 104, a transactional exchange between the one or more second tokens and corresponding one or more first tokens based on the order. In various embodiments, the transactional exchange between the second token(s) and the corresponding first token(s) may include a reception of the second token(s) from the electronic wallet 104 of the user entity, into a digital storage medium, such as an electronic wallet, an account, or a second token database such as the second token database 126 of the CCTTS 108 illustrated in FIG. 1, and a transmission of the corresponding first token(s) from a digital storage medium, such as an electronic wallet, an account, or a first token database such as the first token database 124 of the CCTTS 108 illustrated in FIG. 1 to the electronic wallet 104 of the user entity. The execution of the transactional exchange between the second token(s) and the corresponding first token(s) may constitute a transaction for which an immutable record may be created in the distributed ledger 214.

At 712, the CCTTS 108 may load the electronic wallet 104 with the corresponding one or more first tokens based on the executed transactional exchange. In various embodiments, the loading of the electronic wallet 104 with the corresponding one or more first tokens based on the executed transactional exchange may constitute a transaction for which an immutable record may be created in the distributed ledger 214.

At 714, the CCTTS 108 may receive, from the user entity, a request to retire the corresponding one or more first tokens for an offset of GHG emissions. In various embodiments, the CCTTS 108 may receive the request to retire the corresponding first token(s) via a user interface, for example, a website of a trading platform such as the trading platform 150 of the carbon credit marketplace computing entity 146 illustrated in FIG. 1. The reception of the request to retire the corresponding first token(s) for the offset of GHG emissions may constitute a transaction for which an immutable record may be created in the distributed ledger 214.

At 716, the CCTTS 108 may execute a retirement of the corresponding one or more first tokens from the loaded electronic wallet 104. The CCTTS 108 may mark the corresponding first token(s) as “retired,” permanently removing the corresponding first token(s) from circulation. The execution of the retirement of the corresponding first token(s) from the loaded electronic wallet 104 may constitute a transaction for which an immutable record may be created in the distributed ledger 214. After offsetting the GHG emissions, the CCTTS 108 may provide the user with a digital certificate including a unique serial number and transaction hash on the blockchain, confirming the purchase and retirement of the first token(s).

At 718, the CCTTS 108 may create, in the distributed ledger 214, an immutable record of data associated with a transaction. The transaction(s) may be associated with one or more of the example operations 702 through 716 of the computer-implemented method disclosed herein. The CCTTS 108 may, therefore, provide immutable blockchain records for each transaction stage from carbon credit sourcing to retirement. In various embodiments, the CCTTS 108 may create an immutable record of data associated with the retirement of the corresponding first token(s) in the distributed ledger 214.

In various embodiments, the CCTTS 108 may expose at least one API to enable one or more interactions between two or more modules associated with at least one of the operations 702 through 718. The two or more modules may be one of integral or external to the CCTTS 108 as disclosed in the description of FIG. 1 and FIG. 12. In various embodiments, the CCTTS 108 may expose the API(s), in communication with an API entity, for example, the API server 154 illustrated in FIG. 1 and FIG. 12.

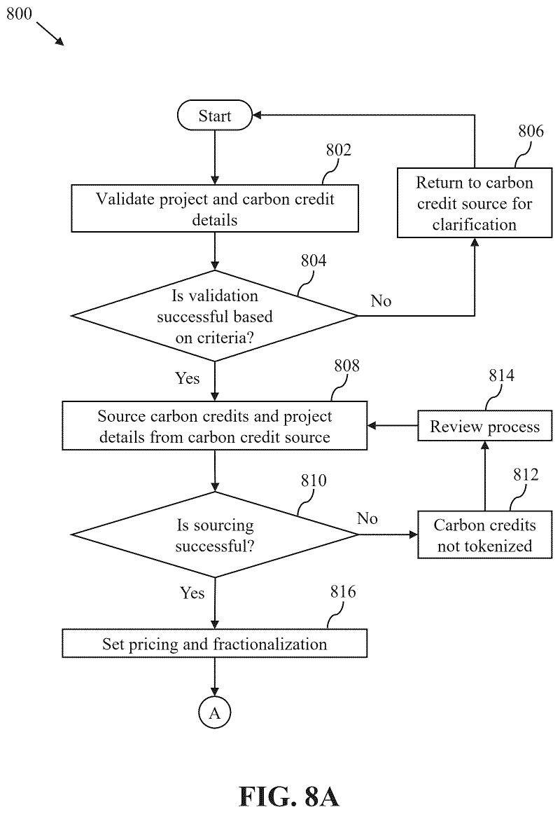

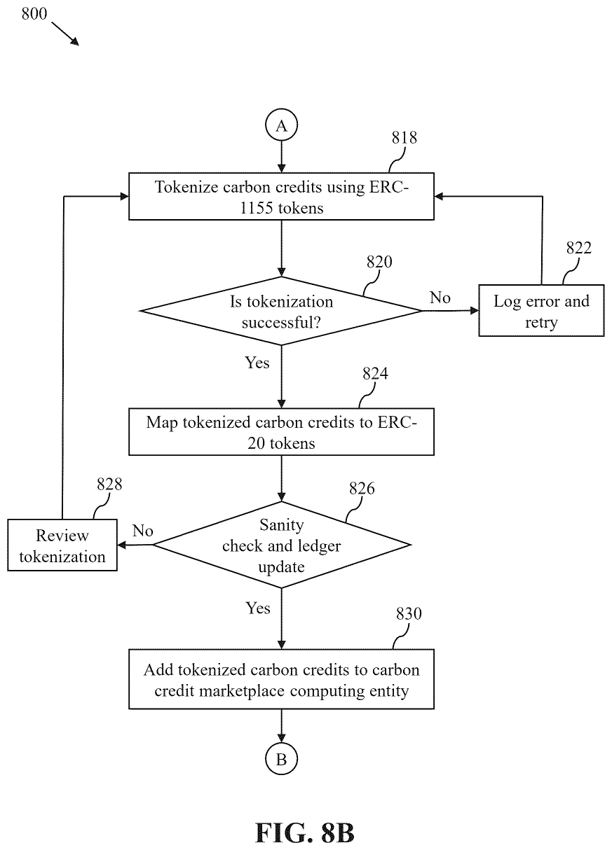

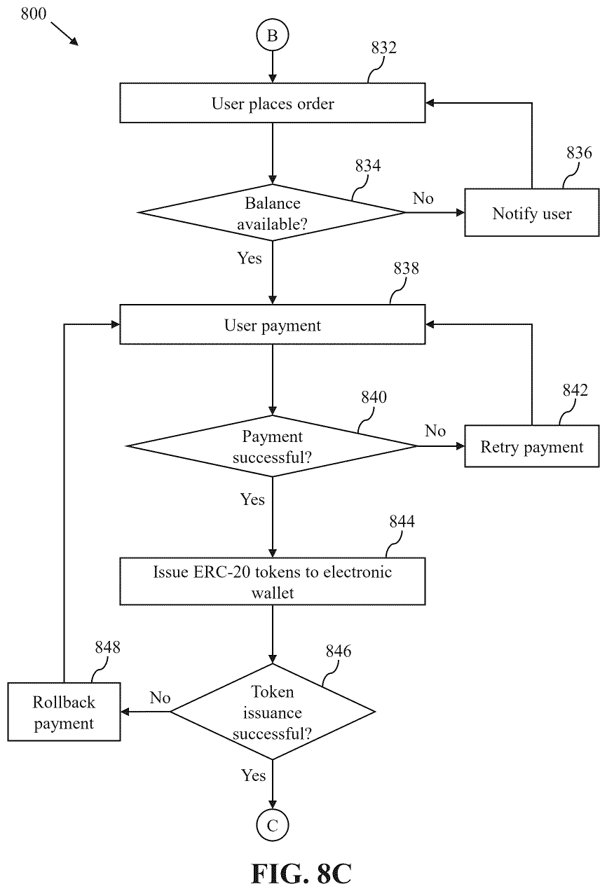

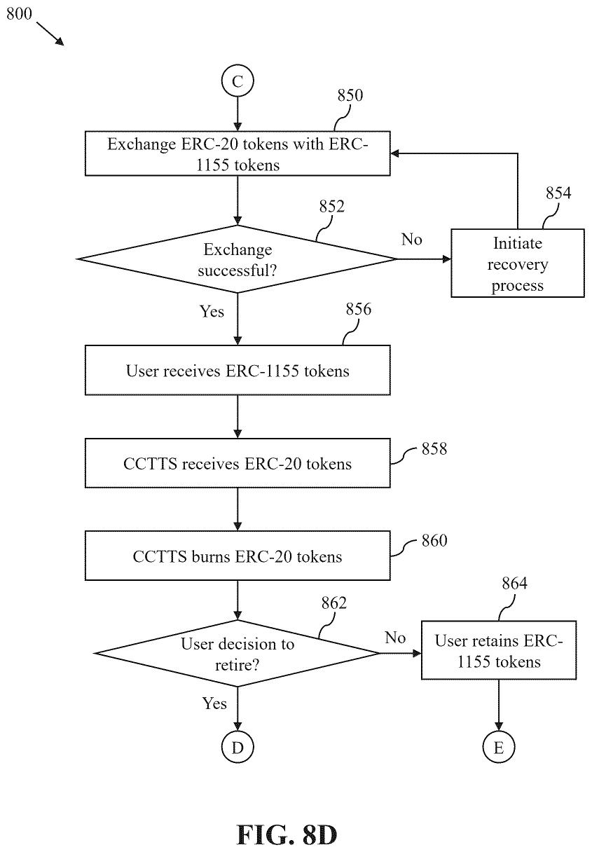

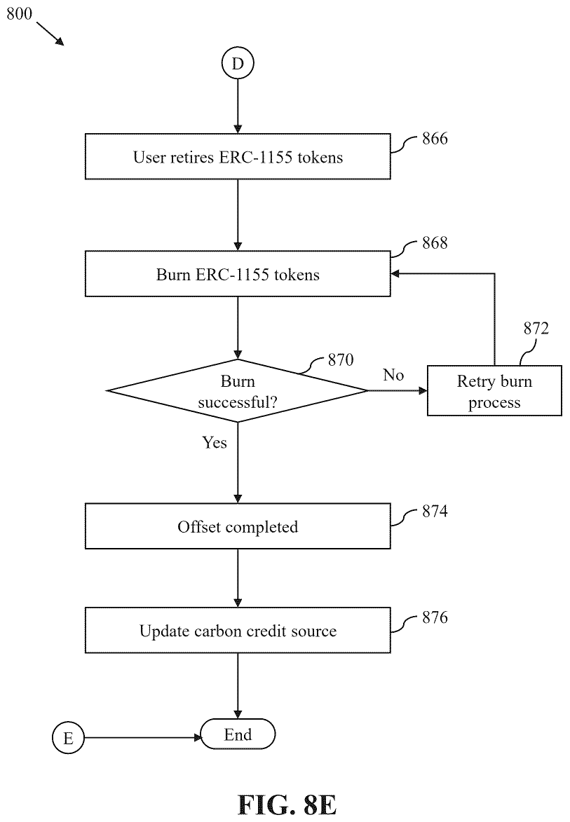

FIGS. 8A, 8B, 8C, 8D, and 8E collectively represent a flowchart 800 illustrating an example of a computer-implemented method for tokenizing and trading tokenized carbon credits by utilizing a dual-token mechanism, in accordance with various embodiments of the present disclosure. FIGS. 8A, 8B, 8C, 8D, and 8E are described in conjunction with FIGS. 1, 2, 3, 4, 5, 6, and 7. Referring to FIG. 8A, at 802, the CCTTS 108 may validate a project and carbon credit details as disclosed in the description of FIG. 1. The carbon credit details may include, for example, quantity of carbon credits to be tokenized, rate of sell of the carbon credits, a ratio of the carbon credits to the fractions to be created, name of the token, image of the token to be attached to the token, additional notes, or the like. At 804, the CCTTS 108 may determine whether the validation of the project and the associated carbon credit details is successful based on validation criteria. The validation criteria may include, for example, project additionality, baseline scenario, emission reduction method type, monitoring parameters such as energy generated, fuel saved, biomass used, etc., leakage assessment, leakage mitigation measures, sustainable co-benefits, environment safeguards, or the like. If the validation of the project and the associated carbon credit details is not successful, at 806, the CCTTS 108 may return to a carbon credit source, for example, the carbon credit source(s) 106, such as a carbon registry, for clarification, and may restart the validation process. The CCTTS 108 may communicate with the carbon credit source(s) 106 for clarification on the failure of the validation based on the validation criteria. Further, the CCTTS 108 may review the details associated with the project and the corresponding carbon credits. Further, the CCTTS 108 may continue the validation process until the validation of the project and the associated carbon credit details is successful.

Upon the successful validation of the project and the associated carbon credit details, at 808, the CCTTS 108 may source or procure the carbon credits and the project details associated with the carbon credits from the carbon credit source(s) 106. At 810, the CCTTS 108 may determine whether the sourcing of the carbon credits and the project details from the carbon credit source(s) 106 is successful. If the sourcing of the carbon credits and the project details is not successful, at 812, the CCTTS 108 may not tokenize the carbon credits. In various embodiments, the CCTTS 108 may mark the carbon credits as non-tokenized based on the carbon credits and the project details being unavailable for tokenization. Further, at 814, the CCTTS 108 may review the process of sourcing the carbon credits and the project details. The CCTTS 108 may further execute one or more operations to resolve errors detected during the review process. Upon the resolution of the errors, the CCTTS 108 may retry the sourcing of the carbon credits and project details from the carbon credit source(s) 106. The CCTTS 108 may repeat the steps 812 and 814 until the carbon credits and the project details are successfully sourced from the carbon credit source(s) 106. Upon the successful sourcing of the carbon credits and the project details associated with the carbon credits, at 816, the CCTTS 108 may perform fractionalization of the carbon credits into smaller tradable units and set pricing of each fraction of the carbon credits based on the corresponding ratio of one carbon credit value as disclosed in the descriptions of FIG. 1 and FIG. 4.

Referring to FIG. 8B, at 818, the CCTTS 108 may tokenize the sourced carbon credits by utilizing first tokens generated based on a first token standard, for example, the Ethereum Request for Comment (ERC)-1155 multi-token standard or the like. The first tokens may hereinafter be referred to as “ERC-1155 tokens.” In various embodiments, the ERC-1155 tokens may be indicative of semi-fungible tokens representing the carbon credits or a fraction of a carbon credit. The ERC-1155 tokens may be created in the ratio as mentioned in the project details. At 820, the CCTTS 108 may determine whether the tokenization of the carbon credits is executed successfully. If the tokenization is unsuccessful, at 822, the CCTTS 108 may log an error and retry tokenizing the carbon credits. Logging an error may refer to a process of recording the error during an execution of a process. The process of logging the error may also include providing information for debugging, monitoring, and troubleshooting to resolve the occurred error. The CCTTS 108 may execute one or more operations for debugging the error and may further retry tokenizing the carbon credits until the carbon credit is successfully tokenized based on the first token standard. Upon the carbon credits being successfully tokenized, at 824, the CCTTS 108 may map the tokenized carbon credits to second tokens generated based on a second token standard. The second tokens may hereinafter be referred to as “ERC-20 tokens.” The CCTTS 108 may generate an equivalent number of ERC-20 tokens to match the generated ERC-1155 tokens. The ERC-20 tokens may correspond to fungible tokens based on the ERC-20 standard. The ERC-20 tokens may be indicative of the value of the mapped tokenized carbon credits. The ERC-20 tokens may be utilized to perform a transaction associated with the tokenized carbon credits on the trading platform 150 illustrated in FIG. 1.

The CCTTS 108 may execute a sanity check and update a distributed ledger 214, for example, the blockchain ledger 152 illustrated in FIGS. 1 and 2. The sanity check may correspond to a validation process performed to ensure that associated data, logic, or operations are reasonable and correct, and meet the expected conditions. At 826, the CCTTS 108 may determine whether the sanity check and the update to the blockchain ledger 152 is successful. The sanity check may be a high-level check to verify that there are no errors or inconsistencies in the execution of the process and the corresponding outcome. In various embodiments, the sanity check may verify the generation of the tokenized carbon credits and the successful mapping of the ERC-20 tokens to the tokenized carbon credits. Upon the successful sanity check, the CCTTS 108 may update the blockchain ledger 152 based on the output of the sanity check. The blockchain ledger 152 may be configured to maintain a record of each step corresponding to the tokenization and trading of the tokenized carbon credits in the CCTTS 108. Further, if the sanity check and updation of the blockchain ledger 152 fails, at 828, the CCTTS 108 may review the tokenization process. The CCTTS 108 may perform one or more operations for reviewing the tokenization process in case of an error. If there are issues with the tokenization process, the CCTTS 108 may repeat the step of tokenization at 818 and the following steps 820-828. The review process may continue until the sanity check and the blockchain ledger update is successful. Upon the sanity check and the update to the blockchain ledger 152 being successful, at 830, the CCTTS 108 may add the tokenized carbon credits to the carbon credit marketplace computing entity 146, for example, in the project listing database 148 illustrated in FIG. 1. The project listing database 148 may enable sellers to display the carbon credits available for sale and as a result purchasers may obtain access to the available carbon credits for purchase. The purchaser(s) may filter the carbon credits based on the purchaser(s)' preferences. For example, the purchaser may provide a requirement and select the most suitable carbon credits to offset the GHG emissions.

Referring to FIG. 8C, at 832, a user places an order using the trading platform 150 in the carbon credit marketplace computing entity 146. Further, the CCTTS 108 may receive the order including, for example, a quantity of carbon credits requested, the type of project associated with the carbon credits, a geographical location associated with the carbon credits, price limitations, or the like. At 834, upon receiving the order, the CCTTS 108 may check an availability of balance in the user's electronic wallet, for example, the electronic wallet 104 illustrated in FIG. 1. If there is insufficient balance in the electronic wallet 104, at 836, the CCTTS 108 may transmit a notification to the user. The transmitted notification is indicative of the insufficient balance in the electronic wallet 104. In various embodiments, the CCTTS 108 may request the user to transfer the desired funds in the corresponding electronic wallet 104 to proceed with the order. Upon the transmission of the notification, the CCTTS 108 may proceed to place the order again at 832. Further, the balance availability check process may continue until the electronic wallet 104 includes sufficient balance. Upon the availability of the sufficient balance in the electronic wallet 104, at 838, the CCTTS 108 may execute a user payment corresponding to the placed order.

At 840, the CCTTS 108 may verify whether the payment is successful. On unsuccessful payment, at 842, the CCTTS 108 may request the user to retry the payment and proceed back to 838. The payment verification process continues until the payment is successfully executed. Upon the successful payment, at 844, the CCTTS 108 may issue ERC-20 tokens to the user's electronic wallet 104. At 846, the CCTTS 108 may determine whether the token issuance to the user's electronic wallet 104 is successful. If the ERC-20 tokens are not successfully issued to the user's electronic wallet 104, at 848, the CCTTS 108 may rollback the payment and proceed to user payment at 838. The processing of payment continues until the ERC-20 tokens are successfully issued to the user.

Referring to FIG. 8D, if the ERC-20 tokens are successfully issued to the user, at 850, the CCTTS 108 may exchange the ERC-20 tokens with the ERC-1155 tokens representative of the tokenized carbon credits. The exchange of the ERC-20 tokens with the ERC-1155 tokens may ensure enhanced security in the CCTTS 108. At 852, the CCTTS 108 may determine whether the exchange of the ERC-20 tokens with the ERC-1155 tokens is successful. If the exchange is unsuccessful, at 854, the CCTTS 108 may initiate a token recovery process to recover the processed tokens and re-initiate the exchange until the exchange is successfully executed. At 856, if the exchange is successful, the user may receive the ERC-1155 tokens from the CCTTS 108. The successful reception of the ERC-1155 tokens may be indicative of the order being successfully fulfilled. At 858, upon the successful exchange and reception of the ERC-1155 tokens in the user's electronic wallet 104, the CCTTS 108 may receive the ERC-20 tokens in a digital storage medium, for example, the second token database 126 illustrated in FIG. 1. Upon the reception of the ERC-20 tokens, at 860, the CCTTS 108 may burn the ERC-20 tokens. The burning or retiring of the ERC-20 tokens is indicative of removal of the ERC-20 tokens from the CCTTS 108. Further, burning the ERC-20 tokens may ensure prevention of double counting and reusing of the ERC-20 tokens, thereby preventing a fraud risk associated with the ERC-20 tokens being used to perform unauthorized transactions on the trading platform 150. At 862, the CCTTS 108 may provide an option to retire the ERC-1155 tokens. Retiring of the ERC-1155 tokens may be indicative of the user burning the ERC-1155 tokens to offset GHG emissions. If the user decides not to retire the ERC-1155 tokens, at 864, the user may retain the ERC-1155 tokens in the electronic wallet 104.

Referring to FIG. 8E, if the user decides to retire the ERC-1155 tokens, at 866, the user may retire the ERC-1155 tokens from the electronic wallet 104. The CCTTS 108 may receive the ERC-1155 tokens and at 868, the CCTTS 108 may burn the ERC-1155 tokens. At 870, the CCTTS 108 may determine whether the burning of the ERC-1155 tokens is successful. If the burning of the ERC-1155 tokens is unsuccessful, at 872, the CCTTS 108 may retry the burn process and proceed to burn the ERC-1155 tokens at 868. If the burning of the ERC-1155 tokens is successful, at 874, the CCTTS 108 may indicate a successful offsetting of the GHG emissions associated with the user. At 876, the CCTTS 108 may update the corresponding the carbon credit source(s) 106 to account for the burned ERC-1155 tokens.

In various embodiments, the CCTTS 108 may allow scheduling of a purchase of a specific quantity of carbon credits from a project; scheduling of a purchase of a specific amount from a project; scheduling a purchase of a specific quantity or number of carbon credits from a project based on predefined triggers and conditions; scheduling of a retirement of a specific quantity of carbon credits from a project; scheduling a retirement of a specific amount from a project; scheduling a retirement of a specific quantity or number of carbon credits from a project based on predefined triggers and conditions; pre-booking of carbon credits from a project that is listed on the carbon credit source(s) 106 but not yet allocated with carbon credits; and pre-booking of carbon credits from a project that is listed on the carbon credit source(s) 106 and allocated with the carbon credits but not yet tokenized.

In various embodiments, the CCTTS 108 may implement an online carbon footprint calculator, for example, based on the GHG protocol which is aligned with the United Nations (UN) standards and guidelines. The online carbon footprint calculator may allow the user to provide input via an online form-based interface. The user may provide input for every process and the activities performed by her/him to arrive at the GHG emissions due to such processes and activities. The online carbon footprint calculator may support unit conversions, and the applicability of emission calculation standards, for example, the GHG Protocol, the Intergovernmental Panel on Climate Change (IPCC) standards, the Environmental Protection Agency (EPA) standards, etc., and store the calculated GHG emissions for future reference and reporting purposes. The CCTTS 108, in communication with the online carbon footprint calculator, may provide each user with a summary and a detailed report of her/his GHG emission calculations with optional additional Artificial Intelligence (AI)-generated analysis. The online carbon footprint calculator may calculate and report the total GHG emissions, for example, in metric units equivalent to CO₂e, which may be expressed in kilograms or tonnes and optionally abbreviated as Kt, Mt, and Gt to denote kilotons, megatons, and Gigatons, respectively, for ease of comprehension.

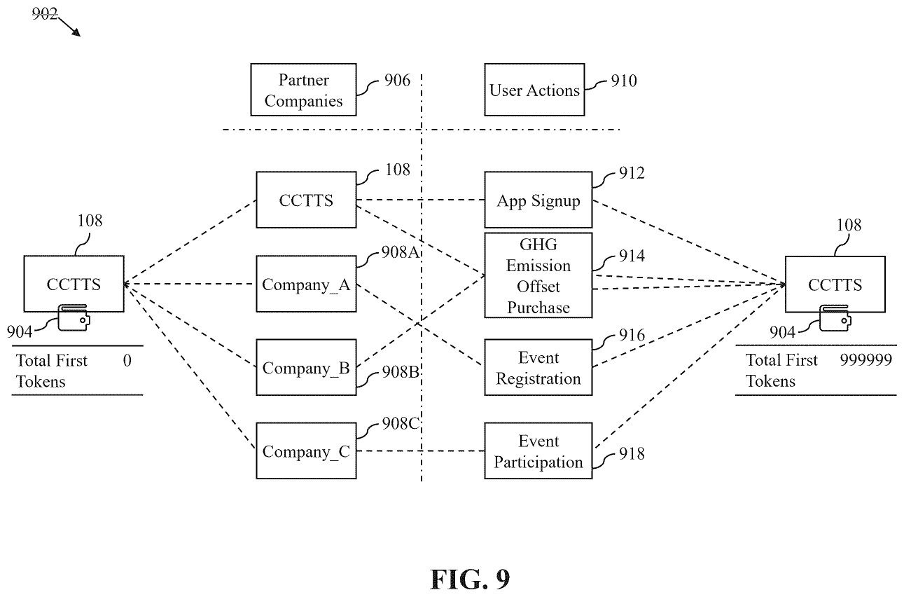

FIG. 9 is a block diagram 902 illustrating an example of a method for minting non-fungible tokens, in accordance with various embodiments of the present disclosure. FIG. 9 is described in conjunction with FIG. 1. In various embodiments, the non-fungible tokens may correspond to first tokens generated by the CCTTS 108. The CCTTS 108 may store the first tokens in a digital storage medium, for example, an electronic wallet 904 associated with the CCTTS 108. The first tokens, herein referred to as “non-fungible tokens,” may serve as means to encourage environmentally conscious behavior of users and foster environmental sustainability by rewarding the users for the users' positive impactful action on the environment. The non-fungible tokens may refer to unique digital assets generated and issued by the CCTTS 108 for various actions including, for example, participation in impactful environmental actions within a carbon credit marketplace associated with the carbon credit marketplace computing entity 146 illustrated in FIG. 1, carbon credit purchases for GHG emission offset, green project support and contribution, charity, donations, sustainable merchandise purchase, etc. The CCTTS 108 may allow users to accumulate the non-fungible tokens in the users' electronic wallets and redeem the non-fungible tokens for offers and discounts, for example, at partner companies 906, websites, outlets, or the like. The CCTTS 108 may issue the non-fungible tokens to the users of products and services provided by the CCTTS 108 as well as to the users or customers of organizations that are part of the carbon credit marketplace.

In various embodiments, the CCTTS 108 may mint the non-fungible tokens to recognize and reward users for the users' positive contributions to the environment. The non-fungible tokens may be of the following example types: generic, non-expiring, non-fungible tokens, and special purpose, expiring non-fungible tokens. The CCTTS 108 may pre-mint the generic, non-expiring, non-fungible tokens, which may be redeemed at the CCTTS 108, the trading platform 150 of the carbon credit marketplace computing entity 146, or at any partner companies 906 for purchase of products and services. The offers and discounts applied by redeeming such non-fungible tokens may vary from partner to partner and time to time. The CCTTS 108 or a partner company may issue the non-fungible tokens directly to the users' electronic wallets. The CCTTS 108 may govern the total supply of such non-fungible tokens, which may be independently verified on the blockchain.

The CCTTS 108 may mint the special purpose, expiring non-fungible tokens. A specific partner company(s) may request the CCTTS 108 to mint the special purpose, expiring non-fungible tokens for a special event or purpose. The special purpose, expiring non-fungible tokens may carry an expiration date or epoch time. Further, the special purpose, expiring non-fungible tokens can be redeemed at specific partner companies 906 for purchase of products and services before the expiration date. The offers and discounts applied by redeeming such non-fungible tokens may vary from partner company to partner company and time to time. The CCTTS 108 or a partner company may issue the special purpose, expiring non-fungible tokens directly to the users' electronic wallets. Once the expiration of such non-fungible tokens occurs, the special purpose, expiring non-fungible tokens cannot be redeemed at any partner company. The CCTTS 108 may govern the total supply of such non-fungible tokens in agreement with the partner company that requested the CCTTS 108 for the minting and issuance of such non-fungible tokens. The CCTTS 108 may mint any number of special purpose non-fungible tokens for any number of partner companies 906.

The generic, non-expiring, non-fungible tokens and the special purpose, expiring non-fungible tokens may not be minted by any partner company and may be burned by the user, the partner company, or the CCTTS 108. The burning process may ensure that the redeemed non-fungible tokens are taken out of circulation to avoid double counting. Further, both types of non-fungible tokens cannot be exchanged by any partner company. In various embodiments, the CCTTS 108 may help the user to exchange the expired, special purpose non-fungible tokens with the generic, non-expiring, non-fungible tokens as a promotional activity. For example, a user holding five hundred (500) expired, special purpose non-fungible tokens may request the CCTTS 108 to receive one hundred (100) generic, non-expiring non-fungible tokens which can be utilized for further redemption.

In various embodiments, the CCTTS 108 may implement a user reward system to issue non-fungible tokens to users of the CCTTS 108. The user reward system may track user activities within the CCTTS 108 or the trading platform 150, identifying user actions 910 that positively impact the environment. Based on the level of engagement and the significance of the user actions 910, the CCTTS 108 may issue the non-fungible tokens to the users' electronic wallets based on the users' eligibility, with fair and equitable distribution among the users. The CCTTS 108 may allow the users to monitor the users' progress and accumulation of the non-fungible tokens through the users' electronic wallets or an account dashboard. As the number of partner companies 906 grows and the number of products and services grows with the CCTTS 108 as well as the partner companies 906, the CCTTS 108 may reward contributions of the users with non-fungible tokens for the following example user actions 910:
1) GHG emission offset: The CCTTS 108 may allow the users, for example, organizations and individuals, to purchase high-quality carbon credits to offset the users' GHG emissions. The CCTTS 108 may consider such a purchase as an impactful user action by a purchaser of the carbon credit, which may directly support green projects which generated the carbon credits. When the users purchase carbon credits through the CCTTS 108, the user may receive non-fungible tokens in proportion to the users' purchases. The non-fungible tokens may incentivize the users to continue efforts towards GHG emission offset through carbon credit purchase and further sustainable actions. In various embodiments, the CCTTS 108 may reward the users with bonus non-fungible tokens for consistently purchasing carbon credits or reaching specific milestones in the users' carbon offsetting journey.
2) Environmental action: In various embodiments, the CCTTS 108 may reward users with non-fungible tokens based on the users' engagement in impactful user actions 910 that contribute positively to the environment. The user actions 910 may include, for example, participating in events organized by the organizations such as round-table discussions, sustainability conferences, beach cleanups, river cleanups, tree plantations, or supporting local environmental organizations within the carbon credit marketplace, purchasing products or services from such organizations, etc. Each non-fungible token may be indicative of the users' significant contributions toward protecting and preserving the environment. In various embodiments, the CCTTS 108, in collaboration with the organizations, may periodically implement new sustainability campaigns for generation and utilization of non-fungible tokens.
3) New user activity: The CCTTS 108 may reward a new user with non-fungible tokens for registering and signing up with the CCTTS 108 as a token of appreciation for taking the first steps towards sustainability. The non-fungible tokens may serve as an introduction to the carbon credit marketplace and encourage users to actively participate in environmental initiatives. The CCTTS 108 may also reward the user with additional non-fungible tokens for performing additional user actions 910 such as joining eco-friendly challenges, referring friends to the CCTTS 108, or completing educational or training modules.

In various embodiments, the CCTTS 108 may implement a non-fungible token distribution mechanism configured to load electronic wallets of users with non-fungible tokens. When the users qualify for the issuance of the non-fungible tokens, the CCTTS 108 may automatically add the non-fungible tokens to the users' electronic wallets directly or via a respective partner company. The CCTTS 108 may provide the users with access to the users' electronic wallets, allowing the users to view and manage the users' collection of non-fungible tokens. The electronic wallets may provide access of detailed information about each non-fungible token, including purpose, expiration, applicability, and associated rewards of each non-fungible token, to users for viewing within the electronic wallets. The electronic wallets may provide a transparent and secure distribution mechanism that allows the users to have complete control over the respective non-fungible tokens. In various embodiments, the CCTTS 108 may request the users to update wallet information associated with the users' electronic wallets for receiving the users' non-fungible tokens. In an embodiment, the CCTTS 108 may update the wallet information of the users' electronic wallets during a user registration process.

Referring to FIG. 9, consider an example where the CCTTS 108, in communication with partner companies 906 such as Company_A 908A, Company_B 908B, and Company_C 908C in the carbon credit marketplace, may monitor user actions 910 for minting non-fungible tokens. The CCTTS 108 may mint non-fungible tokens for the user actions 910 including, for example, application (app) signup 912 and GHG emission offset purchase 914. App signup 912 may refer to a user registering with the CCTTS 108 and downloading an application associated with the CCTTS 108 on a user entity such as a user device for receiving non-fungible tokens representative of carbon credits and trading tokenized carbon credits. GHG emission offset purchase 914 may refer to the user purchasing high-quality carbon credits to offset the GHG emissions as disclosed herein. In some examples, the CCTTS 108 may mint non-fungible tokens based on the user actions 910 associated with the app signup 912 and the GHG emission offset purchase 914. The CCTTS 108 may also mint non-fungible tokens when a partner company, for example, Company_B 908B, performs a GHG emission offset purchase 914.

In various embodiments, one or more partner companies 906, for example, Company_A 908A, Company_B 908B, and Company_C 908C, may request the CCTTS 108 to mint non-fungible tokens for user actions 910 such as event registration 916 and event participation 918. Events may include, for example, round-table discussions, sustainability conferences, beach cleanups, river cleanups, tree plantations, or supporting local environmental organizations within the carbon credit marketplace, purchasing products or services from such organizations, or the like. The CCTTS 108 may mint non-fungible tokens for registration to the events and participation in the events by the users. In the example illustrated in FIG. 9, based on the user actions 910, the number of non-fungible tokens minted by the CCTTS 108 and stored in the electronic wallet 904 of the CCTTS 108 may increase from 0 to 999,999.

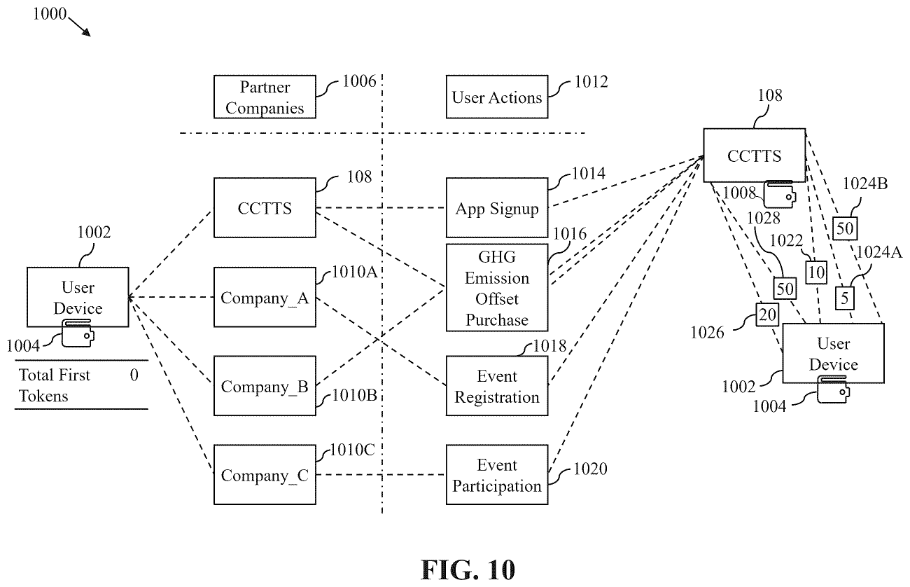

FIG. 10 is a block diagram 1000 illustrating an example of a method for issuing non-fungible tokens to a user for performing different user actions 1012, in accordance with various embodiments of the present disclosure. The CCTTS 108, in communication with multiple partner companies 1006, for example, Company_A 1010A, Company_B 1010B, and Company_C 1010C, may mint first tokens corresponding to non-fungible tokens for issuance to users based on user actions 1012 performed by the users. The CCTTS 108 may store the minted non-fungible tokens in a digital storage medium, for example, an electronic wallet 1008, associated with the CCTTS 108. Consider an example where a user deploys an electronic wallet 1004 on a user device 1002. The user may perform a user action 1012 such as app signup 1014 with the CCTTS 108 and provide wallet information associated with the user's electronic wallet 1004 to the CCTTS 108. The wallet information may include, for example, a public identifier, a public key, a private key, a recovery phrase, account metadata, or the like. The public identifier may be utilized by the CCTTS 108 to transfer one or more minted non-fungible tokens to the user's electronic wallet 1004. The public key may be utilized to verify signatures and may be mathematically linked to the private key. The private key may be utilized to gain complete control of the user's electronic wallet 1004. The recovery phrase may include, for example, a human-readable backup of the private key. The account metadata may include, for example, wallet balance, transaction history, token holdings, blockchain network information, smart contract interactions, or the like.

In various embodiments, the CCTTS 108 may host a client application downloadable on the user device 1002 that links to the user's electronic wallet 1004. The client application on the user device 1002, in communication with the CCTTS 108 via a communication network, for example, the communication network 144 such as the Internet, may allow the user to monitor and accumulate non-fungible tokens in the electronic wallet 1004. The CCTTS 108 may mint and store non-fungible tokens for various user actions 1012 including, for example, the app signup 1014, a GHG emission offset purchase 1016, event registration 1018, event participation 1020, or the like, in the electronic wallet 1008. In an example, the CCTTS 108 may transfer five (5) minted, non-fungible tokens 1024A for the app signup 1014, from the electronic wallet 1008 to the user's electronic wallet 1004. In a further example, if the user performs a user action 1012 such as purchasing high-quality carbon credits from the CCTTS 108 and a partner company such as Company_B 1010B to offset GHG emissions, herein referred to as “GHG emission offset purchase 1016,” the CCTTS 108 may transfer fifty (50) minted, non-fungible tokens 1024B and an additional 50 minted, non-fungible tokens 1028 from the electronic wallet 1008 to the user's electronic wallet 1004, respectively. In a further example, the CCTTS 108 may transfer twenty (20) minted, non-fungible tokens 1026 for the user's registration with an event, herein referred to as “Event Registration 1018,” organized by Company_A 1010A, from the electronic wallet 1008 to the user's electronic wallet 1004. In an additional example, the CCTTS 108 may transfer ten (10) non-fungible tokens 1022 for the user's participation in an event, herein referred to as “Event Participation 1020,” organized by Company_C 101C, from the electronic wallet 1008 to the user's electronic wallet 1004. In the example illustrated in FIG. 10, based on the user actions 1012, the number of non-fungible tokens transferred to the user's electronic wallet 1004 from the electronic wallet 1008 of the CCTTS 108 may increase from 0 to 135. The user's electronic wallet 1004 may store the transferred non-fungible tokens. The user may hold ownership rights to the stored non-fungible tokens within the carbon credit marketplace associated with the carbon credit marketplace computing entity 146 illustrated in FIG. 1. In various embodiments, the non-fungible tokens may be non-transferable outside an ecosystem associated with the CCTTS 108 and cannot be sold, exchanged, or transferred to different users or companies external to the ecosystem.

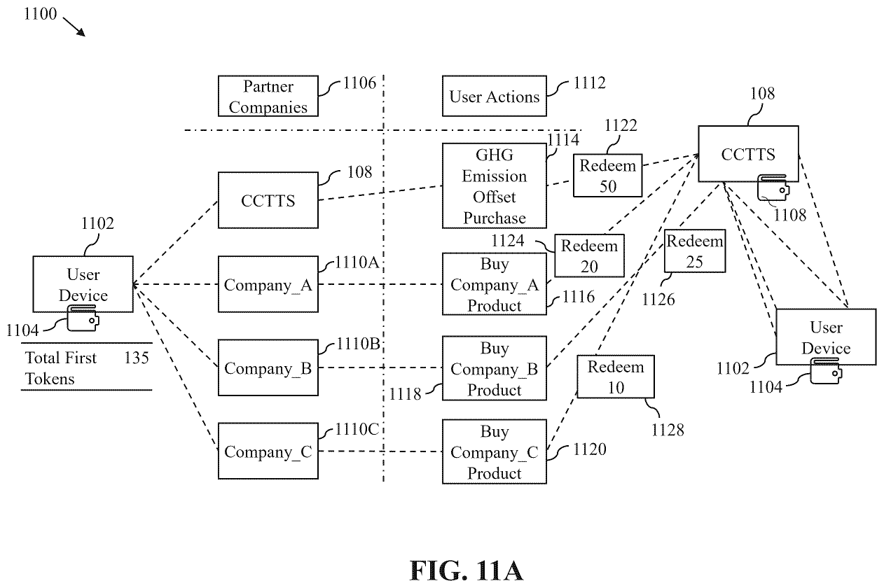

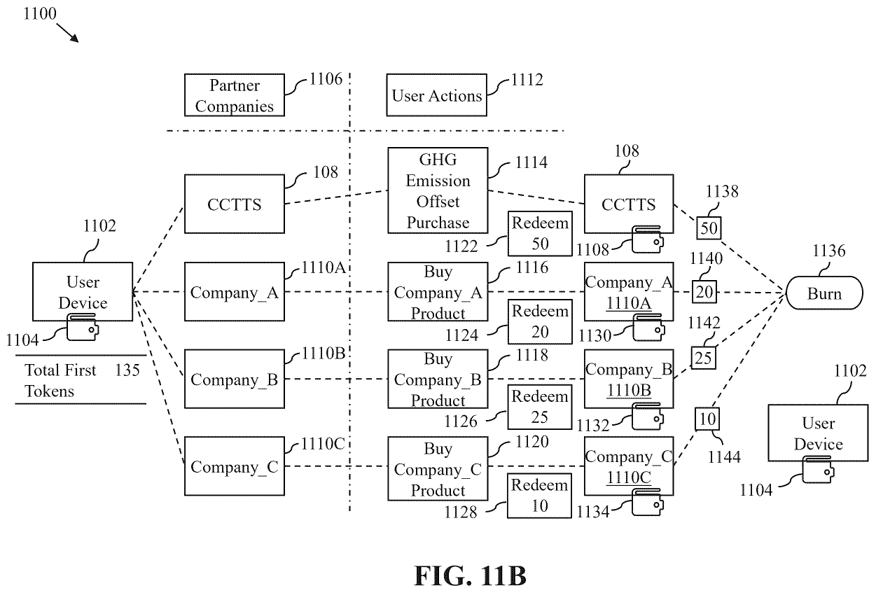

FIGS. 11A and 11B are block diagrams 1100 illustrating an example of a method for redeeming and burning non-fungible tokens, in accordance with various embodiments of the present disclosure. As illustrated in FIG. 11A, the CCTTS 108 may implement a redemption process to provide tangible benefits to users while incentivizing the users' involvement in environmental sustainability efforts. The CCTTS 108 may establish partnerships with various partner companies 1106 and outlets that share a common vision of environmental sustainability. The partner companies 1106 may offer deals and discounts to the users who hold non-fungible tokens in respective electronic wallets 1104, creating a mutually beneficial relationship where the users can enjoy incentives while supporting environmentally conscious businesses. The incentives may include, for example, discounted sustainable products, eco-friendly services, unique experience services, or the like. The non-fungible tokens stored in the users' electronic wallets 1104 can be redeemed on the CCTTS 108 or with the partner companies 1106 for offers and discounts.

The users may redeem the non-fungible tokens by visiting partner companies 1106, websites, or outlets and presenting the non-fungible tokens issued by the CCTTS 108. In various embodiments, the CCTTS 108 may execute a verification process, ensuring the non-fungible tokens are genuine and belong to respective users. Upon successful verification, the CCTTS 108 may allow the users to avail the offers and discounts associated with specific non-fungible tokens they possess. To avail the offers and discounts of the partner companies 1106, the user may redeem the non-fungible tokens at the respective partner companies 1106 by transferring a required number of non-fungible tokens to electronic wallets, for example, electronic wallets 1130, 1132, and 1134 illustrated in FIG. 111B, associated with the partner companies 1106. The partner companies 1106 may verify receipt of the non-fungible tokens and then apply the offers and discounts to applicable and approved merchandise, goods, or services as the case may be. The partner companies 1106 may offer one or more types or tiers of discounts for corresponding one or more types of purchases. In various embodiments, while the non-fungible tokens offer rewards and benefits, the redemption of the non-fungible tokens may be subject to certain limitations and exclusions. For example, the CCTTS 108 may set specific validity periods or restrictions on the number of times the non-fungible tokens can be redeemed. The users may refer to details of individual non-fungible tokens within respective electronic wallets 1104 for specific terms and conditions associated with each non-fungible token. In a further example, the CCTTS 108 may set one or more conditions for the non-fungible tokens, such as the non-fungible tokens cannot be redeemed for cash, purchased using different tokens, purchased using fiat currency, or refunded at any company outlet.

Referring to FIG. 11A, consider an example where a user deploys an electronic wallet 1104 on a user device 1102. The electronic wallet 1104 may contain, for example, 135 non-fungible tokens, that were minted and transferred from an electronic wallet 1108 of the CCTTS 108. In various embodiments, the user may initiate the redemption process via the electronic wallet 1108 of the CCTTS 108. The user may redeem some or all of the 135 non-fungible tokens from the electronic wallet 1104 to perform different user actions 1112. For example, as illustrated in FIG. 11A and FIG. 11B, the user may perform a redemption 1122 of fifty (50) non-fungible tokens 1138 by performing a GHG emission offset purchase 1114 from the CCTTS 108. In further examples, the user may perform a redemption 1124 of twenty (20) non-fungible tokens 1140, a redemption 1126 of twenty-five (25) non-fungible tokens 1142, and a redemption 1128 of ten (10) non-fungible tokens 1144 at the partner companies 1106, for example, Company_A 1110A, Company_B 1110B, and Company_C 1110C, respectively. The user may perform the redemptions 1124, 1126, and 1128 of the respective non-fungible tokens 1140, 1142, and 1144 to buy Company_A product 1116, Company_B product 1118, and Company_C 1120, respectively. The remaining non-fungible tokens, for example, 30 non-fungible tokens, may be stored in the user's electronic wallet 1104 for future redemptions. In various embodiments, to perform the redemptions 1122, 1124, 1126, and 1128, the user may transfer the respective non-fungible tokens 1138, 1140, 1142, and 1144 from the user's electronic wallet 1104 to the electronic wallet 1108 of the CCTTS 108. The CCTTS 108 may execute a verification process, ensuring the respective amounts of non-fungible tokens 1138, 1140, 1142, and 1144 are genuine and belong to the user. Upon successful verification, the CCTTS 108 may allow the user to avail the offers and discounts of the partner companies 1106, for example, Company_A 1110A, Company_B 1110B, and Company_C 1110C.

Referring to FIG. 111B, when the users avail the offers and discounts from the CCTTS 108 or the partner companies 1106, the non-fungible tokens 1138, 1140, 1142, and 1144 may be burned to be removed from circulation. The user may burn some or all of the non-fungible tokens 1138, 1140, 1142, and 1144 at the respective partner companies 1106. The CCTTS 108 may implement a burn process 1136 as illustrated in FIG. 11B to burn respective non-fungible tokens 1138, 1140, 1142, and 1144, after the respective redemptions 1122, 1124, 1126, and 1128 at the CCTTS 108, Company_A 1110A, Company_B 1110B, and Company_C 1110C. The redemptions 1122, 1124, 1126, and 1128 refer to the redemptions of 50 non-fungible tokens 1138, 20 non-fungible tokens 1140, 25 non-fungible tokens 1142, and 10 non-fungible tokens 1144, respectively, as disclosed in the description of FIG. 11A. In various embodiments, the CCTTS 108, through the electronic wallet 1108, may complete the burn process 1136 in collaboration with the partner companies 1106 via respective electronic wallets 1130, 1132, and 1134.

In various embodiments, the CCTTS 108 may provide different options to the partner companies 1106 for completing the burn process 1136 of the redeemed non-fungible tokens 1138, 1140, 1142, and 1144. In an embodiment, the CCTTS 108 may allow the partner companies 1106 to burn the redeemed non-fungible tokens 1140, 1142, and 1144 by transferring the redeemed non-fungible tokens 1140, 1142, and 1144 to a null address. In this embodiment, the partner companies 1106 may transmit respective confirmations to the CCTTS 108 on the number of the redeemed non-fungible tokens 1140, 1142, and 1144 that are burned successfully. In various embodiments, the CCTTS 108 may set a prescribed time to be agreed upon by the partner companies 1106 for receiving the confirmation from the partner companies 1106. In some embodiments, the partner companies 1106 may transfer the redeemed non-fungible tokens 1140, 1142, and 1144 to be burned to the electronic wallet 1108 of the CCTTS 108. The CCTTS 108 may burn the redeemed non-fungible tokens 1140, 1142, and 1144 on behalf of the respective partner companies 1106 by transferring such non-fungible tokens 1140, 1142, and 1144 to a null address and providing confirmations to the respective partner companies 1106. In various embodiments, the CCTTS 108 may perform the required logistics around the burn process 1136 including, for example, record keeping, confirmation, reporting, or the like. The redeemed non-fungible tokens 1138, 1140, 1142, and 1144 that are burned either by the CCTTS 108 or by the partner companies 1106, may not be available for any further application. In case of refunds or returns of products or services, such non-fungible tokens 1138, 1140, 1142, and 1144 cannot be considered for further application even if such non-fungible tokens 1138, 1140, 1142, and 1144 were utilized in the original transaction. In various embodiments, the CCTTS 108 may set an expiration date for each of the non-fungible tokens. The expired non-fungible tokens, if not burned, may not be usable for any discount or redemption process at any of the partner companies 1106. While the descriptions of FIGS. 9, 10, 11A, and 11B refer to the first tokens being non-fungible tokens, the present disclosure is not limited to the first tokens being non-fungible tokens, but may extend to include semi-fungible tokens and different functionally equivalent tokens.

FIG. 12 is a block diagram illustrating an integration of APIs 1212, a security framework 1232, and multiple external entities 1246 into a system 1200 for tokenizing and trading tokenized carbon credits, in accordance with various embodiments of the present disclosure. FIG. 12 is described in conjunction with FIG. 1. In an example implementation, various embodiments of the system 1200 may include the CCTTS 108 communicatively coupled to one or more carbon credit sources 106, multiple user devices, for example, user devices 1204, 1208, etc., and the blockchain ledger 152 via the communication network 144 as disclosed in the description of FIG. 1. In various embodiments, the CCTTS 108 may implement an API suite for supporting one or more operations including, for example, user management, carbon credit management, transaction processing, blockchain integration, compliance, audit, marketplace integration, report generation, analytics, or the like, enabling programmatic access to the functionality of the CCTTS 108. In various embodiments, the API suite may provide support for various data formats including, for example, a JavaScript Object Notation (JSON) format, a Comma Separated Values (CSV) format, a Portable Document Format (PDF), a Microsoft® Excel® format, or the like as disclosed herein. The CCTTS 108 may implement secure and easy-to-configure API integration with various third-party applications and solutions. API integration may refer to connecting the CCTTS 108 with a different module, application, or service via the APIs 1212 to allow the different module, application, or service to exchange data with the CCTTS 108 and trigger actions. In addition to supporting tokenization and trading of tokenized carbon credits, the API suite may enhance the CCTTS 108 into an enterprise-grade platform.

In various embodiments, the CCTTS 108 may implement an API suite configured to enable seamless integration with external entities 1246, for example, external systems, third-party applications, enterprise platforms, or the like. In various embodiments, the CCTTS 108 may provide multiple integration points and data formats for connectivity with the external entities 1246 and data exchange. The CCTTS 108 may support an API architecture built, for example, on Representational State Transfer (REST) principles, providing stateless, cacheable, and scalable communication protocols. In various embodiments, the API suite may support multiple authentication mechanisms including, for example, OAuth 2.0, JSON Web Tokens (JWT), API key-based authentication, or the like to provide secure access control and data protection in the CCTTS 108.

In various embodiments, the CCTTS 108 may implement and expose different APIs 1212 for performing different functions of the CCTTS 108 as disclosed herein. The APIs 1212 may enable one or more interactions between two or more modules, for example, the module(s) 1202, 1248, or both, associated with different functions of the CCTTS 108. In various embodiments, the module(s) may be integral to the CCTTS 108. Examples of the module(s) 1202 that may be integral to the CCTTS 108 may include the verification and audit module 116, the token minting module 118, and the transaction module 120 as illustrated in FIG. 1. In various embodiments, the module(s) may be external to the CCTTS 108. Examples of the module(s) that may be external to the CCTTS 108 may include the module(s) 1248 of the external entities 1246 such as external enterprise systems, carbon registries, third-party applications, marketplace platforms, enterprise platforms, sustainability reporting platforms, business intelligence tools, analytics tools, or the like, that support tokenizing, trading, and different operations associated with tokenized carbon credits. In various embodiments, the module(s) 1248 may include API clients utilized by the external entities 1246 to access the APIs 1212. Examples of the APIs 1212 may include a user management API 1214, a carbon credit management API 1216, a transaction processing API 1218, a blockchain integration API 1220, a compliance and audit API 1222, a marketplace integration API 1224, a reporting and analytics API 1226, an enterprise integration API 1228, and one or more additional APIs 1230 as illustrated in FIG. 12.

In an embodiment, the CCTTS 108 may utilize an API entity, for example, the API server 154, to host and expose the APIs 1212, process requests made to the APIs 1212, and return responses to the requests based on underlying logic and data. In various embodiments, the user devices 1204, 1208, etc., may include API clients 1206, 1210, etc., respectively, to communicate with the API server 154 via one or more of the APIs 1212 as illustrated in FIG. 12. The API clients 1206, 1210, etc., in the user devices 1204, 1208, etc., the module(s) 1202 of the CCTTS 108, or the module(s) 1248 of the external entities 1246 may initiate and transmit requests associated with one or more of the APIs 1212 to the API server 154, for example, via a Hypertext Transfer Protocol Secure (HTTPS) protocol. The API server 154 may receive and process the requests, based on which, the API server 154 may transmit responses, for example, JSON responses, to the API clients 1206, 1210, etc., the module(s) 1202 of the CCTTS 108, or the module(s) 1248 of the external entities 1246.

In various embodiments, the CCTTS 108, in communication with the API server 154, may implement and expose the user management API 1214 to at least one of: the user devices 1204, 1208, etc., the module(s) 1202 of the CCTTS 108, or the module(s) 1248 of the external entities 1246. The user management API 1214 may be configured to handle user registration, authentication, profile management, and role-based access control operations. In various examples, the user management API 1214 may include endpoints for creating new user accounts, validating user credentials, updating user profiles, managing associations with a user's electronic wallet, for example, the electronic wallet 104 illustrated in FIG. 1, and implementing multi-factor authentication workflows. In various embodiments, the user management API 1214 may support bulk user operations for enterprise clients, enabling batch user creation, role assignment, and permission management through programmatic interfaces.

In various embodiments, the CCTTS 108, in communication with the API server 154, may implement and expose the carbon credit management API 1216 to at least one of: the user devices 1204, 1208, etc., the module(s) 1202 of the CCTTS 108, or the module(s) 1248 of the external entities 1246. The carbon credit management API 1216 may be configured to support, for example, carbon credit sourcing, tokenization, and lifecycle management operations. In various examples, the carbon credit management API 1216 may include endpoints for retrieving carbon credits from the carbon credit source(s) 106, initiating tokenization processes, querying token balances, and executing retirement operations. The carbon credit management API 1216 may support real-time synchronization with the carbon credit source(s) 106, enabling automatic updates of carbon credit availability, pricing information, and project details. In various embodiments, the carbon credit management API 1216 may implement one or more webhook mechanisms to notify the external entities 1246 of carbon credit status changes, token settlement details, tokenization completions, and retirement events. A webhook mechanism may refer to an event-driven communication that automatically transmits data between various modules, for example, the module(s) 1202 of the CCTTS 108 and the module(s) 1248 of the external entities 1246, via an HTTP. Triggered by specific events, the webhook mechanism(s) may automate communication between the different APIs 1212 and may be utilized to activate workflows.

In various embodiments, the CCTTS 108, in communication with the API server 154, may implement and expose the transaction processing API 1218 to at least one of: the user devices 1204, 1208, etc., the module(s) 1202 of the CCTTS 108, or the module(s) 1248 of the external entities 1246. The transaction processing API 1218 may be configured to handle various aspects of tokenized carbon credit trading, including, for example, order placement, payment processing, transactional exchanges between first tokens and second tokens, and settlement operations. The transaction processing API 1218 may support both synchronous and asynchronous processing models, enabling real-time transactions for immediate settlement and batch processing for high-volume operations. In various embodiments, the transaction processing API 1218 may implement idempotency mechanisms to prevent duplicate transactions and ensure data consistency across distributed systems. An idempotency mechanism may refer to a mechanism that ensures that an operation, when repeated, has the same effect as a single execution, preventing unintended side effects such as duplicate transactions or data inconsistencies. In various examples, the transaction processing API 1218 may include endpoints for creating purchase orders, executing the transactional exchanges between the first tokens and the second tokens, processing payments through multiple currency instruments, and generating transaction confirmations.

In various embodiments, the CCTTS 108, in communication with the API server 154, may implement and expose a blockchain integration API 1220 to at least one of: the user devices 1204, 1208, etc., the module(s) 1202 of the CCTTS 108, or the module(s) 1248 of the external entities 1246. The blockchain integration API 1220 may be configured to support direct interaction with the blockchain ledger 152, smart contracts stored in the smart contract repository 132 illustrated in FIG. 1, and token management operations. In various examples, the blockchain integration API 1220 may provide endpoints for querying a blockchain transaction status, retrieving smart contract execution results, monitoring token balances across multiple wallet addresses, and executing atomic transactions through smart contract interfaces. In various embodiments, the blockchain integration API 1220 may support multiple blockchain networks and may implement cross-chain compatibility mechanisms for interoperability with various blockchain platforms.

In various embodiments, the CCTTS 108, in communication with the API server 154, may implement and expose the compliance and audit API 1222 to at least one of: the user devices 1204, 1208, etc., the module(s) 1202 of the CCTTS 108, or the module(s) 1248 of the external entities 1246. The compliance and audit API 1222 may be configured to support regulatory reporting requirements, audit trail generation, and compliance verification processes. The compliance and audit API 1222 may implement automated compliance checking mechanisms, alert generation for potential regulatory violations, and maintenance of immutable audit logs of activities of the CCTTS 108. The compliance and audit API 1222 may support integration with regulatory reporting systems, enabling automatic submission of required compliance reports to relevant authorities. In various embodiments, the compliance and audit API 1222 may implement verification processes including, for example, Know Your Customer (KYC) and Anti-Money Laundering (AML) verification processes through integration with third-party verification services.

In various embodiments, the CCTTS 108, in communication with the API server 154, may implement and expose the marketplace integration API 1224 to at least one of: the user devices 1204, 1208, etc., the module(s) 1202 of the CCTTS 108, or the module(s) 1248 of the external entities 1246. The marketplace integration API 1224 may be configured to support integration with one or more external entities 1246 such as carbon credit marketplaces, trading platforms, and price discovery mechanisms. In various examples, the marketplace integration API 1224 may support real-time price feeds, market data synchronization, and cross-platform trading capabilities. In various embodiments, the marketplace integration API 1224 may implement market maker functionalities, enabling automated trading strategies and liquidity provision mechanisms. In various examples, the marketplace integration API 1224 may include endpoints for listing carbon credits on external trading platforms, synchronizing inventory across multiple carbon credit marketplaces, and executing arbitrage operations.

In various embodiments, the CCTTS 108 may implement and expose a reporting and analytics API 1226 to at least one of: the user devices 1204, 1208, etc., the module(s) 1202 of the CCTTS 108, or the module(s) 1248 of the external entities 1246. The reporting and analytics API 1226 may be configured to generate comprehensive reports on carbon credit activities, environmental impact metrics, and trading performance indicators. The reporting and analytics API 1226 may support multiple output formats including, for example, JSON, eXtensible Markup Language (XML), CSV, PDF, and Microsoft® Excel® formats, enabling seamless integration with business intelligence and reporting systems. The reporting and analytics API 1226 may implement real-time data streaming capabilities for live dashboard updates and may support custom report generation based on user-defined parameters, date ranges, and filter criteria.

In various embodiments, the CCTTS 108, in communication with the API server 154, may implement and expose an enterprise integration API 1228 to at least one of: the user devices 1204, 1208, etc., the module(s) 1202 of the CCTTS 108, or the module(s) 1248 of the external entities 1246. The enterprise integration API 1228 may be configured to support integration with different external entities 1246, for example, Enterprise Resource Planning (ERP) systems, Customer Relationship Management (CRM) systems, Environmental Management Systems (EMS), sustainability reporting platforms, or the like. The enterprise integration API 1228 may support standard enterprise integration patterns including, for example, Electronic Data Interchange (EDI), Enterprise Service Bus (ESB) integration, message queue protocols, or the like. The enterprise integration API 1228 may implement data transformation capabilities to handle various data formats and schemas utilized in enterprise environments.

In various embodiments, the CCTTS 108 may implement and expose the additional API(s) 1230 including, for example, a carbon credit blockchain API, a carbon credit information retrieval API, a carbon credit minting API, a carbon credit transfer API, a carbon credit offsetting API, one or more blockchain-related APIs, or the like. In various embodiments, the CCTTS 108, in communication with the API server 154, may implement and expose the carbon credit blockchain API to at least one of: the user devices 1204, 1208, etc., the module(s) 1202 of the CCTTS 108, or the module(s) 1248 of the external entities 1246. The carbon credit blockchain API may be configured for carbon credit lifecycle management and blockchain interactions. In various examples, the carbon credit blockchain API may include a carbon credit tracking endpoint configured to retrieve available carbon credits in the user's electronic wallet 104, including balance queries, transaction history, and ownership verification through blockchain validation. The carbon credit tracking endpoint may support multi-wallet queries, enabling organizations to track carbon credits across multiple electronic wallets and consolidate holdings for comprehensive carbon asset management.

In various embodiments, the CCTTS 108, in communication with the API server 154, may implement and expose the carbon credit information retrieval API to at least one of: the user devices 1204, 1208, etc., the module(s) 1202 of the CCTTS 108, or the module(s) 1248 of the external entities 1246. The carbon credit information retrieval API may be configured to fetch detailed carbon credit information by utilizing unique token IDs. The carbon credit information retrieval API may return comprehensive carbon credit metadata including, for example, project details, vintage year, certification body, geographic location, carbon credit type (e.g., renewable energy, forestry, waste management), emission reduction methodology, verification status, and a blockchain transaction hash for authenticity verification. In various embodiments, the carbon credit information retrieval API may support batch queries for multiple token IDs, enabling efficient retrieval of carbon credit information for portfolio management and reporting purposes.

In various embodiments, the CCTTS 108, in communication with the API server 154, may implement and expose a carbon credit minting API to at least one of: the user devices 1204, 1208, etc., the module(s) 1202 of the CCTTS 108, or the module(s) 1248 of the external entities 1246. The carbon credit minting API may enable authorized users to mint carbon credits directly on respective individual platforms through programmatic interfaces. The carbon credit minting API may implement authorization and validation mechanisms, expecting carbon credit source verification, project certification validation, and compliance with regulatory standards before executing minting operations. The carbon credit minting API may support both individual and batch minting operations, enabling organizations to tokenize large quantities of verified carbon credits while maintaining one-to-one relationships with underlying environmental assets through regulated minting processes as disclosed herein.

In various embodiments, the CCTTS 108, in communication with the API server 154, may implement and expose a carbon credit transfer API to at least one of: the user devices 1204, 1208, etc., the module(s) 1202 of the CCTTS 108, or the module(s) 1248 of the external entities 1246. The carbon credit transfer API may be configured to support secure transfer of carbon credits between electronic wallets and organizational accounts. The carbon credit transfer API may implement atomic transaction mechanisms ensuring that carbon credit transfers are executed completely or not at all, preventing partial transfers and maintaining data integrity. In various embodiments, the carbon credit transfer API may support conditional transfers based on smart contract logic, enabling automated carbon credit transfers when predefined conditions are met, such as emission threshold breaches or scheduled offset requirements. In various embodiments, the carbon credit transfer API may include multi-signature support for organizational accounts requiring multiple approvals for carbon credit transfers.

In various embodiments, the CCTTS 108, in communication with the API server 154, may implement and expose a carbon credit offsetting API to at least one of: the user devices 1204, 1208, etc., the module(s) 1202 of the CCTTS 108, or the module(s) 1248 of the external entities 1246. The carbon credit offsetting API may be configured to execute carbon credit retirement operations through blockchain-based burning mechanisms. The carbon credit offsetting API may accept carbon credit retirement requests specifying quantities, token IDs, and offset purposes, and execute smart contract-based retirement operations that permanently remove carbon credits from circulation. The carbon credit offsetting API may generate offset certificates containing unique retirement identifiers, blockchain transaction hashes, and cryptographic proof of retirement, enabling organizations to demonstrate verified carbon neutrality achievements. In various embodiments, the carbon credit offsetting API may support scheduled offset operations, enabling organizations to automate carbon credit retirement based on predefined schedules or emission calculation results.

In various embodiments, the CCTTS 108, in communication with the API server 154, may implement and expose one or more blockchain-related APIs to at least one of: the user devices 1204, 1208, etc., the module(s) 1202 of the CCTTS 108, or the module(s) 1248 of the external entities 1246. The blockchain-related API(s) may include a carbon credit marketplace API for listing and discovering available carbon credits, a verification API for authenticating carbon credit ownership and transaction history through blockchain validation, a portfolio management API for tracking carbon credit holdings across multiple projects and vintage years, and a compliance API for generating regulatory reports with blockchain-verified carbon credit transactions. In various embodiments, the blockchain-related API(s) may implement real-time event streaming capabilities, enabling client applications to receive instant notifications of carbon credit transactions, ownership changes, and offset operations, for example, through WebSocket connections or Server-Sent Events (SSE).

For purposes of illustration, the detailed description refers to some examples of the APIs 1212 exposed by the CCTTS 108 as disclosed herein; however, the scope of the present disclosure is not limited to the above-disclosed APIs 1212, but may extend to include different internal and external APIs that enable one or more interactions between two or more modules, for example, the module(s) 1202, the module(s) 1248, or both associated with various operations performed in or via the CCTTS 108.

In various embodiments, the CCTTS 108 may implement API rate limiting, throttling, and monitoring mechanisms to ensure stability of the CCTTS 108 and fair resource allocation among API consumers. In various embodiments, the API architecture implemented by the CCTTS 108 may include distributed caching mechanisms, for example, the Redis™ in-memory, key-value database of Redis Ltd., or the Memcached distributed memory object caching system to improve response times and reduce database load. In various embodiments, the API architecture may implement circuit breaker patterns to prevent cascade failures and may include logging and monitoring capabilities for performance optimization and troubleshooting purposes.

In various embodiments, the API suite may implement Software Development Kit (SDK) libraries for programming languages including, for example, Java, Python, JavaScript® of Oracle America, Inc., C#, the Go® programming language of Google LLC, enabling rapid integration and reducing development complexity for client applications and different modules. The API suite may implement SDKs including, for example, documentation, code examples, and automated testing frameworks to support seamless integration with software systems. In various embodiments, the CCTTS 108 may provide GraphQL endpoints as an alternative to REST APIs, enabling client applications and different modules to request specific data fields and reducing network overhead for mobile and bandwidth-constrained environments.

In various embodiments, the CCTTS 108 may communicate with the security framework 1232 of the system 1200 via the communication network 144. In some embodiments, the security framework 1232 may be implemented within the CCTTS 108. In various embodiments, the security framework 1232 may support a multi-layered architecture. In various embodiments, the security framework 1232 may include an access control system 1234 configured to provide access of one or more resources of the CCTTS 108 to authorized and authenticated entities. The access control system 1234 may include one or more authorization mechanisms 1236 such as one or more Role-Based Access Controls (RBACs) 1234 configured to restrict system access, for example, based on user roles, organizational hierarchies, and functional requirements. The access control system 1234 may further include one or more authentication mechanisms 1238 including, for example, Multi-Factor Authentication (MFA), Single Sign-On (SSO) integration, validation of user credentials, and API key-based authentication for programmatic access. In various embodiments, the security framework 1232 may implement one or more application-level logging mechanisms 1240 that record user interactions, CCTTS operations, and security events, providing audit trails for compliance monitoring and forensic analysis.

The security framework 1232 may include secure data handling and file transfer infrastructure configured to protect sensitive carbon credit data, user information, and transaction records throughout a lifecycle of the CCTTS 108. The secure data handling and file transfer infrastructure may utilize enterprise-grade security protocols and cloud-based services to ensure data integrity, confidentiality, and regulatory compliance across CCTTS operations. In various embodiments, the secure data handling and file transfer infrastructure may implement secure file transfer capabilities through encrypted channels utilizing cloud computing platforms including, for example, the Microsoft® Azure® of Microsoft Corporation, AWS® of Amazon Technologies, Inc., the Google Cloud Platform (GCP®) of Google LLC, or the like. The secure data handling and file transfer infrastructure may support multiple data ingestion methods including, for example, direct data provision by authorized third-party entities through agreed protocols, ensuring seamless integration with external carbon credit verification systems and regulatory reporting platforms. In various embodiments, the secure data handling and file transfer infrastructure may implement structured data templates configured to minimize personal data exposure while maintaining carbon credit transaction records and environmental impact metrics.

In various embodiments, the CCTTS 108 may implement an encryption framework 1242 including multi-layered data encryption protocols utilizing, for example, Advanced Encryption Standard (AES)-256 encryption for data at rest and Transport Layer Security (TLS) 1.2 or higher (SSL) for data in transit. The encryption framework 1242 may protect carbon credit data, user authentication credentials, token transaction records, and blockchain interactions against unauthorized access and data breaches. The encryption framework 1242 may implement end-to-end encryption for API communications, file transfers, and database operations, ensuring that sensitive information remains encrypted throughout an entirety of a data processing lifecycle. The integration capabilities of the CCTTS 108 may support automated threat detection, real-time security monitoring, and incident response workflows, ensuring rapid identification and mitigation of potential security threats. For example, the security framework 1232 may further include one or more automated threat detection mechanisms 1244 configured to identify security threats across the system 1200 by continuously monitoring and analyzing data, events, logs, endpoints, servers, applications, or the like for indications of unusual or unauthorized behavior, thereby detecting suspicious or malicious activity early, helping to prevent or mitigate cyberattacks. The multi-layered architecture of the security framework 1232 including, for example, the access control system 1234, the application-level logging mechanism(s) 1240, the encryption framework 1242, and the automated threat detection mechanism(s) 1244 may serve as interconnected security layers that protect the CCTTS 108.

In various embodiments, the CCTTS 108 may utilize a cloud computing platform, for example, Microsoft® Azure®, to provide scalable, secure, and compliant data storage and processing capabilities. The cloud computing platform may implement geographically distributed data centers 1250 and 1252 with automatic failover capabilities, ensuring high availability and disaster recovery for critical carbon credit trading operations. In various embodiments, the CCTTS 108 may implement data residency controls to ensure compliance with regional data protection regulations and may support private cloud deployments for organizations with enhanced security requirements.

In various embodiments, the CCTTS 108 may implement structured data templates configured to collect and process minimum necessary information required for carbon credit tokenization, trading, and regulatory compliance. The CCTTS 108 may implement data minimization protocols to automatically identify and redact Personally Identifiable Information (PII) from carbon credit transaction records while maintaining the integrity of environmental impact data and blockchain verification processes. In various embodiments, the CCTTS 108 may implement data anonymization and pseudonymization techniques to protect user privacy while enabling carbon footprint tracking and reporting.

In various embodiments, the CCTTS 108 may integrate with enterprise security services including, for example, identity providers, certificate authorities, and Security Information and Event Management (SIEM) systems. The CCTTS 108 may implement automated security scanning and vulnerability assessment capabilities, providing continuous monitoring of system security posture and compliance with industry security standards such as International Organization for Standardization (ISO) 27001, System and Organization Controls (SOC) Type 1 and Type 2, and relevant carbon trading market security requirements. Further, the CCTTS 108 may include batch transfer capabilities for efficient bulk transactions. In various embodiments, the CCTTS 108 may also implement security features such as multi-factor authentication for platform access, RBAC for different user types, time-locked transactions for enhanced security, multi-step verification for the token retirement process, and automated audit trail maintenance.

In various embodiments, the CCTTS 108 may implement tokenized carbon credit trading where the tokens generated by the CCTTS 108 can be utilized for trading on various Decentralized Exchanges (DEXs), allowing users to purchase or sell the users' holdings easily while maintaining transparency and traceability on the blockchain. In various embodiments, the CCTTS 108 may implement loyalty programs where users earn additional tokens or alternative rewards for participating in sustainability initiatives or referring new users to the CCTTS 108. In various embodiments, the flexibility of the token standards, for example, the ERC-20 and ERC-1155 token standards, may allow for easy integration with different platforms such as blockchain platforms or services, potentially expanding the reach of the CCTTS 108 within a broader sustainability ecosystem. In various embodiments, the CCTTS 108 may implement carbon offset donations where users may leverage respective tokens for donations towards environmental projects or organizations focused on climate change mitigation, further enhancing community engagement.

In various embodiments, the applications of the systems, for example, the systems 100 and 1200 illustrated in FIG. 1 and FIG. 12, respectively, and the computer-implemented methods for tokenizing and trading tokenized carbon credits by utilizing the non-volatile token system, for example, the dual-token mechanism, may include, for example, GHG emission offsetting, Environmental, Social and Governance (ESG) reporting, Carbon Border Adjustment Mechanism (CBAM) reporting, regulatory sustainability reporting, carbon credit monetization, or the like. Further applications of the systems and the computer-implemented methods disclosed herein may include, for example, supply chain sustainability tracking through tokenized carbon credits, corporate net-zero goal achievement verification, carbon footprint reduction program management, transparent stakeholder reporting on environmental impact, integration with existing environmental management systems, or the like. Still further applications of the systems and the computer-implemented methods disclosed herein may include, for example, API integration with enterprise sustainability platforms, automated carbon credit portfolio management, real-time environmental impact monitoring, programmatic retirement scheduling for recurring offsets, integration with national and international carbon registries, batch processing for large-scale industrial offset programs, or the like. Mobile device-specific applications of the systems and the computer-implemented methods disclosed herein may include, for example, carbon credits for eco-friendly transportation choices, incentivizing green mobility solutions, tracking and rewarding sustainable transport usage, or the like. Project-specific applications of the systems and the computer-implemented methods disclosed herein may include, for example, renewable energy project credit management, forest conservation project credit tracking, Clean Development Mechanism (CDM) project integration, or the like. Industry-specific applications of the systems and the computer-implemented methods disclosed herein may include, for example, cement industry emissions tracking and offsetting, steel industry carbon management, energy sector transition programs, manufacturing sector sustainability initiatives, or the like. Infrastructure-specific applications of the systems and the computer-implemented methods disclosed herein may include, for example, smart city carbon footprint management, green building certification programs, water management, waste management, plastic recycling, sustainable infrastructure development, or the like.

The present disclosure may address several challenges in carbon credit trading by tokenizing and trading tokenized carbon credits using the non-volatile tokens. For example, the systems and the computer-implemented methods disclosed herein may utilize programmable smart contracts to implement automated compliance processes and synchronization with the carbon credit source(s) 106 for instant verification, thereby reducing verification costs. In an example, the systems may reduce up to 90% of the verification costs through automated compliance processes and further eliminate data availability delays through instant verification. Further, the systems and the computer-implemented methods may resolve reporting discrepancies by utilizing the distributed ledger 214 such as the blockchain ledger 152 illustrated in FIGS. 1 and 2. Furthermore, in comparison to conventional systems, the systems and the computer-implemented methods disclosed herein may log the successful burning of each non-fungible token on the blockchain ledger 152, indicating offsetting of the corresponding amount of GHG emissions, thereby improving the impact measurement accuracy of the systems. Additionally, the disclosed systems and computer-implemented methods may implement token-based payment between the corresponding electronic wallets of the involved parties, thereby reducing the international transaction costs.

Moreover, the systems and the computer-implemented methods disclosed herein may prevent double-counting through immutable blockchain records; enable precise credit tracking through unique token identifiers; ensure price stability through non-volatile tokens; ensure credit authenticity through regulated minting; and provide automated compliance through smart contracts. Price stability may be inherently built into the CCTTS 108, as the value of the non-volatile tokens is not affected by currency fluctuations or market volatility. The closed-loop nature of the CCTTS 108 may ensure that the value of the non-volatile tokens remains stable and predictable within the CCTTS 108. In various embodiments, the non-volatile tokens including the native fungible tokens and the non-fungible tokens, cannot be converted into fiat currency or traded on external exchanges, making the non-volatile tokens, specialized tokens with a focused use case. The non-convertibility of the non-volatile tokens may ensure that the value of the non-volatile tokens remains consistent within the sustainability-focused ecosystem, providing a specialized solution for GHG emission offsetting. Furthermore, the systems and the computer-implemented methods disclosed herein may enable small participant entry through fractionalization; support real-time tracking of environmental impact; create transparent audit trails for the transactions; maintain a strict carbon credit to token ratio; and eliminate market speculation through non-convertible tokens. Furthermore, the systems and the computer-implemented methods disclosed herein may provide a comprehensive tracking system that maintains detailed records of the number of tokens that are utilized from each project, ensuring transparency in how carbon offsets are allocated. By leveraging blockchain technology's inherent capabilities for transparency, traceability, and automated compliance, the tokenized carbon credits may address fundamental challenges while creating new opportunities for market participation and efficiency.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in various embodiments, the order of operations may be rearranged without departing from the spirit and the scope of the disclosed subject matter.

Techniques consistent with the disclosure provide, among various features, systems and computer-implemented methods for tokenizing and trading tokenized carbon credits. While various example embodiments of the disclosed systems and computer-implemented methods have been described above, the embodiments have been presented for purposes of example only, and not limitations. The foregoing examples and illustrative implementations of various embodiments have been provided merely for explanation and are in no way to be construed as limiting of the disclosure to the precise form disclosed. Further, although the embodiments are described herein with reference to particular means, materials, techniques, and implementations, the embodiments herein are not intended to be limited to the particulars disclosed herein; rather, the embodiments extend to all functionally equivalent structures, methods, and uses, such as are within the scope of the appended claims.

While the present disclosure is described with reference to various embodiments, entities skilled in the art will understand that various changes may be made, and equivalents may be substituted without departure from the scope of the present disclosure. In addition, many modifications and variations may be made to adapt a particular situation or material to the teachings of the present disclosure or may be acquired from practicing the disclosure, without departing from the scope of the present disclosure. Therefore, the present disclosure is not limited to the embodiments disclosed, but includes all embodiments that fall within the scope of the appended claims.

What is claimed is:

1. A system, comprising:
one or more memories; and
one or more processors communicatively coupled to the one or more memories, wherein the one or more processors are individually or collectively configured to cause the system to:
retrieve a plurality of carbon credits from one or more carbon credit sources;
generate a plurality of first tokens representative of the retrieved plurality of carbon credits;
generate a plurality of second tokens mapped in a one-to-one relationship to the plurality of first tokens; and
execute a transactional exchange between one or more second tokens of the plurality of second tokens and corresponding one or more first tokens of the plurality of first tokens based on an order associated with a trade of at least one carbon credit of the retrieved plurality of carbon credits.

2. The system of claim 1, wherein the one or more processors are individually or collectively configured to cause the system to:
generate the plurality of first tokens based on a first token standard; and
generate the plurality of second tokens based on a second token standard, wherein the second token standard is different from the first token standard.

3. The system of claim 1, wherein the one or more processors are individually or collectively further configured to cause the system to remove the one or more second tokens from the system after the transactional exchange.

4. The system of claim 3, wherein the one or more processors are individually or collectively further configured to cause the system to create, in a distributed ledger operably coupled to the system, an immutable record of data associated with a transaction, and wherein the transaction is associated with at least one of: the generation of the plurality of first tokens, the generation of the plurality of second tokens, the execution of the transactional exchange, or the removal of the one or more second tokens.

5. The system of claim 4, wherein the distributed ledger corresponds to a blockchain ledger.

6. The system of claim 1, wherein the one or more processors are individually or collectively further configured to cause the system to list the generated plurality of first tokens representative of the retrieved plurality of carbon credits on a user interface in a carbon credit marketplace computing entity.

7. The system of claim 1, wherein the one or more processors are individually or collectively further configured to cause the system to:
receive, from a user entity, the order associated with a purchase of the at least one carbon credit of the retrieved plurality of carbon credits;
receive, from the user entity, an amount of a currency instrument for the order;
transmit, to an electronic wallet of the user entity, the one or more second tokens corresponding to the received amount of the currency instrument; and
execute the transactional exchange between the one or more second tokens and the corresponding one or more first tokens via the electronic wallet of the user entity.

8. The system of claim 7, wherein the transactional exchange between the one or more second tokens and the corresponding one or more first tokens comprises:
a reception of the one or more second tokens from the electronic wallet of the user entity into a digital storage medium of the system; and
a transmission of the corresponding one or more first tokens from the digital storage medium of the system to the electronic wallet of the user entity.

9. The system of claim 1, wherein the one or more processors are individually or collectively further configured to cause the system to:
receive, from the user entity, the order associated with a sale of the corresponding one or more first tokens; and
execute a transactional exchange between the corresponding one or more first tokens and equivalent one or more second tokens from a purchasing entity based on a price issued for the sale by a carbon credit marketplace computing entity.

10. The system of claim 9, wherein the one or more processors are individually or collectively further configured to cause the system to:
convert the equivalent one or more second tokens into an amount of a currency instrument; and
transmit the amount of the currency instrument to an electronic wallet of the purchasing entity.

11. The system of claim 9, wherein the one or more processors are individually or collectively further configured to cause the system to remove the equivalent one or more second tokens from the system after the transactional exchange between the corresponding one or more first tokens and the equivalent one or more second tokens from the purchasing entity.

12. The system of claim 1, wherein the one or more processors are individually or collectively further configured to cause the system to:
configure a ratio for a fractionalization of a carbon credit of the retrieved plurality of carbon credits;
set a price for purchase of the carbon credit in proportion to the configured ratio; and
generate the plurality of first tokens based on the configured ratio and the set price.

13. The system of claim 1, wherein the one or more processors are individually or collectively configured to cause the system to generate the plurality of first tokens and the plurality of second tokens through one or more smart contracts, and wherein the one or more smart contracts are executable in a distributed ledger that is operably coupled to the system.

14. The system of claim 1, wherein the one or more processors are individually or collectively further configured to cause the system to expose at least one application programming interface to enable one or more interactions between two or more modules, wherein the two or more modules are associated with at least one of: the retrieval of the plurality of carbon credits, the generation of the plurality of first tokens, the generation of the plurality of second tokens, the execution of the transactional exchange, or a removal of the one or more second tokens, and wherein the two or more modules are one of integral or external to the system.

15. The system of claim 1, wherein
the generated plurality of first tokens corresponds to one of:
a plurality of non-fungible tokens, or
a plurality of semi-fungible tokens, and
the generated plurality of second tokens corresponds to a plurality of non-volatile and non-convertible fungible tokens.

16. A system, comprising:
one or more memories configured to store:
a plurality of first tokens representative of a plurality of carbon credits retrieved from one or more carbon credit sources; and
a plurality of second tokens mapped in a one-to-one relationship to the plurality of first tokens; and
one or more processors communicatively coupled to the one or more memories, wherein the one or more processors are individually or collectively configured to cause the system to:
receive, from a user entity, an order for at least one carbon credit of the plurality of carbon credits;
load an electronic wallet of the user entity for the order, wherein the electronic wallet stores one or more second tokens of the plurality of second tokens; and
execute, via the loaded electronic wallet, a transactional exchange between the one or more second tokens of the plurality of second tokens and corresponding one or more first tokens of the plurality of first tokens based on the order.

17. The system of claim 16, wherein the one or more processors are individually or collectively further configured to cause the system to:
receive, from the user entity, an amount of a currency instrument for the order;
transmit, to the electronic wallet, the one or more second tokens corresponding to the received amount of the currency instrument; and
load the electronic wallet with the corresponding one or more first tokens based on the executed transactional exchange between the one or more second tokens and the corresponding one or more first tokens.

18. The system of claim 17, wherein the one or more processors are individually or collectively further configured to cause the system to:
receive, from the user entity, a request to retire the corresponding one or more first tokens for an offset of greenhouse gas emissions;
execute a retirement of the corresponding one or more first tokens from the loaded electronic wallet; and
create an immutable record of data associated with the retirement of the corresponding one or more first tokens in a distributed ledger that is operably coupled to the system.

19. The system of claim 16, wherein
the plurality of first tokens corresponds to one of:
a plurality of non-fungible tokens, or
a plurality of semi-fungible tokens, and
the generated plurality of second tokens corresponds to a plurality of non-volatile and non-convertible fungible tokens.

20. A computer-implemented method for tokenizing and trading tokenized carbon credits, the computer-implemented method comprising:
retrieving a plurality of carbon credits from one or more carbon credit sources;
generating a plurality of first tokens representative of the retrieved plurality of carbon credits;
generating a plurality of second tokens mapped in a one-to-one relationship to the plurality of first tokens; and
executing a transactional exchange between one or more second tokens of the plurality of second tokens and corresponding one or more first tokens of the plurality of first tokens based on an order associated with trading at least one carbon credit of the retrieved plurality of carbon credits.
